(19) United States
(12) Patent Application Publication
(10) Pub. No.: US 2022/0331886 A1
(43) Pub. Date: Oct. 20, 2022

(54) HANDHELD POWERED POCKET HOLE DRILL SYSTEM

(71) Applicant: Kreg Enterprises, Inc., Ankeny, IA (US)

(72) Inventors: Neil M. Holland, Cambridge, IA (US); Timothy J. Forbes, Des Moines, IA (US); Scott Schaaf, Boone, IA (US); Nathan Scott Combs, Slater, IA (US)

(21) Appl. No.: 17/694,797

(22) Filed: Mar. 15, 2022

Related U.S. Application Data
(60) Provisional application No. 63/161,547, filed on Mar. 16, 2021.
(60) Provisional application No. 63/241,777, filed on Sep. 8, 2021.
(60) Provisional application No. 63/319,513, filed on Mar. 14, 2022.

(51) Int. Cl. B23B 47/28; B23B 45/00

(52) U.S. Cl. CPC B23B 47/287; B23B 45/003; B23B 2247/10

(57) ABSTRACT

A handheld powered pocket hole drilling system is provided. The system includes a base assembly having a plate. The plate has a drill bit opening extending through the plate. The system includes a drilling assembly and a drill bit connected to the drilling assembly. A drill guide assembly is operably connected to the base assembly and the drilling assembly. The drilling assembly is movable along the drill guide assembly to extend and retract the drill bit through the drill bit opening at an angle. An actuating assembly is operably connected to the drilling assembly. The actuating assembly is configured to move the drilling assembly and drill bit between a retracted position and an extended position. In some arrangements, the actuating assembly moves a drilling assembly and drill bit rearward and downward to the extended position and a handle of the actuating assembly is moved forward and downward.

### CROSS REFERENCE TO RELATED APPLICATION

This application claims priority to U.S. Provisional Patent Application No. 63/161,547, filed Mar. 16, 2021, the entirety of which is hereby fully incorporated by reference herein.

This application also claims priority to U.S. Provisional Patent Application No. 63/241,777, filed Sep. 8, 2021, the entirety of which is hereby fully incorporated by reference herein.

This application also claims priority to U.S. Provisional Patent Application No. 63/319,513, filed Mar. 14, 2022, the entirety of which is fully incorporated by reference herein.

This application is related to U.S. Pat. No. 10,183,338, titled CAM LOCK FENCE SYSTEM AND METHOD OF USE, and which issued Jan. 22, 2019, the entirety of which is hereby fully incorporated by reference herein.

### FIELD OF THE DISCLOSURE

This disclosure relates generally to woodworking tools. More specifically and without limitation, this disclosure relates to a handheld drilling system that provides a plurality of improved functions as well as ease of use.

### OVERVIEW

Pocket hole wood joinery involves joining boards by inserting a fastener at an angle through the edge of one workpiece into an adjoining workpiece, thereby joining the two workpieces together. Such joints are commonly used for face frames, cabinet boxes, leg-to-rail joinery in chairs and tables, and so forth. Drill guides or jigs are used to drill the holes through which the fasteners or pocket screws are inserted into the adjoining workpiece.

To facilitate the formation of pocket hole joinery, a crafts person may utilize various pocket hole jigs and drilling systems. Pocket hole jigs are configured to clamp a workpiece in place and help guide a drill bit at an angle into a workpiece thereby forming a pocket hole in the workpiece. The pocket hole formed by this process is configured to receive a screw that is used to screw two workpieces together. However, many pocket hole jigs can be difficult to properly align with a workpiece and can be unnecessarily time consuming and/or unnecessarily inefficient to use when a larger number of pocket holes must be formed. Some stationary drilling systems are configured to quickly form pocket holes. However, these systems are large, heavy, and generally difficult to transport to and use at a worksite.

For the reasons stated above, and for other reasons stated below which will become apparent to those skilled in the art upon reading and understanding the disclosure, there is a need in the art for a pocket hole drilling system that improves upon the state of the art.

Thus, it is an object of at least one embodiment of the disclosure to provide a pocket hole drilling system that improves upon the state of the art.

Another object of at least one embodiment of the disclosure is to provide a pocket hole drilling system that is easy to use.

Yet another object of at least one embodiment of the disclosure is to provide a pocket hole drilling system that is fast and efficient to use.

Another object of at least one embodiment of the disclosure is to provide a pocket hole drilling system that is portable.

Yet another object of at least one embodiment of the disclosure is to provide a pocket hole drilling system that is light weight.

Another object of at least one embodiment of the disclosure is to provide a pocket hole drilling system that is handheld.

Yet another object of at least one embodiment of the disclosure is to provide a pocket hole drilling system that is cost effective.

Another object of at least one embodiment of the disclosure is to provide a pocket hole drilling system that forms accurate pocket holes.

Yet another object of at least one embodiment of the disclosure is to provide a pocket hole drilling system that is safe to use.

Another object of at least one embodiment of the disclosure is to provide a pocket hole drilling system that has a durable design.

Yet another object of at least one embodiment of the disclosure is to provide a pocket hole drilling system that has a long useful life.

Another object of at least one embodiment of the disclosure is to provide a pocket hole drilling system that provides additional functionality for pocket hole jigs and pocket hole joinery.

Yet another object of at least one embodiment of the disclosure is to provide a pocket hole drilling system that has a wide variety of uses.

Another object of at least one embodiment of the disclosure is to provide a pocket hole drilling system that has a wide variety of applications.

Yet another object of at least one embodiment of the disclosure is to provide a pocket hole drilling system that prevents or reduces relative movement between the pocket hole jig and the workpiece.

Another object of at least one embodiment of the disclosure is to provide a pocket hole drilling system that avoids the need to clamp the system to a workpiece.

Yet another object of at least one embodiment of the disclosure is to provide a pocket hole drilling system that facilitates the formation of aesthetically pleasing finished products.

Another object of at least one embodiment of the disclosure is to provide a pocket hole drilling system that forms a pocket hole with a single movement of a handle.

Yet another object of at least one embodiment of the disclosure is to provide a pocket hole drilling system that facilitates stable placement when used horizontally.

Another object of at least one embodiment of the disclosure is to provide a pocket hole drilling system that facilitates stable placement when used vertically.

Yet another object of at least one embodiment of the disclosure is to provide a pocket hole drilling system that facilitates easy removal of chips and debris during use.

Another object of at least one embodiment of the disclosure is to provide a pocket hole drilling system that is comfortable to use.

Yet another object of at least one embodiment of the disclosure is to provide a pocket hole drilling system that is more stable than other pocket hole jigs.

Another object of at least one embodiment of the disclosure is to provide a pocket hole drilling system that improves the ergonomics of use.

Yet another object of at least one embodiment of the disclosure is to provide a pocket hole drilling system that easily adjusts to workpieces of various thicknesses.

These and other objects, features, or advantages of at least one embodiment will become apparent from the specification, figures, and claims.

### SUMMARY

In one or more arrangements, a handheld powered pocket hole drilling system is provided. The system includes a base assembly having a plate. The plate has a drill bit opening extending through the plate. The system includes a drilling assembly and a drill bit connected to the drilling assembly. A drill guide assembly is operably connected to the base assembly and the drilling assembly. The drilling assembly is movable along the drill guide assembly to extend and retract the drill bit through the drill bit opening at an angle. An actuating assembly is operably connected to the drilling assembly. The actuating assembly is configured to move the drilling assembly between a retracted position and an extended position. In the extended position, the drill bit extends through the drill bit opening to facilitate drilling a pocket hole in a workpiece. In the retracted position, the drill bit does not extend through the drill bit opening.

In one or more arrangements, a lip is operably connected to the base assembly. When a lower surface of the plate is placed on a workpiece with the lip placed against an edge of the workpiece, the drill bit is positioned to drill a pocket hole in the workpiece when the drilling assembly is moved to the extended position.

In one or more arrangements, the actuating assembly includes a lever having a first handle. When the first handle is moved away from the lip, the actuating assembly moves the drilling assembly toward the lip to the extended position. Conversely, when the first handle is moved toward the lip, the actuating assembly moves the drilling assembly away from the lip to the retracted position. In one or more arrangements, when the first handle is moved away from the lip, the actuating assembly is configured and arranged to transfer a downward force to the base assembly, thereby increasing frictional forces between the plate and the workpiece. In one or more arrangements, when the first handle is moved away from the lip, the actuating assembly is configured and arranged to transfer a lateral force to the lip, thereby increasing frictional forces between the lip and the workpiece.

In one or more arrangements, the system includes an adjustable lip assembly having a sliding lip member, a drill stop assembly, and a rear adjustment assembly. In one or more arrangements, the rear adjustment assembly is configured to simultaneously adjust positions of the sliding lip member and the drill stop assembly to accommodate drilling of pocket holes in workpieces of various thicknesses.

In one or more arrangements, the system includes a front support assembly configured to support a front end of the system in an elevated position above a worktable. In one or more arrangements, the front support assembly includes a pair of extendable support legs that can be moved downward to hold the front end of system at a desired height so the system is correctly positioned on the workpiece for drilling pocket holes.

In one or more arrangements, the system includes one or more retractable guides configured to facilitate positioning of the system on a workpiece.

In one or more arrangements, the system includes an alignment window configured to facilitate positioning of the system for drilling a pocket hole at a desired location on a workpiece. In the arrangement shown, as one example, the alignment window includes a cutout in the rearward edge of the base assembly. In one or more arrangements, the alignment window includes an indicator that indicates the position at which a pocket hole will be formed.

In one or more arrangements, the system includes a safety interlock system configured to disable operation of the system unless the plate is placed on top of the workpiece with sufficient pressure.

In one or more arrangements, the system includes a dust collection system configured to collect dust and/or wood shavings generated from the drilling of pocket holes. In one or more arrangements, the dust collection system is configured to transport dust and/or wood shavings for collection using airflow generated by a cooling fan of the drill motor.

### BRIEF DESCRIPTION OF THE DRAWINGS

FIG. 1 shows an upper rear right perspective view of a pocket hole drilling system, in accordance with one or more arrangements.

FIG. 2 shows an upper rear left perspective view of a pocket hole drilling system, in accordance with one or more arrangements.

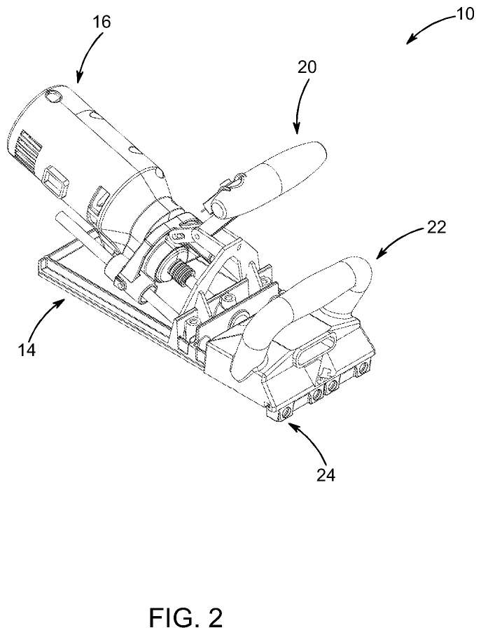

FIG. 3 shows an upper front left perspective view of a pocket hole drilling system, in accordance with one or more arrangements.

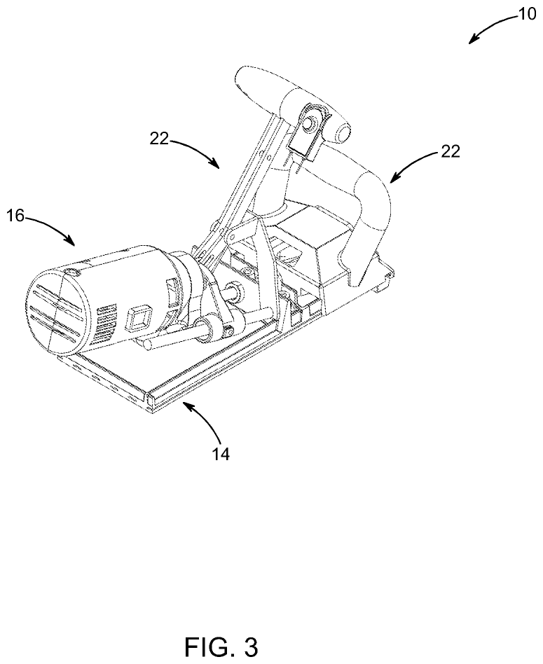

FIG. 4 shows an upper front right perspective view of a pocket hole drilling system, in accordance with one or more arrangements.

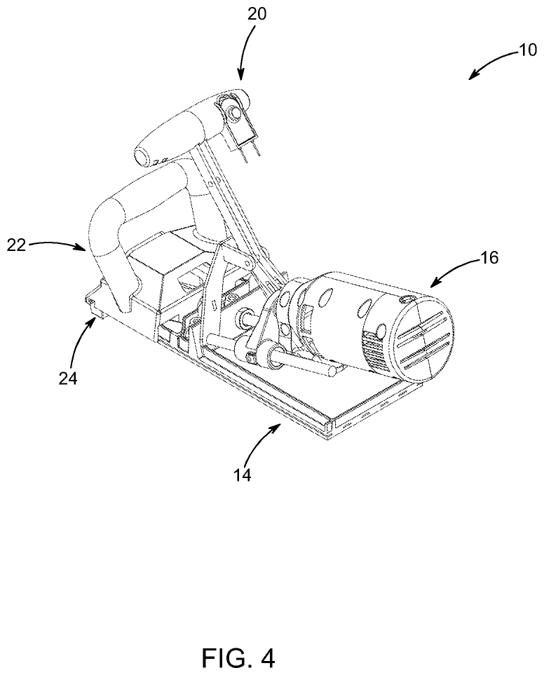

FIG. 5 shows an exploded upper rear left perspective view of a pocket hole drilling system, in accordance with one or more arrangements.

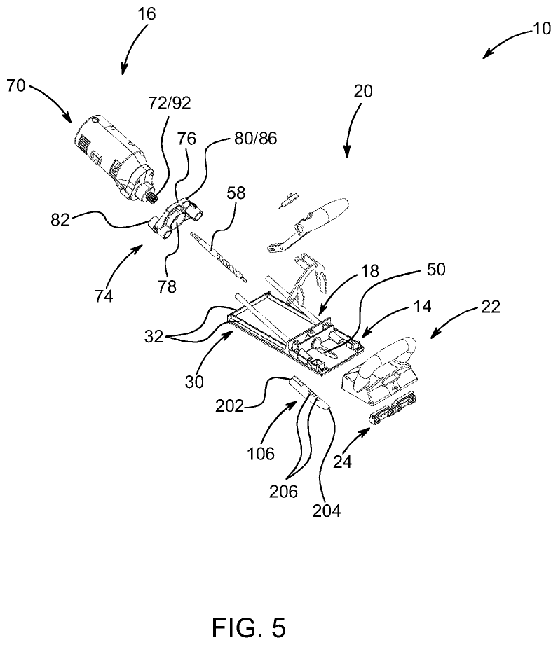

FIG. 6 shows a right side view of a pocket hole drilling system, in accordance with one or more arrangements; the view showing a handle of an actuating assembly in a rearward position and a drilling assembly in a retracted position.

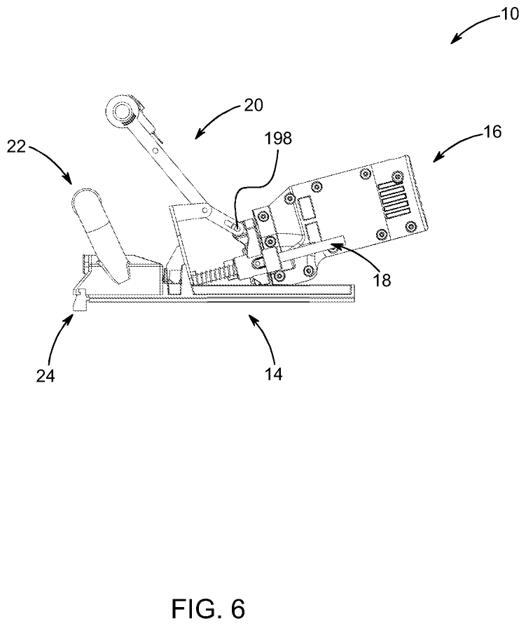

FIG. 7 shows a right side view of a pocket hole drilling system, in accordance with one or more arrangements; the view showing a handle of an actuating assembly in a rearward position and drilling assembly in a retracted position; the view showing a bias member spring positioned on a guide rod to facilitate moving the drilling assembly to the retracted position in the absence of an opposing force.

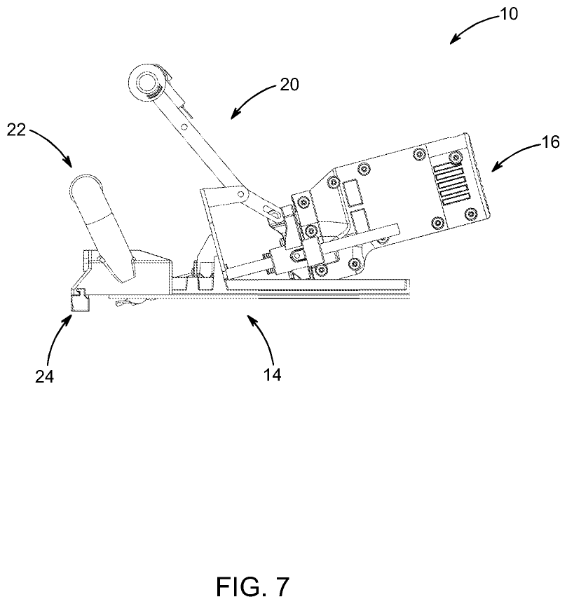

FIG. 8 shows a right side view of a pocket hole drilling system, in accordance with one or more arrangements; the view showing a handle of an actuating assembly in an intermediate position between a rearward position and a forward position; the view showing a drilling assembly in an intermediate position between an extended position and a retracted position; the view showing a bias member spring positioned on a guide rod to facilitate moving the drilling assembly to the retracted position in the absence of an opposing force.

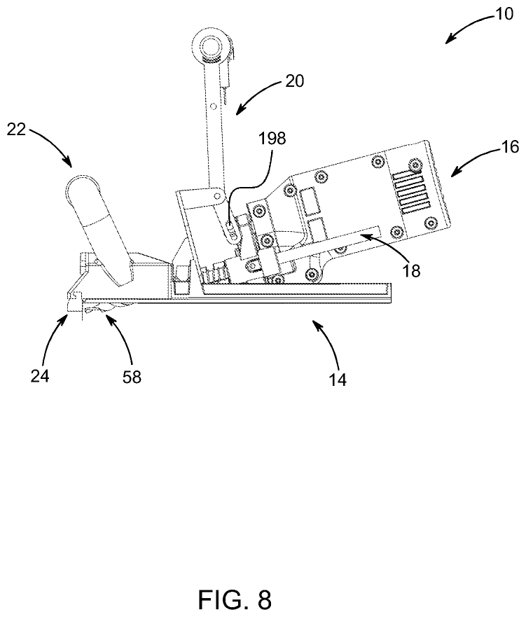

FIG. 9 shows a right side view of a pocket hole drilling system, in accordance with one or more arrangements; the view showing a handle of an actuating assembly in an intermediate position between a rearward position and a forward position; the view showing a drilling assembly in an intermediate position between an extended position and a retracted position; the view showing a bias member spring positioned on a guide rod to facilitate moving the drilling assembly to the retracted position in the absence of an opposing force; the view showing a grip pad positioned on a lower surface of a base plate of the system.

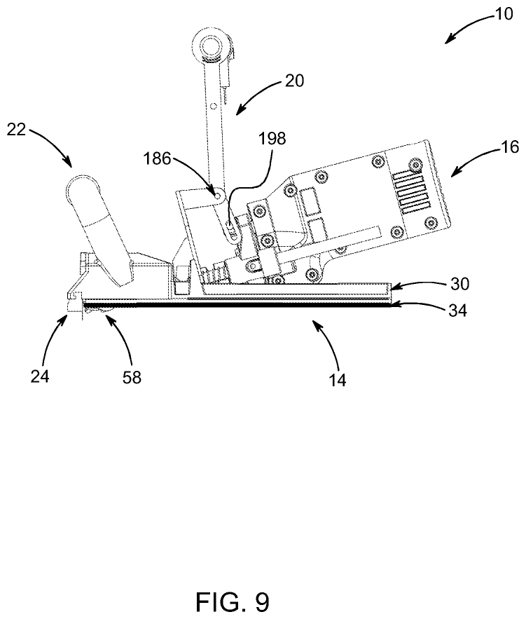

FIG. 10 shows a right side view of a pocket hole drilling system, in accordance with one or more arrangements; the view showing a handle of an actuating assembly in a forward position and drilling assembly in an extended position; the view showing a bias member spring positioned on a guide rod to facilitate moving the drilling assembly to the retracted position in the absence of an opposing force.

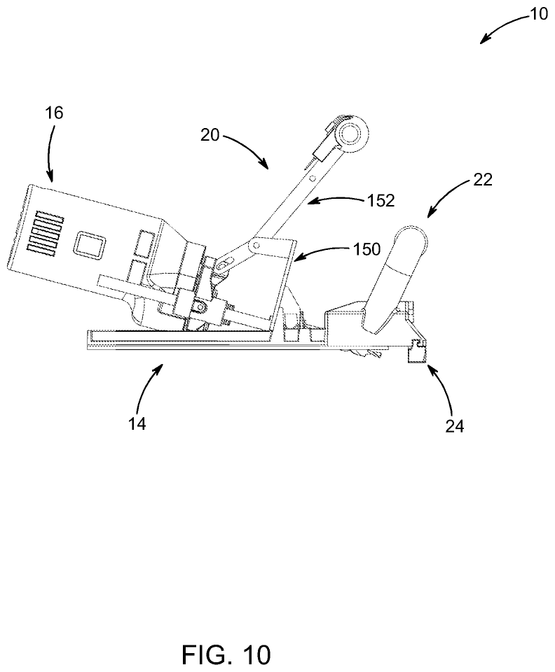

FIG. 11 shows a rear view of a pocket hole drilling system, in accordance with one or more arrangements.

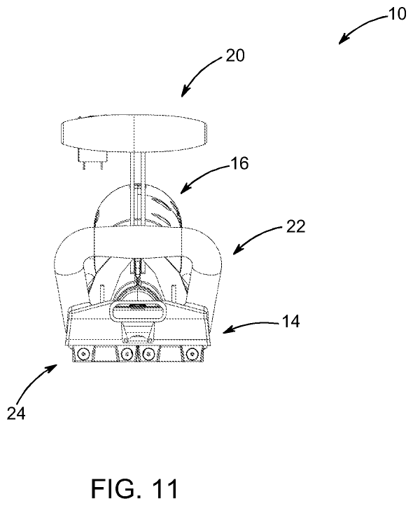

FIG. 12 shows a front view of a pocket hole drilling system, in accordance with one or more arrangements.

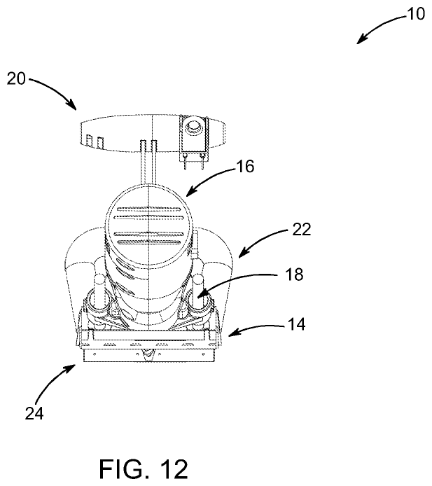

FIG. 13 shows a bottom view of a pocket hole drilling system, in accordance with one or more arrangements.

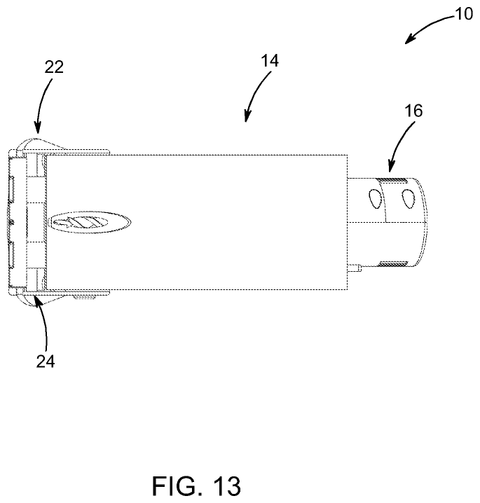

FIG. 14 shows a top view of a pocket hole drilling system, in accordance with one or more arrangements.

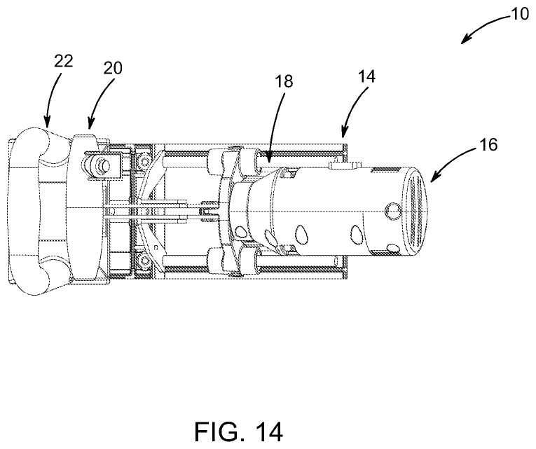

FIG. 15 shows a lower front right perspective view of a pocket hole drilling system, in accordance with one or more arrangements.

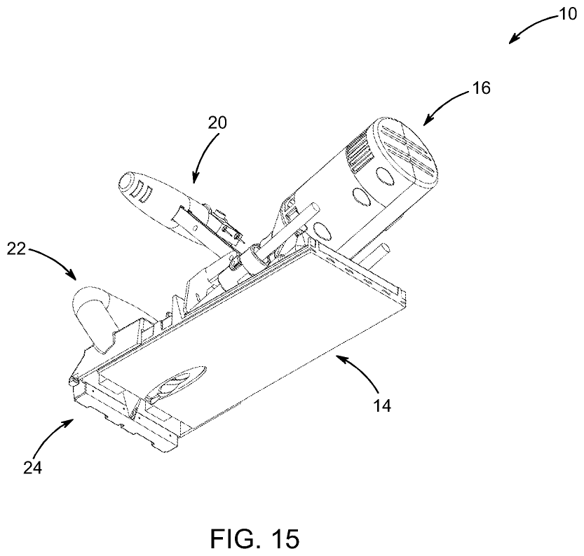

FIG. 16 shows a lower rear right perspective view of a pocket hole drilling system, in accordance with one or more arrangements.

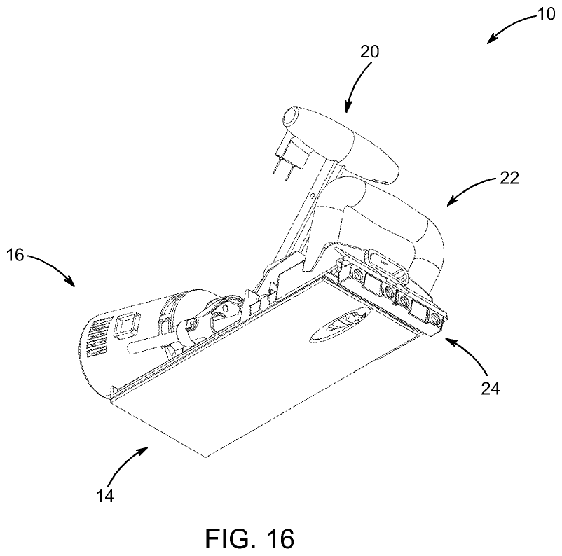

FIG. 17 shows a lower rear right perspective view of a pocket hole drilling system, in accordance with one or more arrangements.

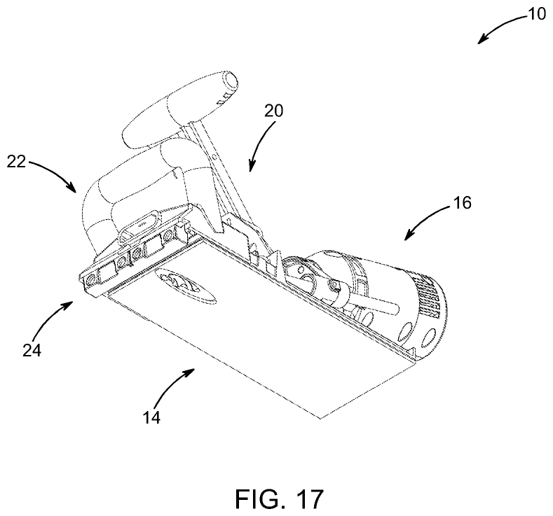

FIG. 18 shows a lower front left perspective view of a pocket hole drilling system, in accordance with one or more arrangements.

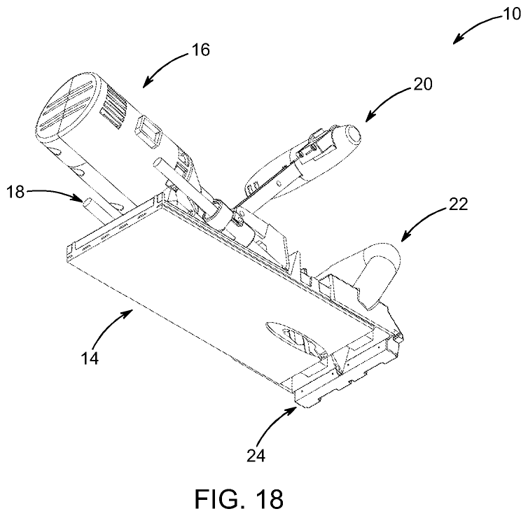

FIG. 19 shows an upper rear left perspective view of a collar assembly of a drilling assembly of a pocket hole drilling system, in accordance with one or more arrangements.

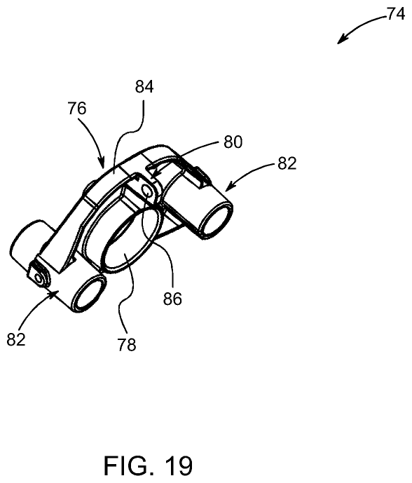

FIG. 20 shows a front view of a base and drill guide assembly of a pocket hole drilling system, in accordance with one or more arrangements.

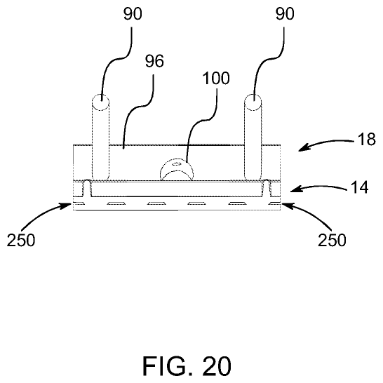

FIG. 21 shows an upper front left perspective view of a base and drill guide assembly of a pocket hole drilling system, in accordance with one or more arrangements.

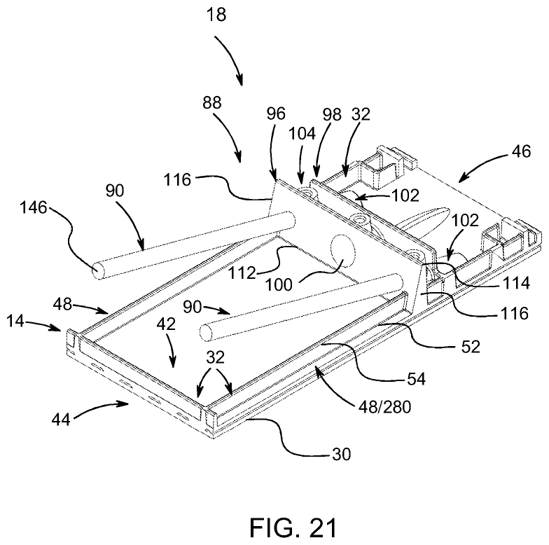

FIG. 22 shows an upper front right perspective view of the base and drill guide assembly of a pocket hole drilling system, in accordance with one or more arrangements.

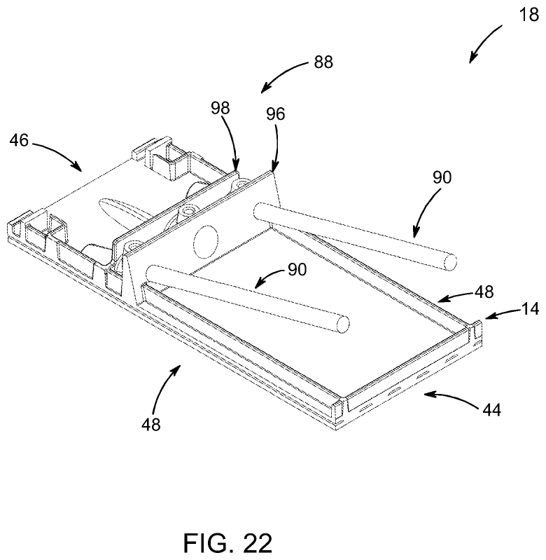

FIG. 23 shows an upper rear left perspective view of a base and drill guide assembly of a pocket hole drilling system, in accordance with one or more arrangements.

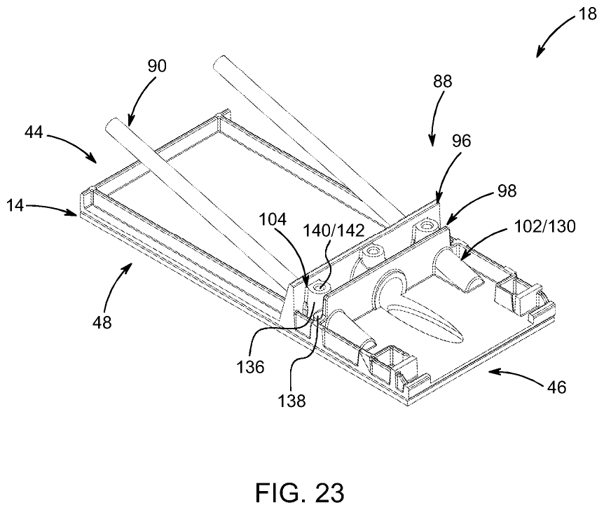

FIG. 24 shows an upper rear right perspective view of a base and drill guide assembly of a pocket hole drilling system, in accordance with one or more arrangements.

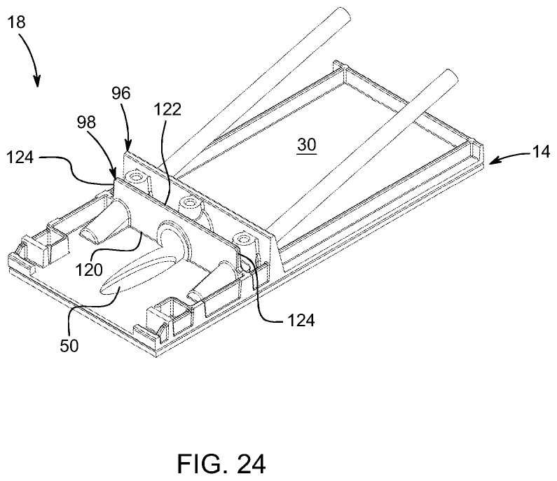

FIG. 25 shows a rear view of a base and drill guide assembly of a pocket hole drilling system, in accordance with one or more arrangements.

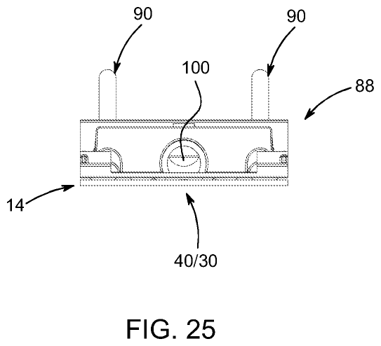

FIG. 26 shows a lower rear right perspective view of a base and drill guide assembly of a pocket hole drilling system, in accordance with one or more arrangements.

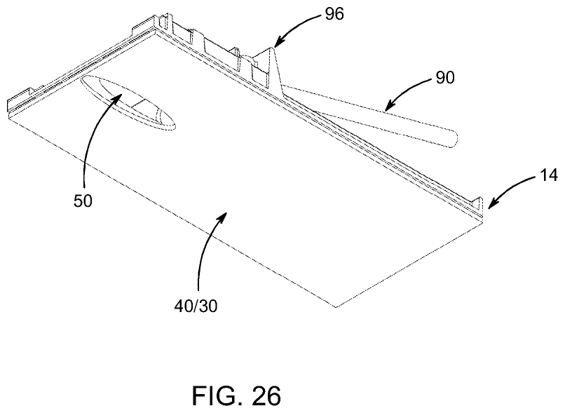

FIG. 27 shows a lower rear left perspective view of a base and drill guide assembly of a pocket hole drilling system, in accordance with one or more arrangements.

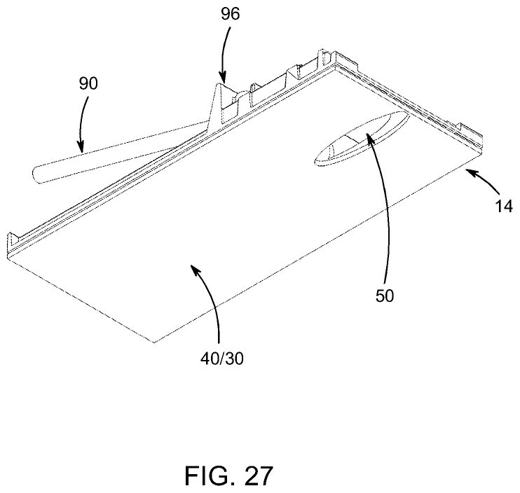

FIG. 28 shows a lower front right perspective view of a base and drill guide assembly of a pocket hole drilling system, in accordance with one or more arrangements.

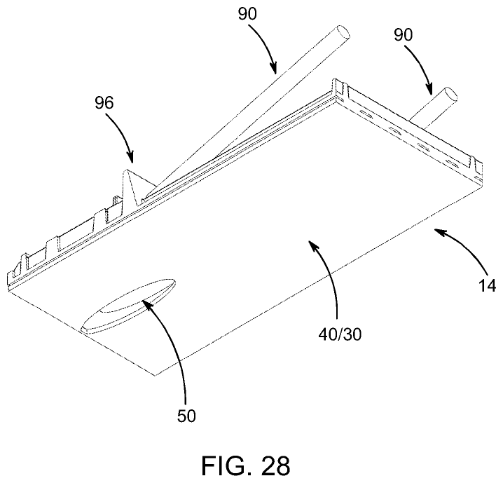

FIG. 29 shows a lower front left perspective view of a base and drill guide assembly of a pocket hole drilling system, in accordance with one or more arrangements.

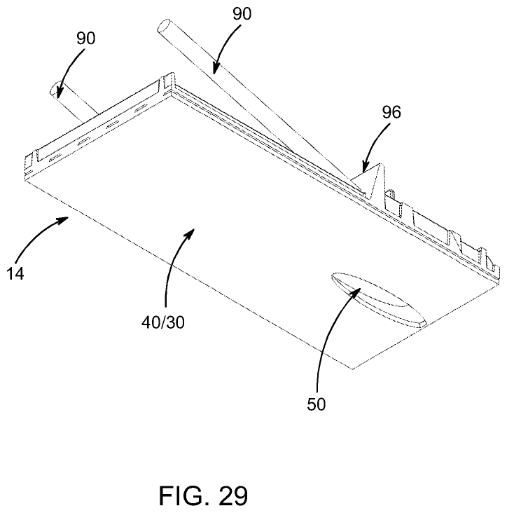

FIG. 30 shows a bottom view of a base and drill guide assembly of a pocket hole drilling system, in accordance with one or more arrangements.

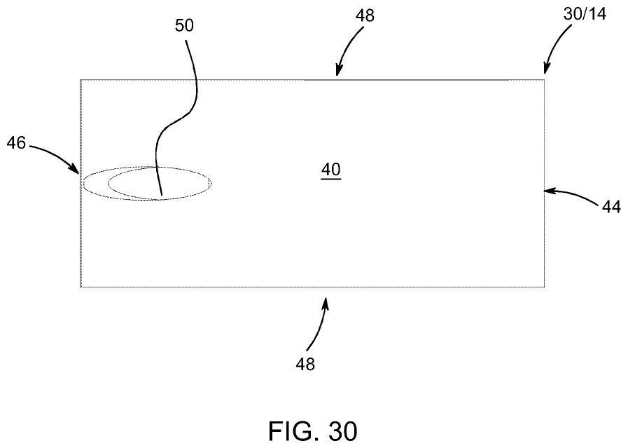

FIG. 31 shows a bottom view of a base and drill guide assembly of a pocket hole drilling system, in accordance with one or more arrangements.

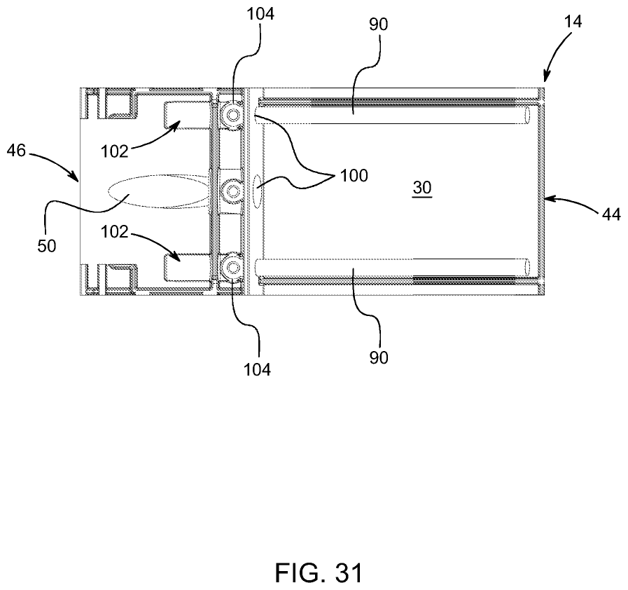

FIG. 32 shows a left side view of a base and drill guide assembly of a pocket hole drilling system, in accordance with one or more arrangements.

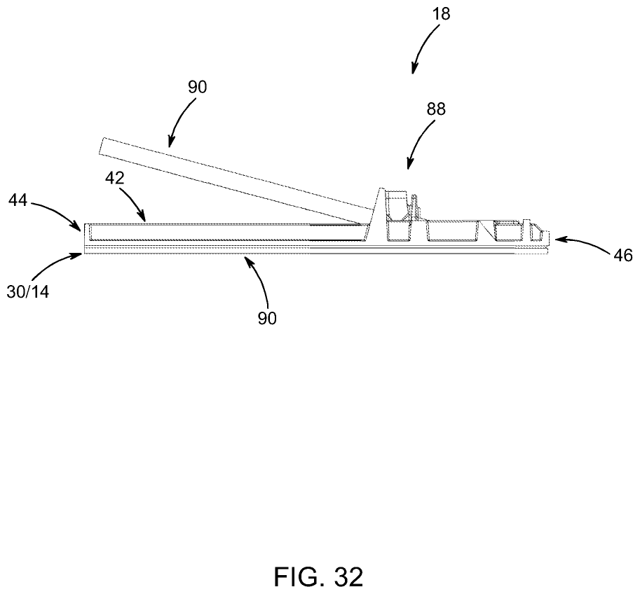

FIG. 33 shows a right side view of a base and drill guide assembly of a pocket hole drilling system, in accordance with one or more arrangements.

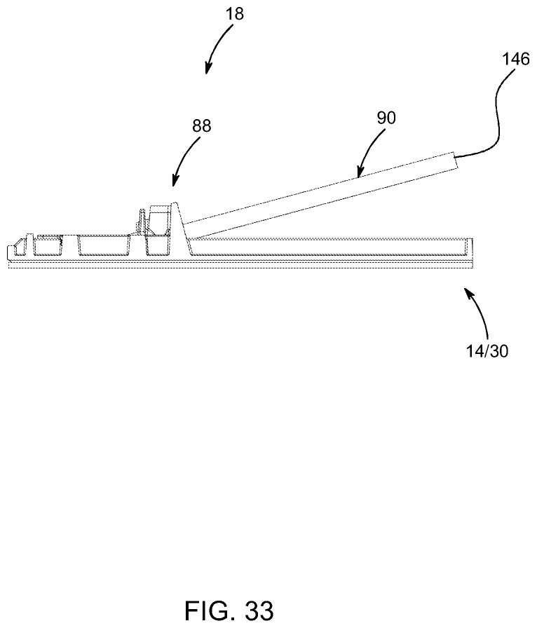

FIG. 34 shows a front view of a handle of an actuating assembly of a pocket hole drilling system, in accordance with one or more arrangements.

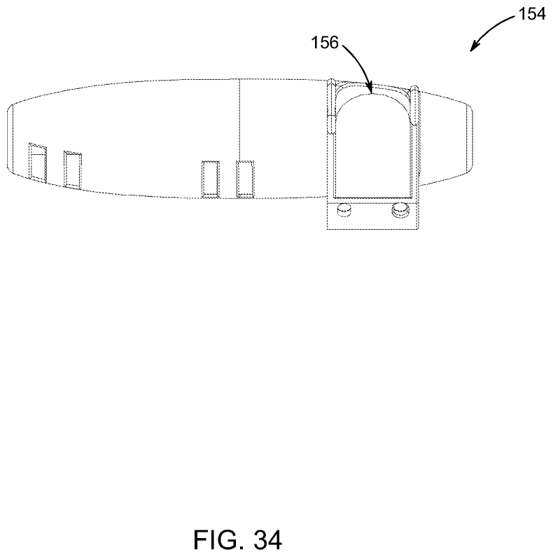

FIG. 35 shows a right side view of a handle of an actuating assembly of a pocket hole drilling system, in accordance with one or more arrangements.

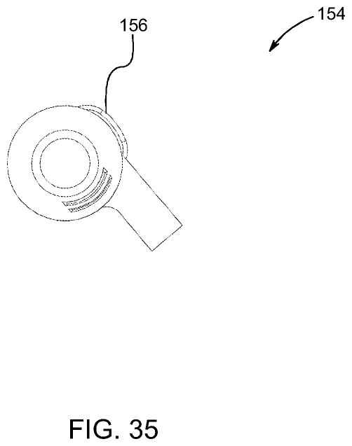

FIG. 36 shows a lower front left perspective view of a handle of an actuating assembly of a pocket hole drilling system, in accordance with one or more arrangements.

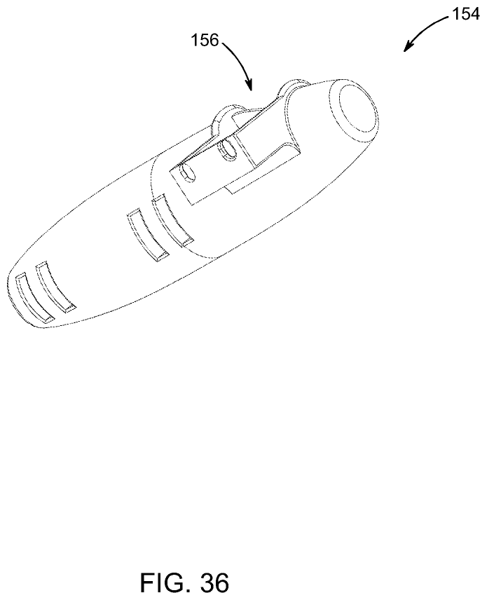

FIG. 37 shows a bottom view of a handle of an actuating assembly of a pocket hole drilling system, in accordance with one or more arrangements.

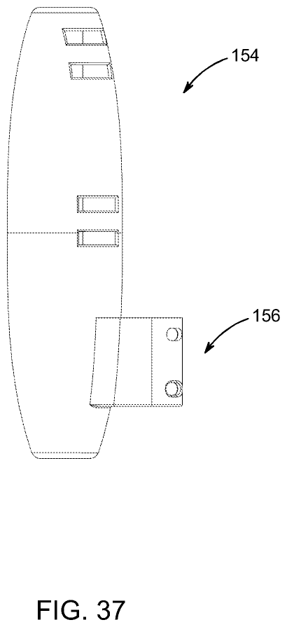

FIG. 38 shows a rear view of a handle of an actuating assembly of a pocket hole drilling system, in accordance with one or more arrangements.

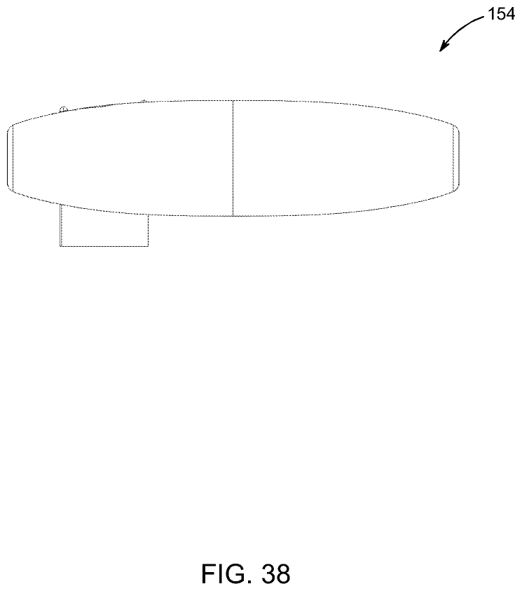

FIG. 39 shows a left side view of a handle of an actuating assembly of a pocket hole drilling system, in accordance with one or more arrangements.

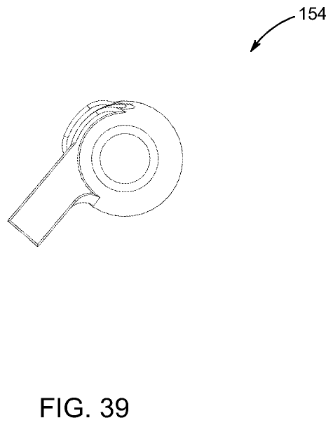

FIG. 40 shows an upper rear left perspective view of a handle of an actuating assembly of a pocket hole drilling system, in accordance with one or more arrangements.

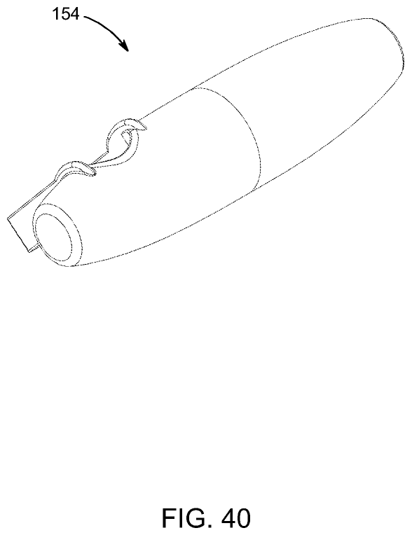

FIG. 41 shows an upper front left perspective view of a handle of an actuating assembly of a pocket hole drilling system, in accordance with one or more arrangements.

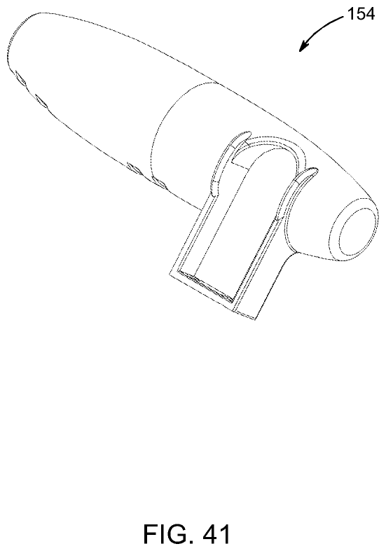

FIG. 42 shows an upper rear left perspective view of a handle of an actuating assembly of a pocket hole drilling system, in accordance with one or more arrangements.

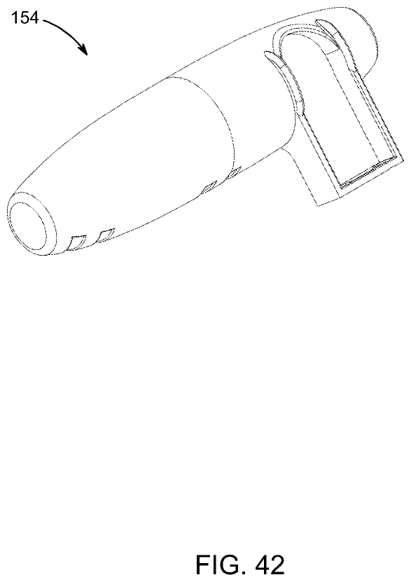

FIG. 43 shows an upper rear right perspective view of a handle of an actuating assembly of a pocket hole drilling system, in accordance with one or more arrangements.

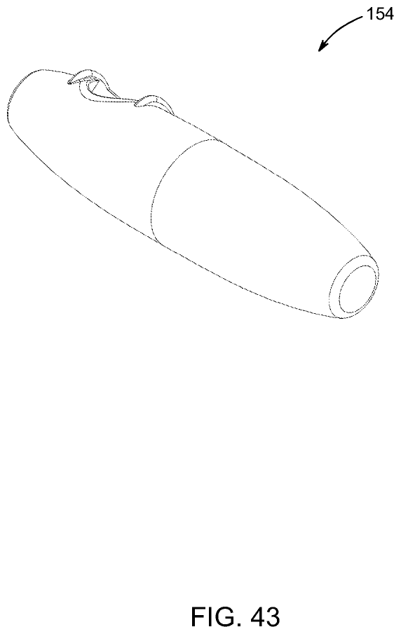

FIG. 44 shows a top view of a handle of an actuating assembly of a pocket hole drilling system, in accordance with one or more arrangements.

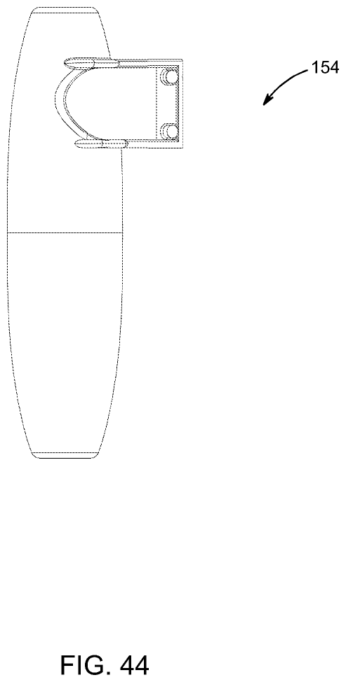

FIG. 45 shows an upper front left perspective view of a switch for a handle of an actuating assembly of a pocket hole drilling system, in accordance with one or more arrangements.

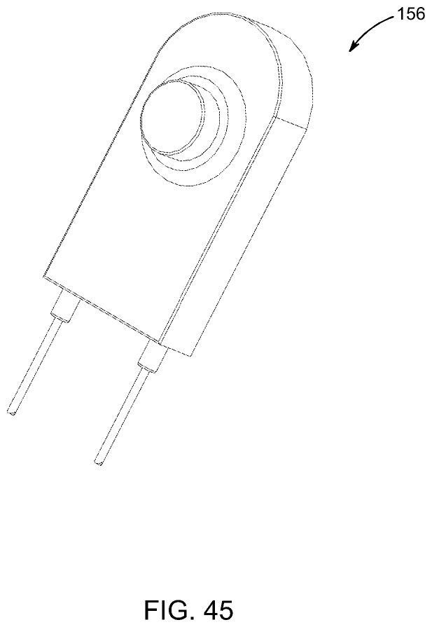

FIG. 46 shows a front view of a switch for a handle of an actuating assembly of a pocket hole drilling system, in accordance with one or more arrangements.

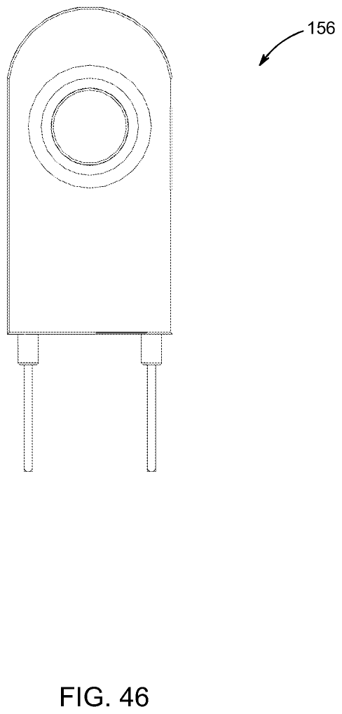

FIG. 47 shows a rear view of a switch for a handle of an actuating assembly of a pocket hole drilling system, in accordance with one or more arrangements.

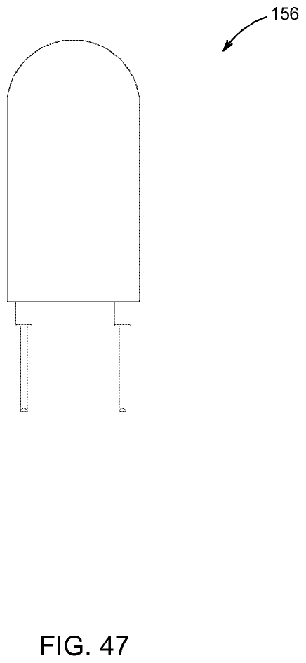

FIG. 48 shows an upper rear right perspective view of a lever of an actuating assembly of a pocket hole drilling system, in accordance with one or more arrangements.

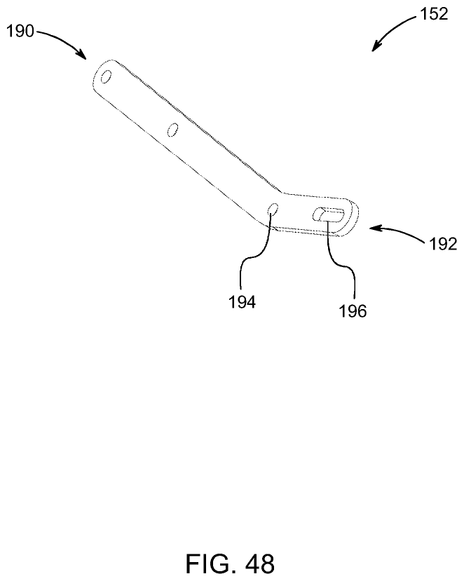

FIG. 49 shows an upper rear left perspective view of a lever of an actuating assembly of a pocket hole drilling system, in accordance with one or more arrangements.

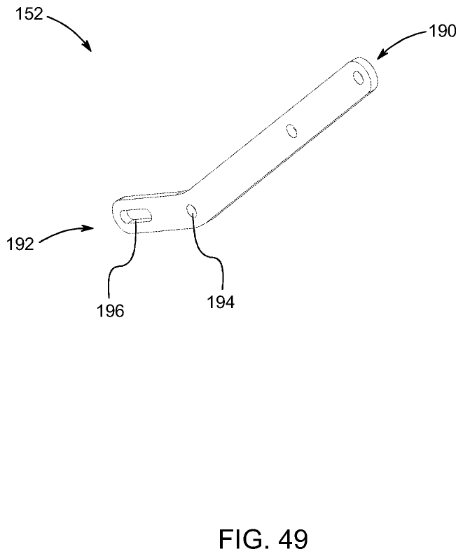

FIG. 50 shows a lower front right perspective view of a lever of an actuating assembly of a pocket hole drilling system, in accordance with one or more arrangements.

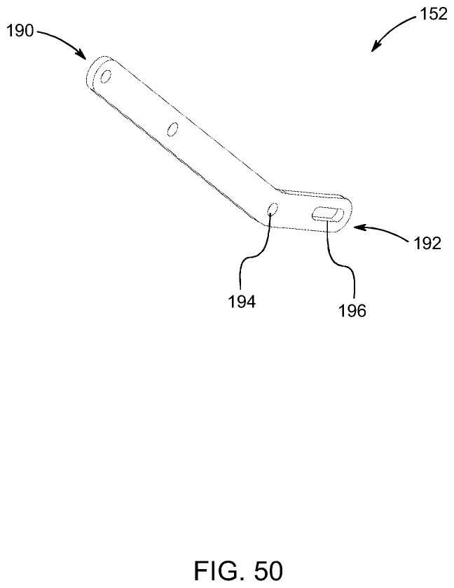

FIG. 51 shows a left side view of a lever of an actuating assembly of a pocket hole drilling system, in accordance with one or more arrangements.

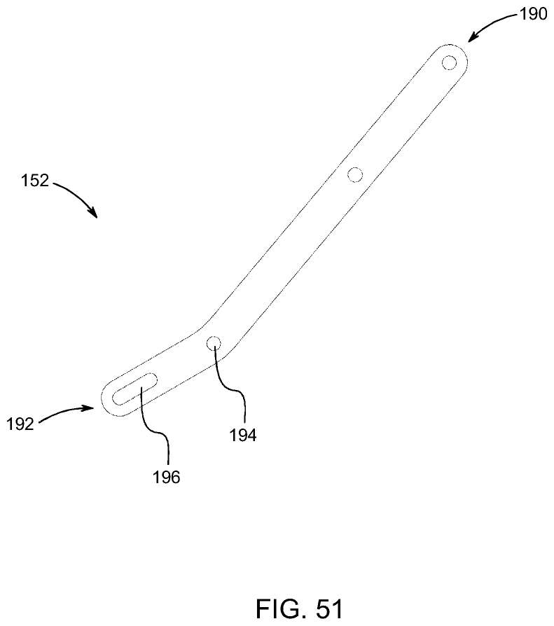

FIG. 52 shows a right side view of a lever of an actuating assembly of a pocket hole drilling system, in accordance with one or more arrangements.

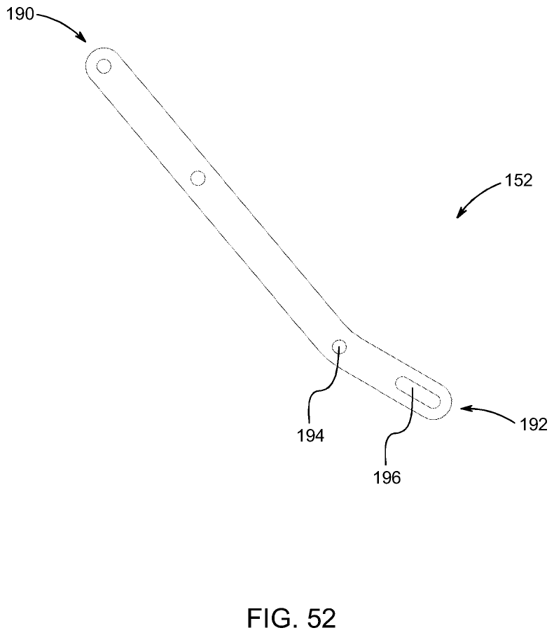

FIG. 53 shows a lower front right perspective view of a fulcrum bracket of an actuating assembly of a pocket hole drilling system, in accordance with one or more arrangements.

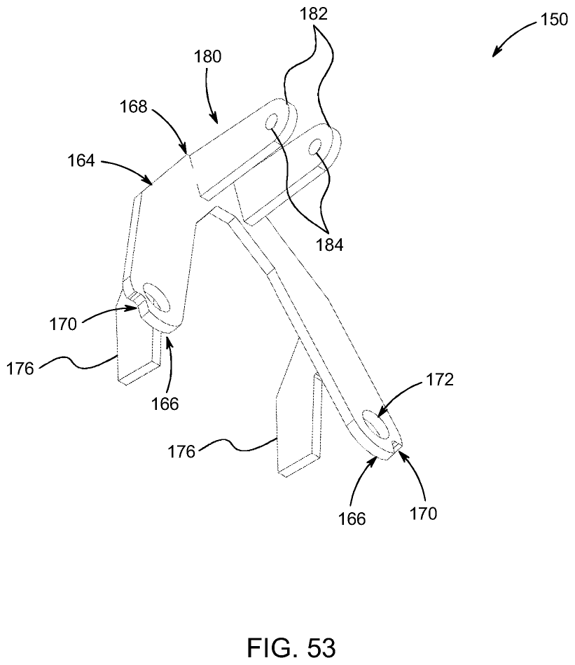

FIG. 54 shows a lower rear left perspective view of a fulcrum bracket of an actuating assembly of a pocket hole drilling system, in accordance with one or more arrangements.

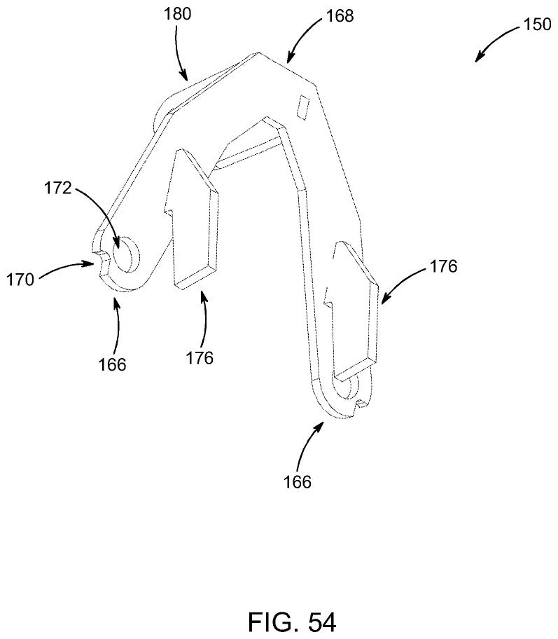

FIG. 55 shows a front view of a fulcrum bracket of an actuating assembly of a pocket hole drilling system, in accordance with one or more arrangements.

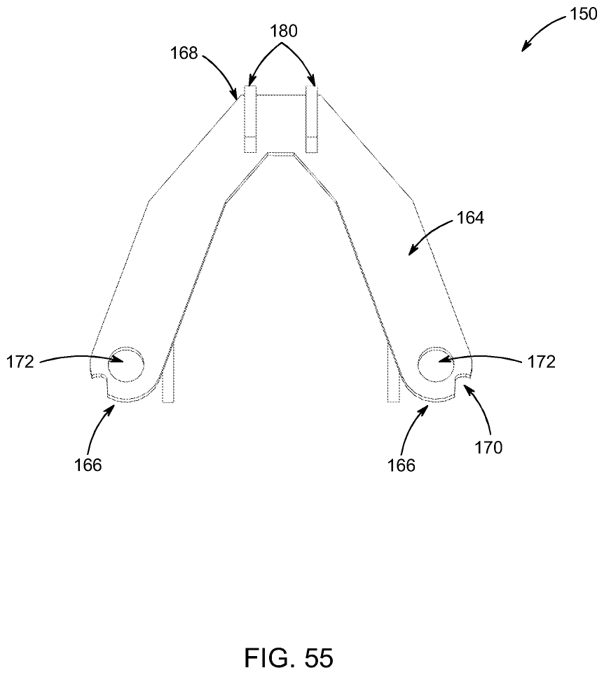

FIG. 56 shows a bottom view of a fulcrum bracket of an actuating assembly of a pocket hole drilling system, in accordance with one or more arrangements.

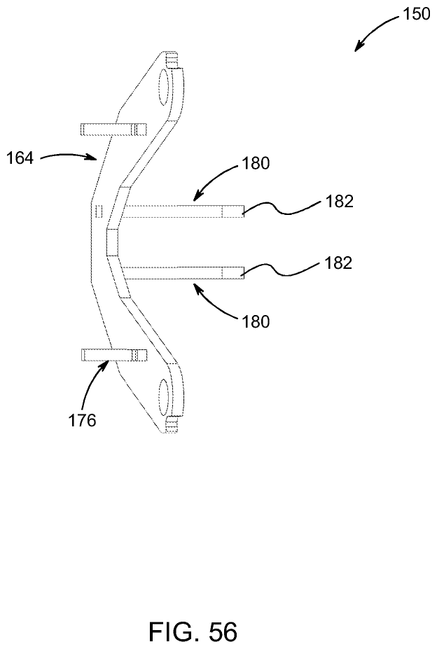

FIG. 57 shows a rear view of a fulcrum bracket of an actuating assembly of a pocket hole drilling system, in accordance with one or more arrangements.

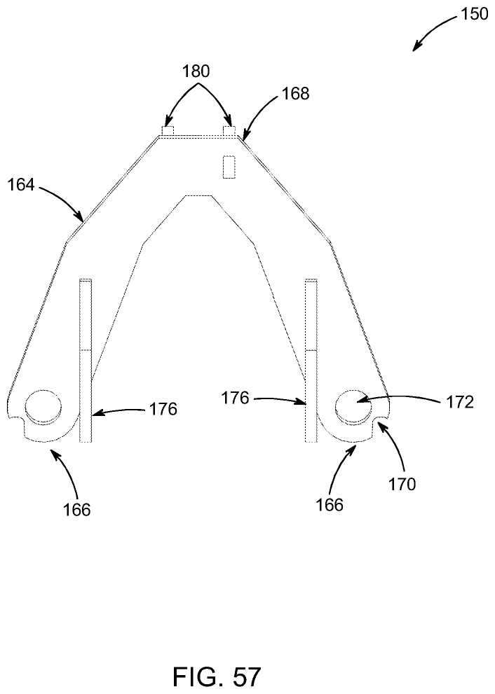

FIG. 58 shows a left side view of a fulcrum bracket of an actuating assembly of a pocket hole drilling system, in accordance with one or more arrangements.

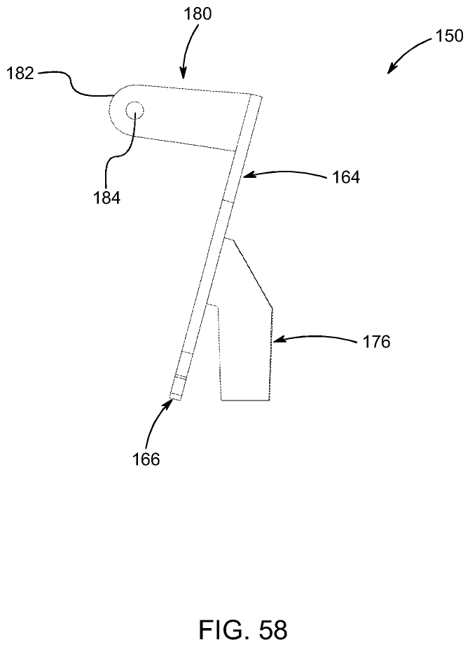

FIG. 59 shows a right side view of a fulcrum bracket of an actuating assembly of a pocket hole drilling system, in accordance with one or more arrangements.

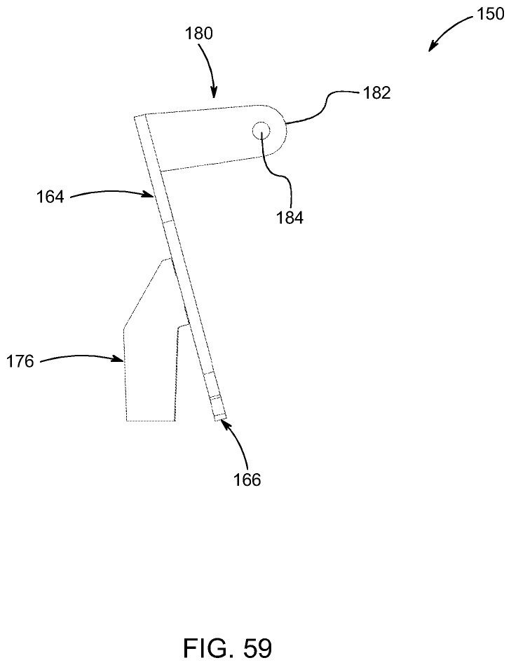

FIG. 60 shows a lower rear right perspective view of a fulcrum bracket of an actuating assembly of a pocket hole drilling system, in accordance with one or more arrangements.

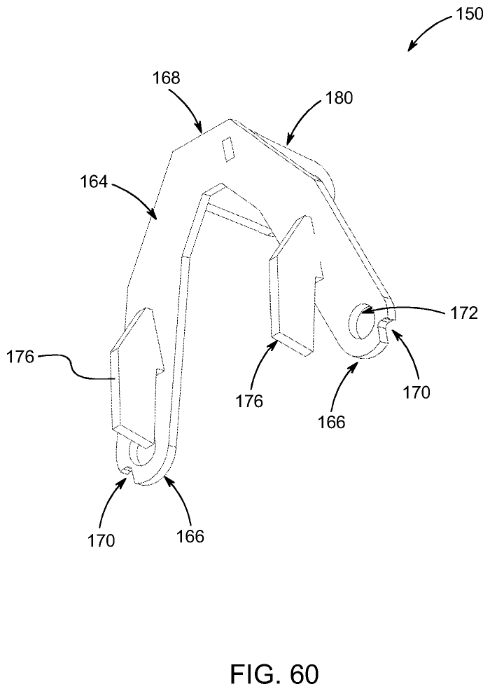

FIG. 61 shows an upper front right perspective view of a fulcrum bracket of an actuating assembly of a pocket hole drilling system, in accordance with one or more arrangements.

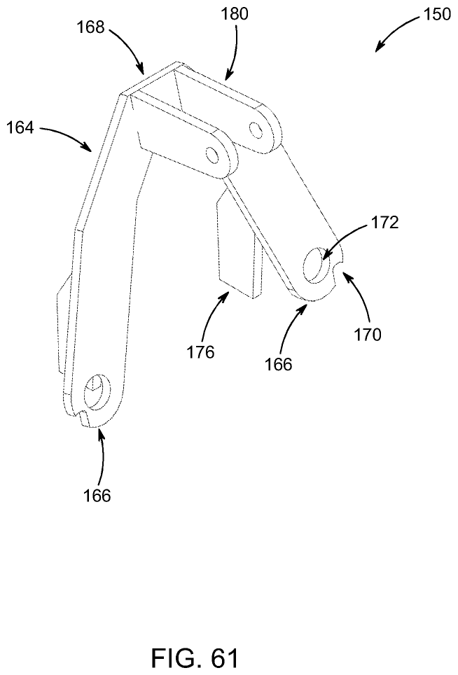

FIG. 62 shows an upper rear left perspective view of a fulcrum bracket of an actuating assembly of a pocket hole drilling system, in accordance with one or more arrangements.

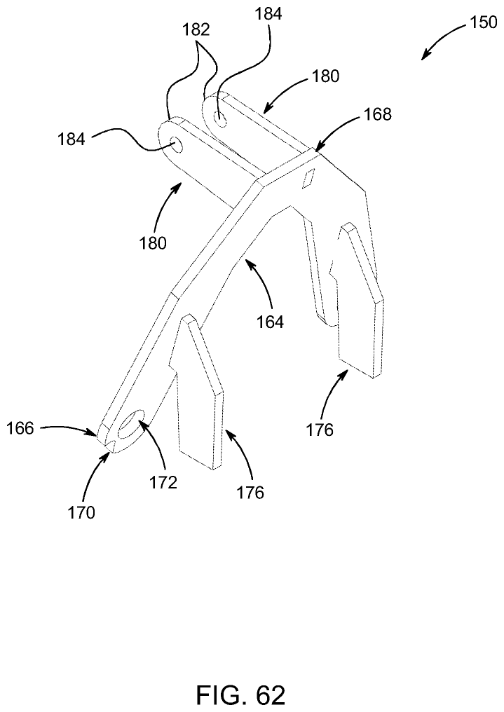

FIG. 63 shows an upper rear right perspective view of a fulcrum bracket of an actuating assembly of a pocket hole drilling system, in accordance with one or more arrangements.

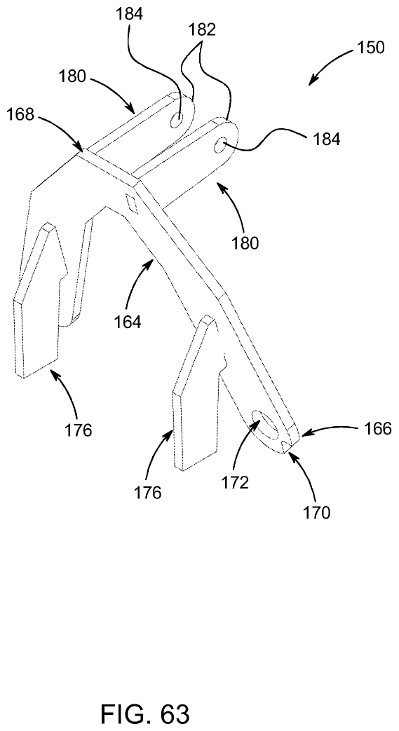

FIG. 64 shows a top view of a fulcrum bracket of an actuating assembly of a pocket hole drilling system, in accordance with one or more arrangements.

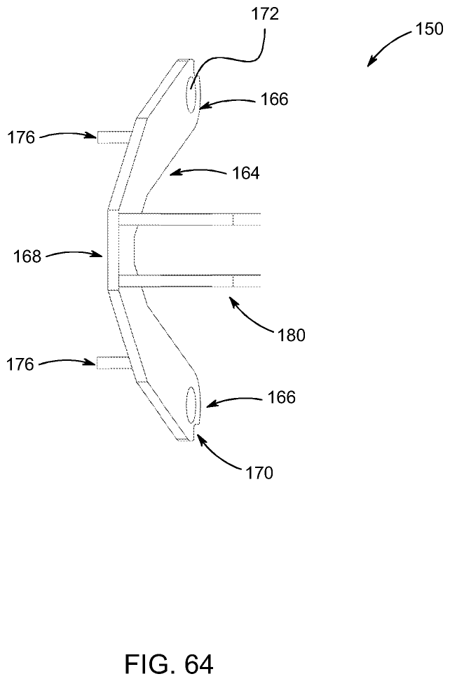

FIG. 65 shows a lower rear left perspective view of a rear handle assembly of a pocket hole drilling system, in accordance with one or more arrangements.

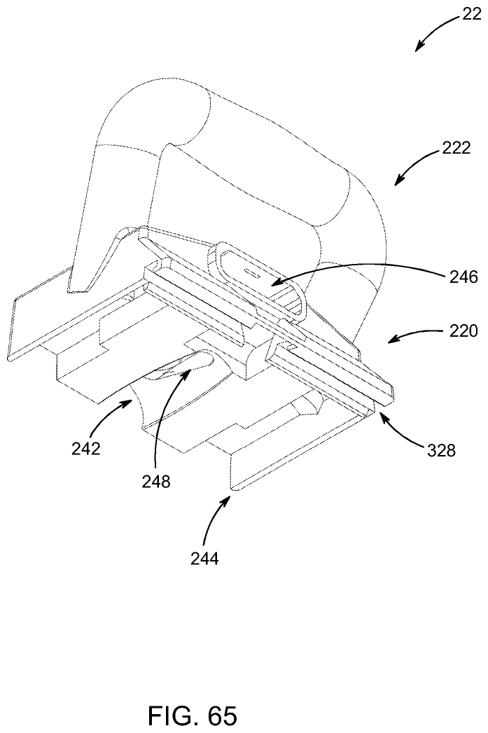

FIG. 66 shows a lower rear right perspective view of a rear handle assembly of a pocket hole drilling system, in accordance with one or more arrangements.

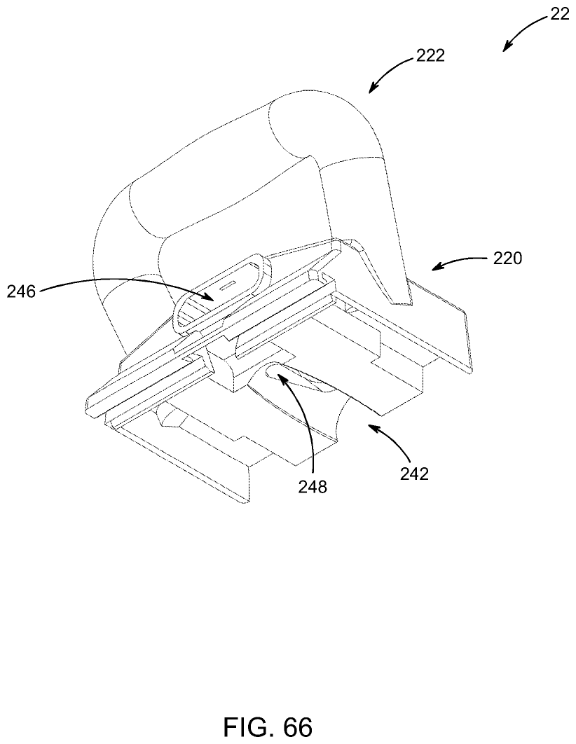

FIG. 67 shows a lower front right perspective view of a rear handle assembly of a pocket hole drilling system, in accordance with one or more arrangements.

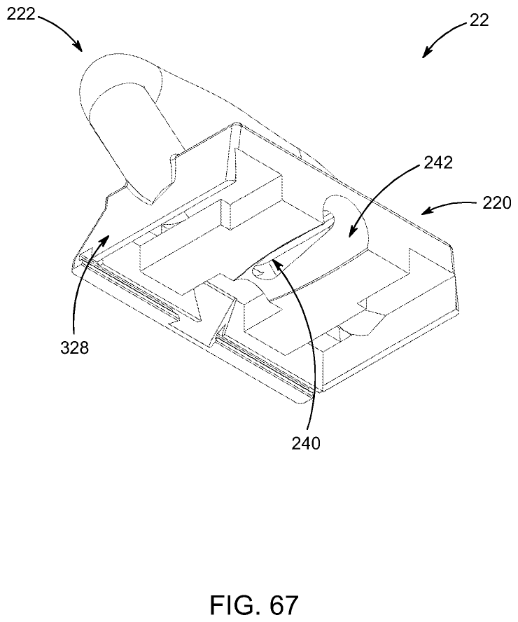

FIG. 68 shows a lower front left perspective view of a rear handle assembly of a pocket hole drilling system, in accordance with one or more arrangements.

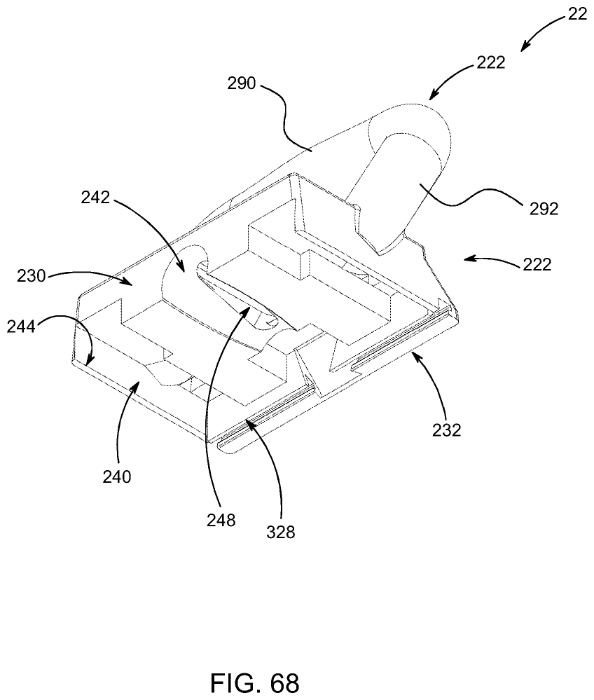

FIG. 69 shows a front view of a rear handle assembly of a pocket hole drilling system, in accordance with one or more arrangements.

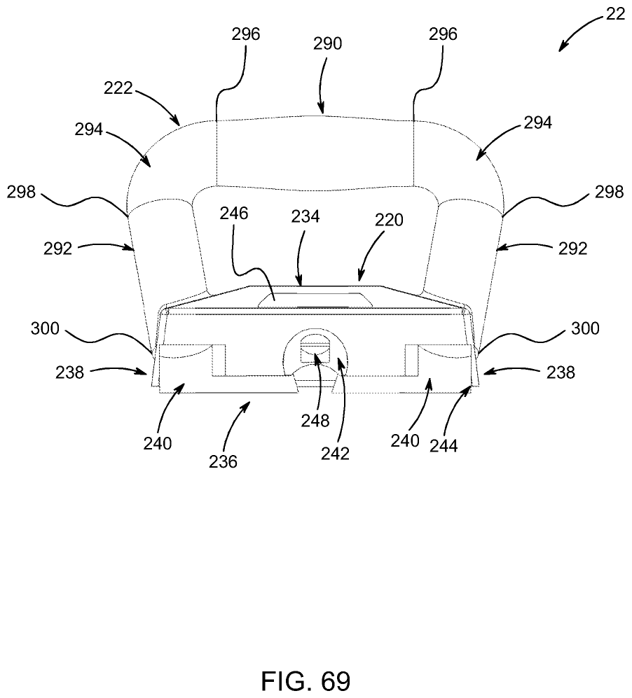

FIG. 70 shows a rear view of a rear handle assembly of a pocket hole drilling system, in accordance with one or more arrangements.

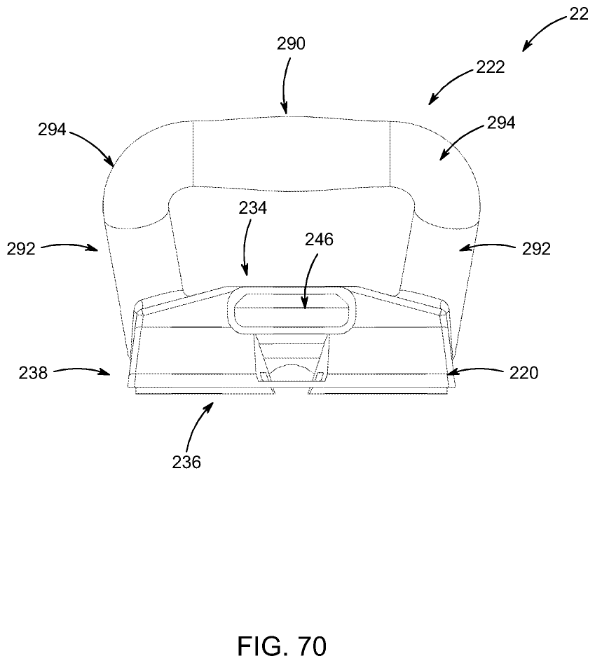

FIG. 71 shows a left view of a rear handle assembly of a pocket hole drilling system, in accordance with one or more arrangements.

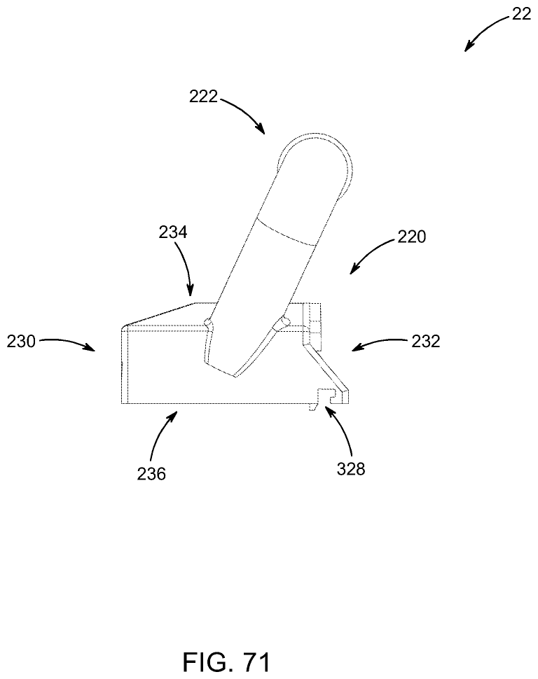

FIG. 72 shows a right view of a rear handle assembly of a pocket hole drilling system, in accordance with one or more arrangements.

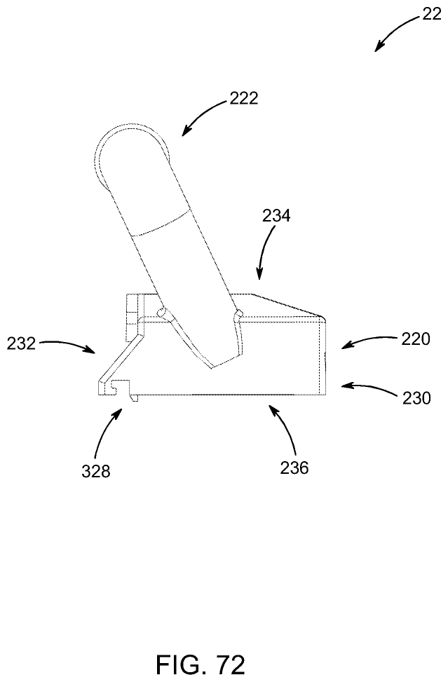

FIG. 73 shows an upper front left perspective view of a rear handle assembly of a pocket hole drilling system, in accordance with one or more arrangements.

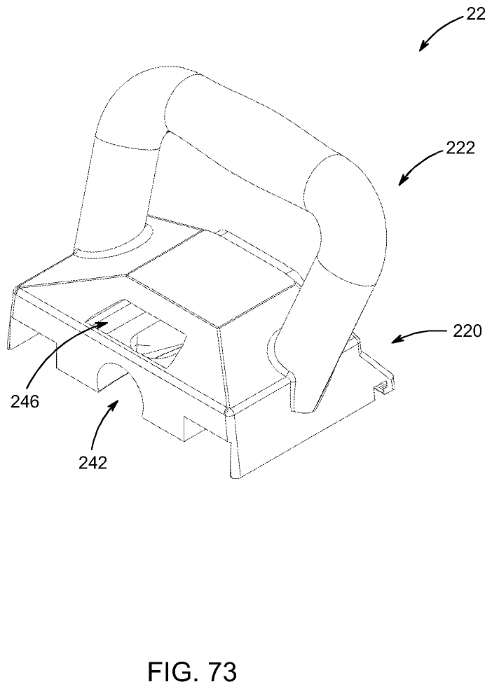

FIG. 74 shows an upper front right perspective view of a rear handle assembly of a pocket hole drilling system, in accordance with one or more arrangements.

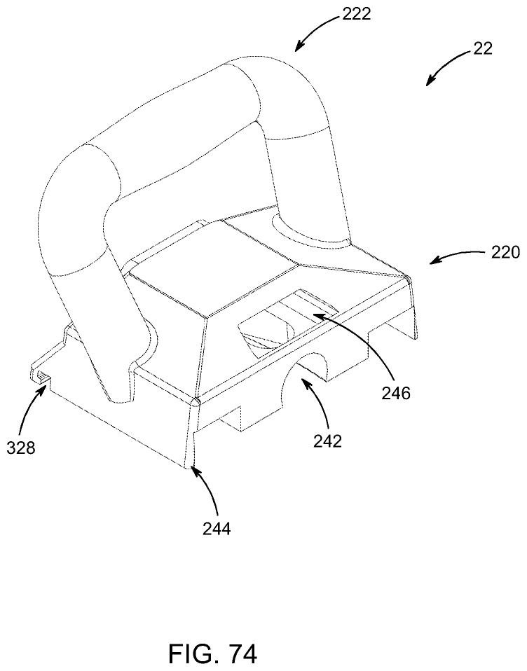

FIG. 75 shows an upper rear left perspective view of a rear handle assembly of a pocket hole drilling system, in accordance with one or more arrangements.

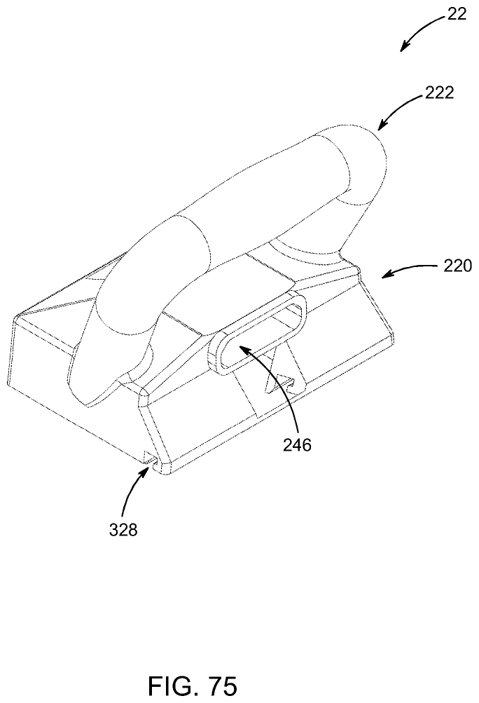

FIG. 76 shows an upper rear right perspective view of a rear handle assembly of a pocket hole drilling system, in accordance with one or more arrangements.

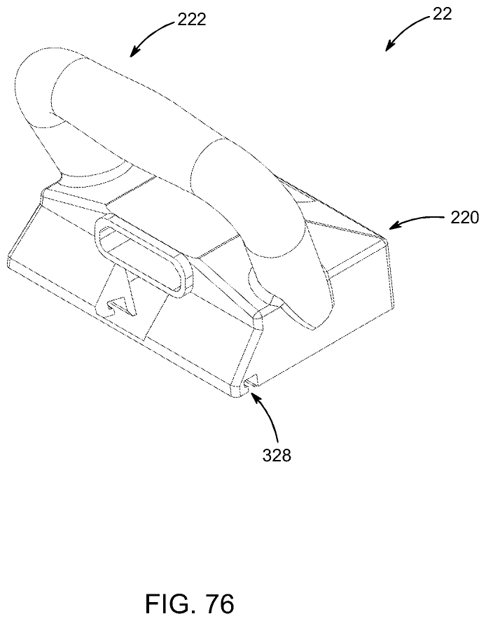

FIG. 77 shows a top view of a rear handle assembly of a pocket hole drilling system, in accordance with one or more arrangements.

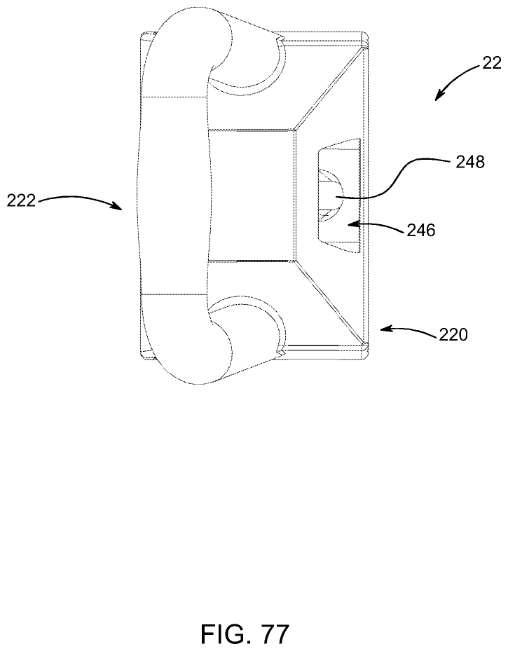

FIG. 78 shows a bottom view of a rear handle assembly of a pocket hole drilling system, in accordance with one or more arrangements.

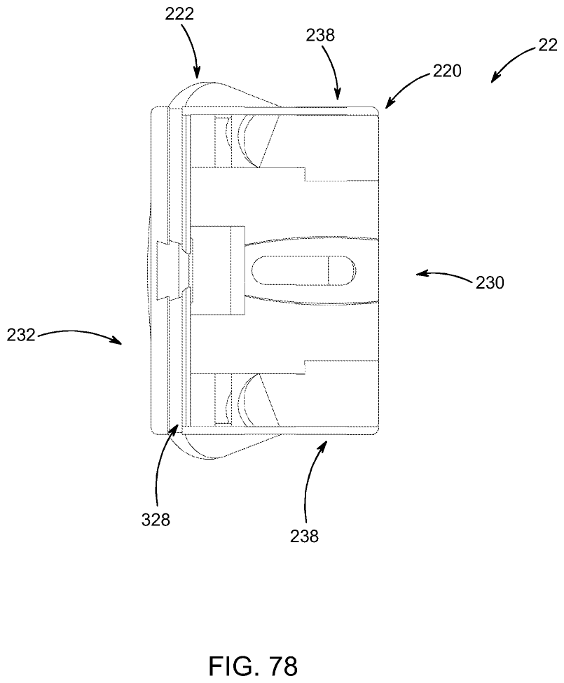

FIG. 79 shows an upper rear right perspective view of a pocket hole drilling system, in accordance with one or more arrangements; the view showing a vacuum connector positioned to connect with a rear end of the system.

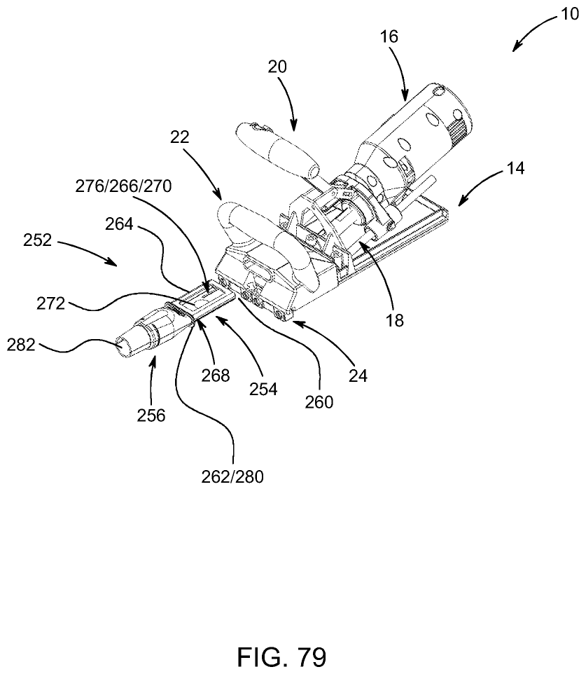

FIG. 80 shows a right side view of a pocket hole drilling system, in accordance with one or more arrangements; the view showing a vacuum connector connected with a rear end of the system to facilitate removal of wood chips and shavings created when drilling.

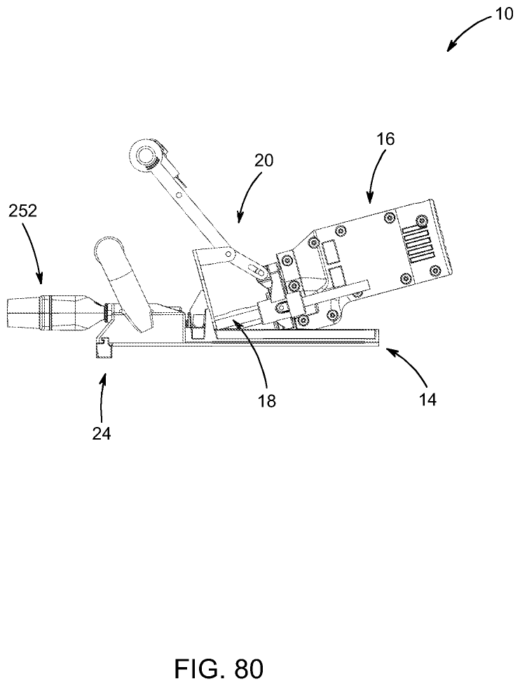

FIG. 81 shows an upper rear right perspective view of a pocket hole drilling system, in accordance with one or more arrangements; the view showing a vacuum connector connected with a rear end of the system to facilitate removal of wood chips and shavings created when drilling.

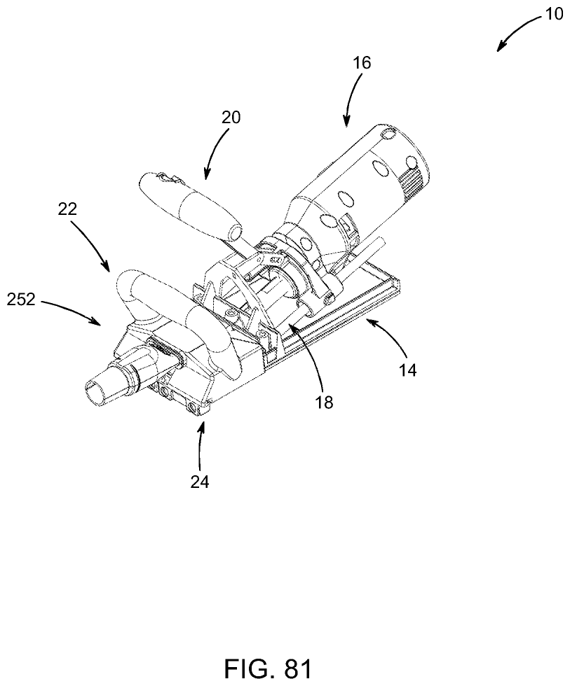

FIG. 82 shows an upper rear right perspective view of a pocket hole drilling system, in accordance with one or more arrangements; the view showing a vacuum connector connected with a rear end of the system to facilitate removal of wood chips and shavings created when drilling; the view showing a bias member spring positioned on a guide rod to facilitate moving the drilling assembly to the retracted position in the absence of an opposing force.

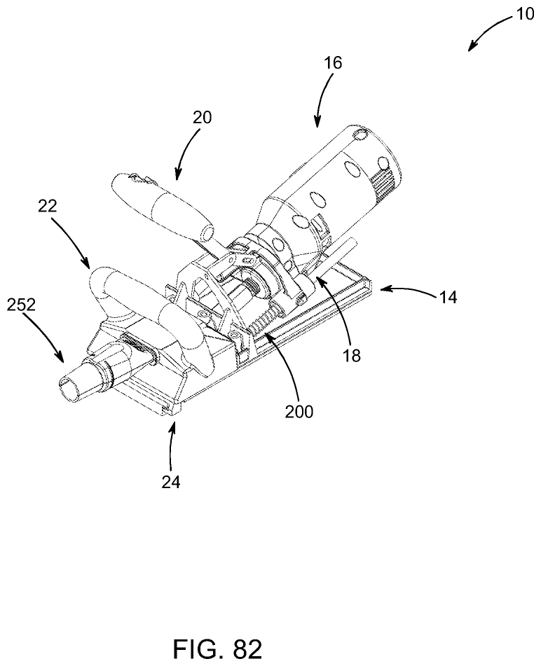

FIG. 83 shows a right side view of a pocket hole drilling system, in accordance with one or more arrangements; the view showing a vacuum connector connected with a rear end of the system to facilitate removal of wood chips and shavings created when drilling; the view showing a bias member spring positioned on a guide rod to facilitate moving the drilling assembly to the retracted position in the absence of an opposing force.

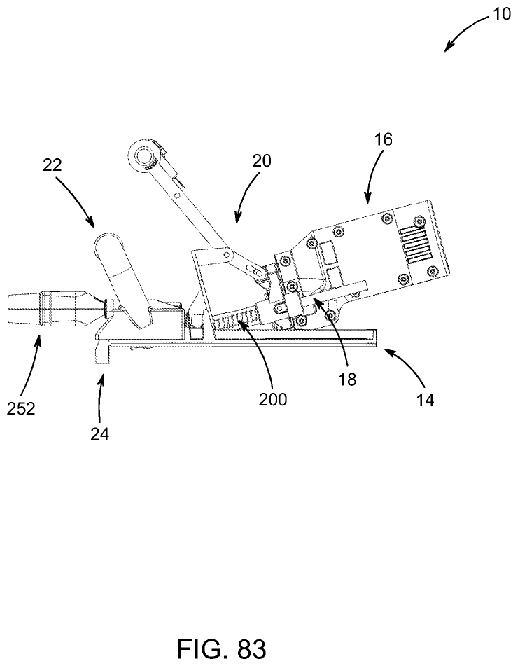

FIG. 84 shows an upper rear left perspective view of a pocket hole drilling system, in accordance with one or more arrangements; the view showing a vacuum connector connected with a rear end of the system to facilitate removal of wood chips and shavings created when drilling; the view showing a bias member spring positioned on a guide rod to facilitate moving the drilling assembly to the retracted position in the absence of an opposing force.

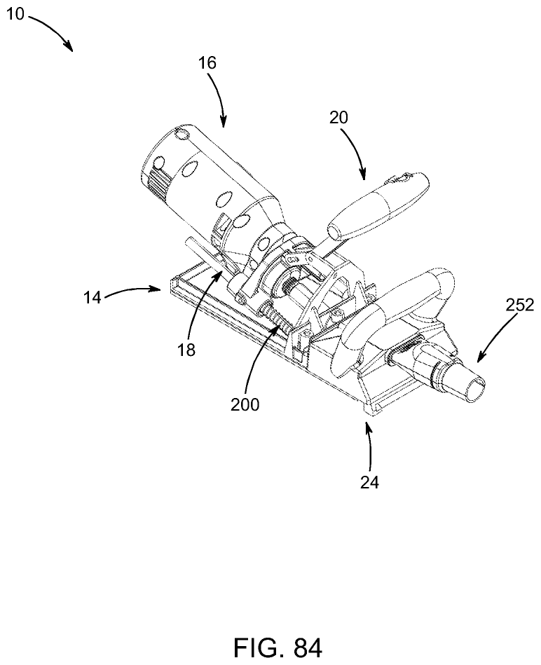

FIG. 85 shows a left side view of a pocket hole drilling system, in accordance with one or more arrangements; the view showing a vacuum connector connected with a rear end of the system to facilitate removal of wood chips and shavings created when drilling; the view showing a bias member spring positioned on a guide rod to facilitate moving the drilling assembly to the retracted position in the absence of an opposing force.

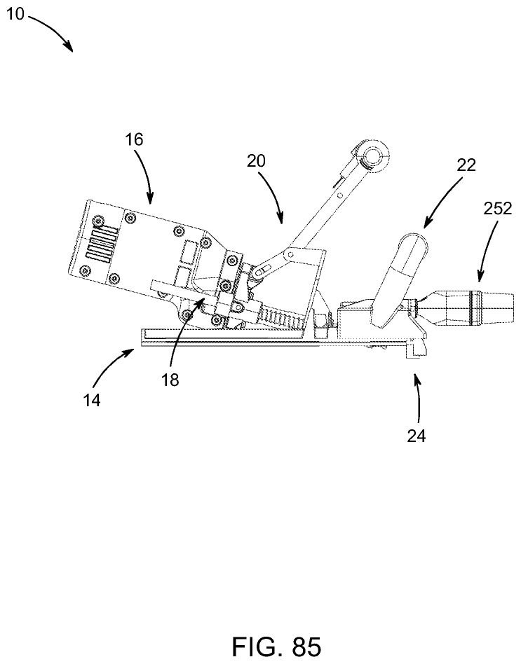

FIG. 86 shows a lower front left perspective view of a lip assembly of a pocket hole drilling system, in accordance with one or more arrangements.

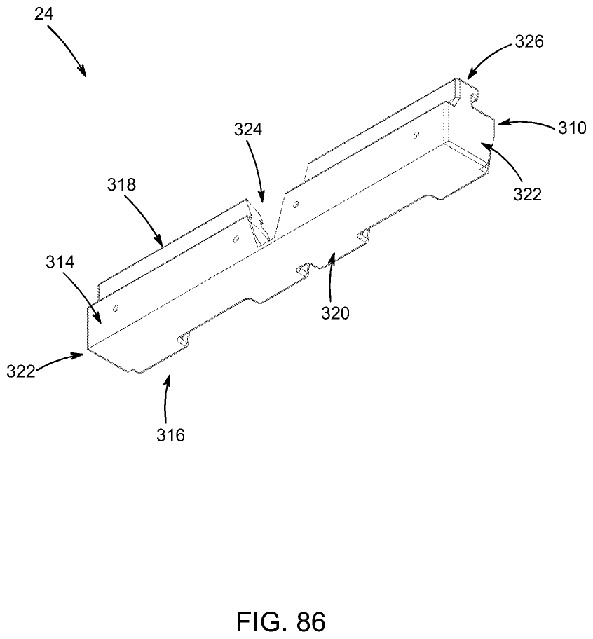

FIG. 87 shows an upper front left perspective view of a lip assembly of a pocket hole drilling system, in accordance with one or more arrangements.

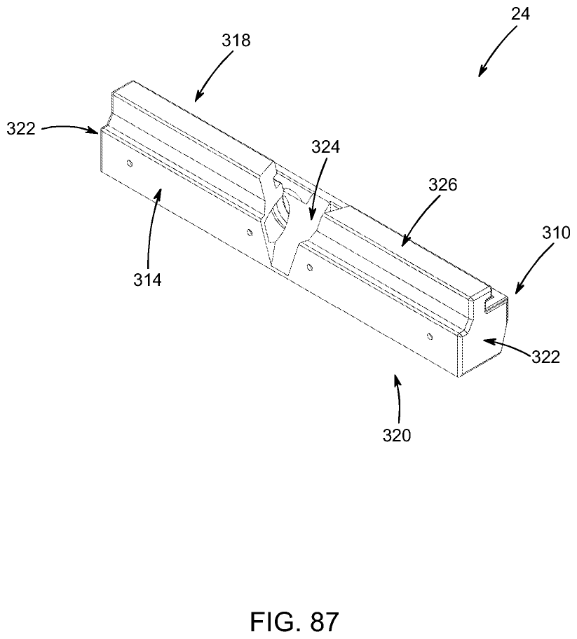

FIG. 88 shows a lower front right perspective view of a lip assembly of a pocket hole drilling system, in accordance with one or more arrangements.

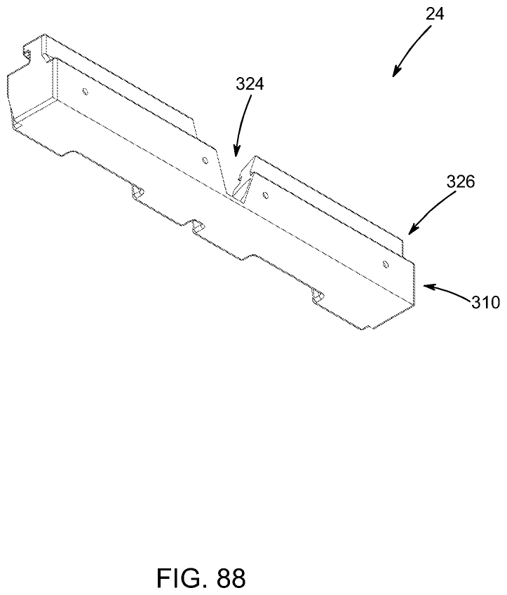

FIG. 89 shows an upper front right perspective view of a lip assembly of a pocket hole drilling system, in accordance with one or more arrangements.

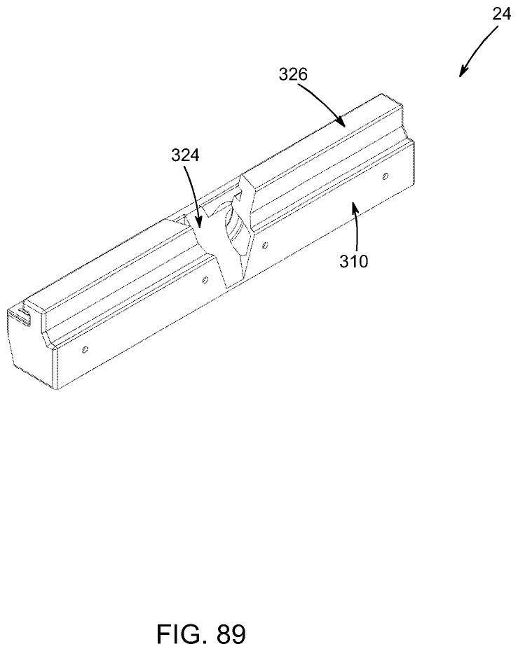

FIG. 90 shows a lower rear left perspective view of a lip assembly of a pocket hole drilling system, in accordance with one or more arrangements.

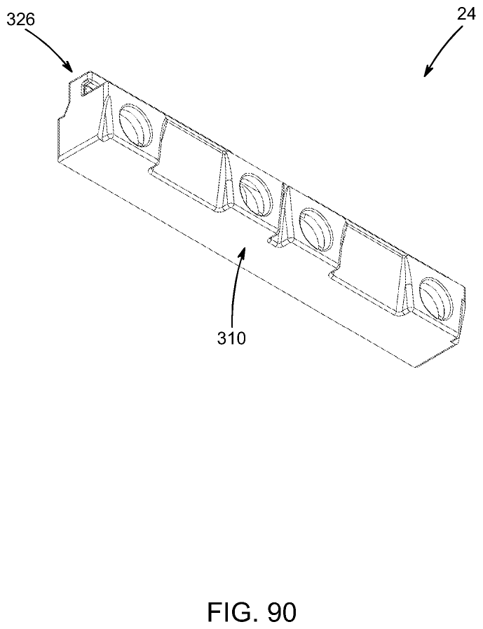

FIG. 91 shows a lower rear right perspective view of a lip assembly of a pocket hole drilling system, in accordance with one or more arrangements.

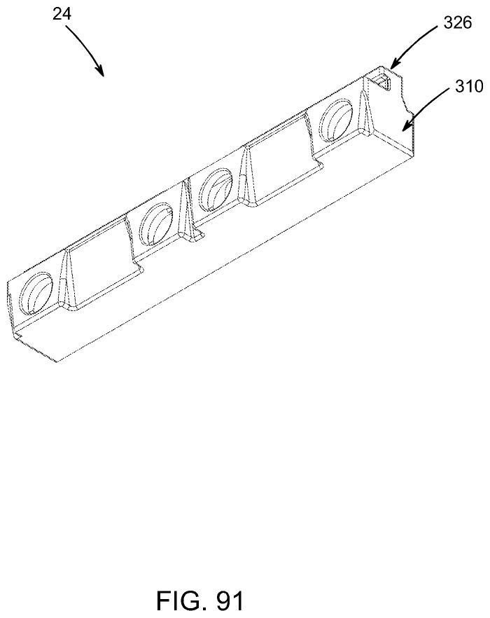

FIG. 92 shows an upper rear left perspective view of a lip assembly of a pocket hole drilling system, in accordance with one or more arrangements.

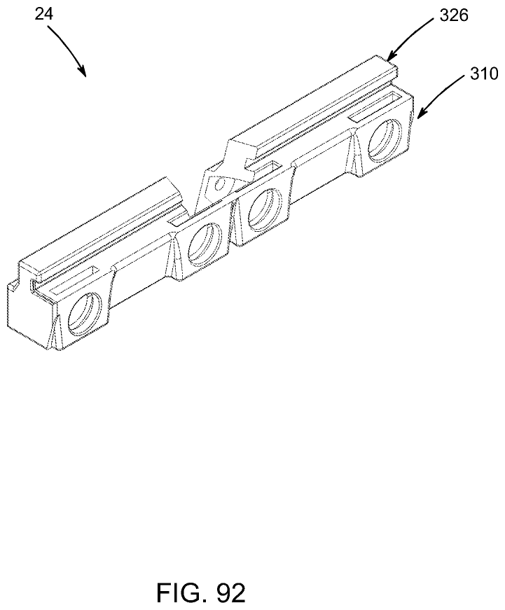

FIG. 93 shows an upper rear right perspective view of a lip assembly of a pocket hole drilling system, in accordance with one or more arrangements.

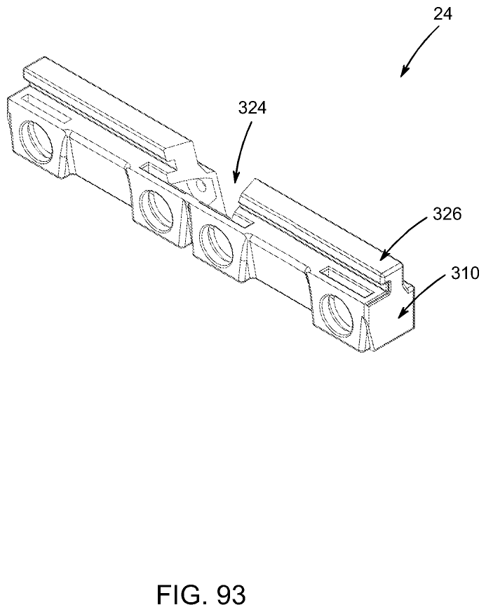

FIG. 94 shows a right side view of a lip assembly of a pocket hole drilling system, in accordance with one or more arrangements.

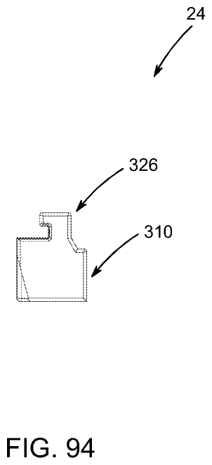

FIG. 95 shows a left side view of a lip assembly of a pocket hole drilling system, in accordance with one or more arrangements.

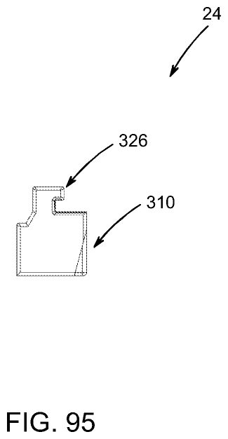

FIG. 96 shows a bottom view of a lip assembly of a pocket hole drilling system, in accordance with one or more arrangements.

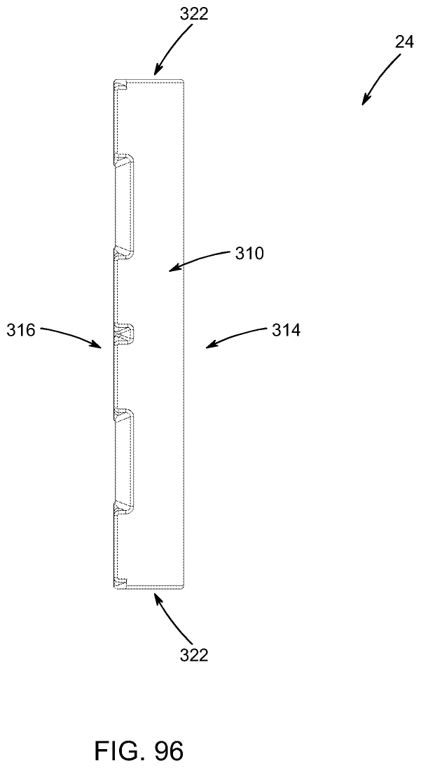

FIG. 97 shows a front view of a lip assembly of a pocket hole drilling system, in accordance with one or more arrangements.

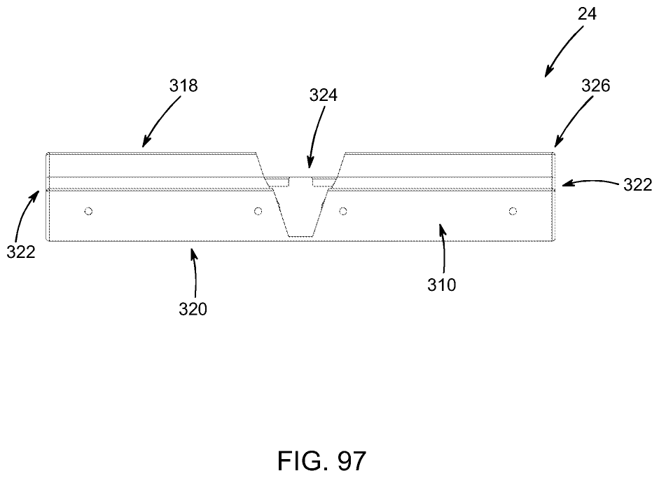

FIG. 98 shows a rear view of a lip assembly of a pocket hole drilling system, in accordance with one or more arrangements.

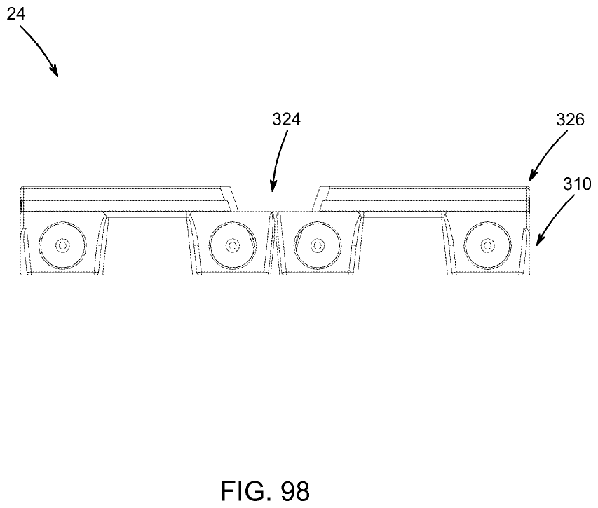

FIG. 99 shows a top side view of a lip assembly of a pocket hole drilling system, in accordance with one or more arrangements.

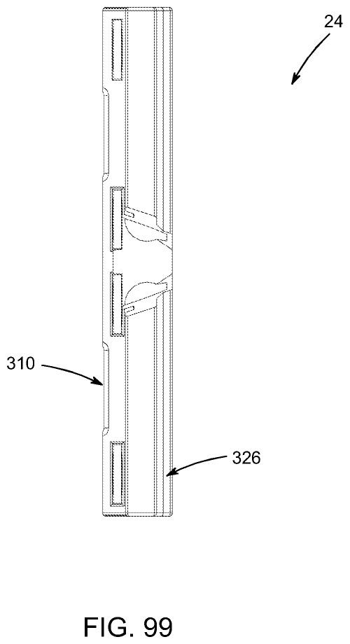

FIG. 100 shows a partially exploded upper rear right perspective view of a pocket hole drilling system, in accordance with one or more arrangements.

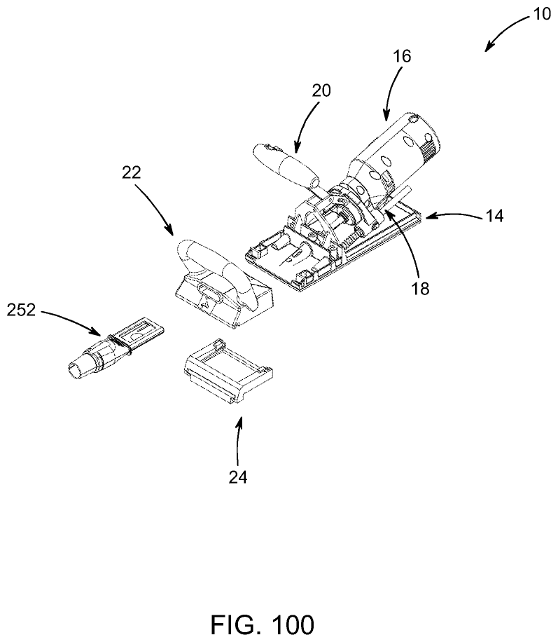

FIG. 101 shows a right side view of a pocket hole drilling system, in accordance with one or more arrangements.

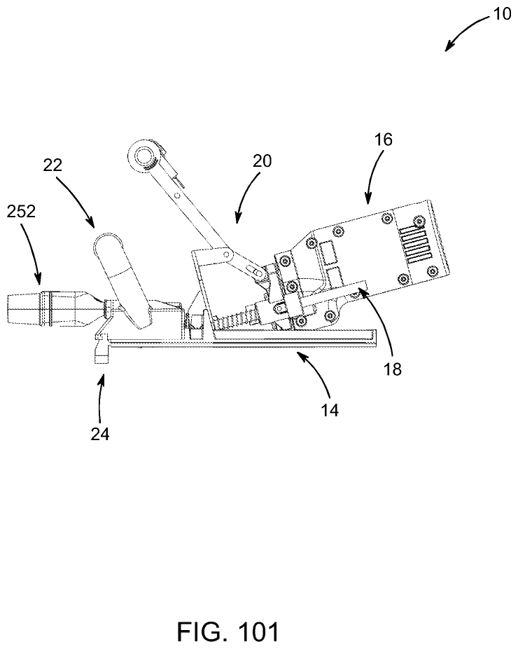

FIG. 102 shows a lower front right perspective view of a pocket hole drilling system, in accordance with one or more arrangements.

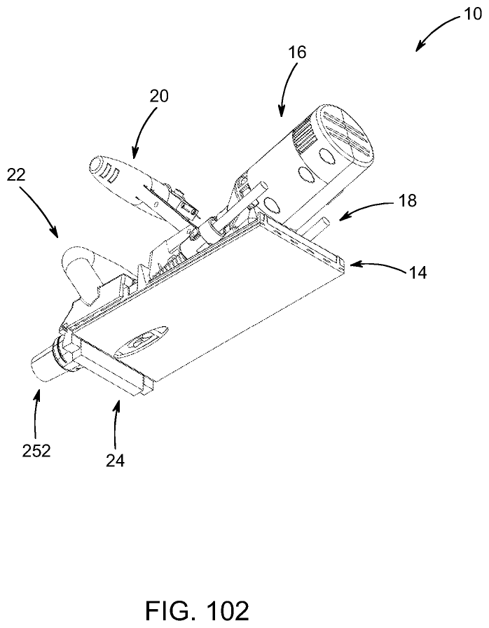

FIG. 103 shows an upper front left perspective view of a pocket hole drilling system, in accordance with one or more arrangements.

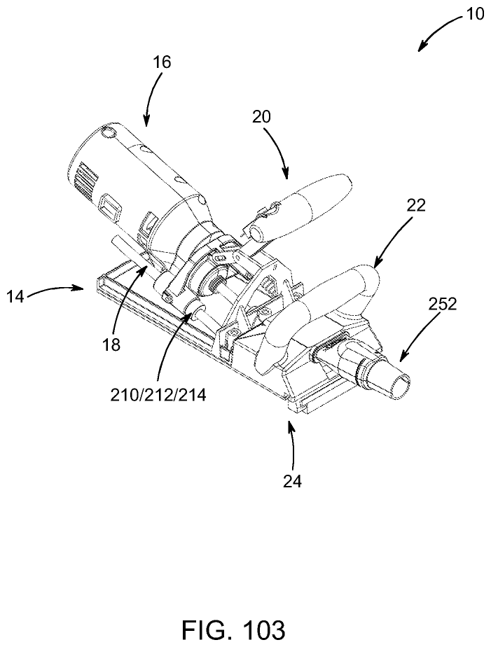

FIG. 104 shows a upper front right perspective view of a pocket hole drilling system, in accordance with one or more arrangements.

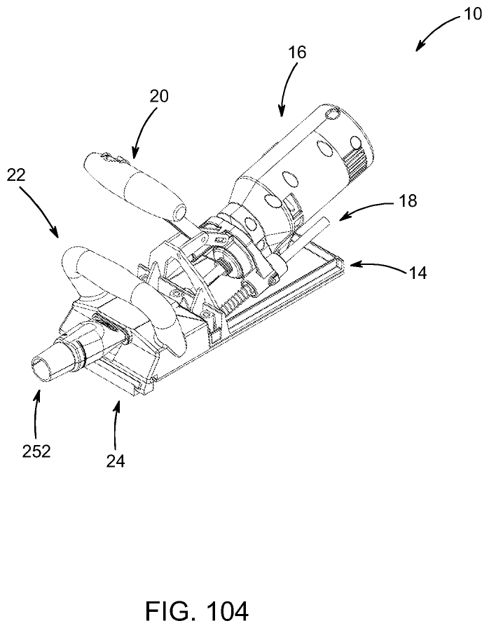

FIG. 105 shows a left side view of a pocket hole drilling system, in accordance with one or more arrangements.

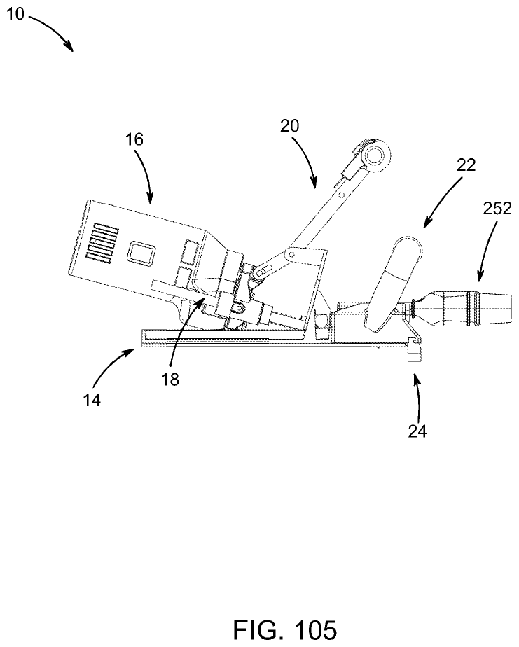

FIG. 106 shows a right side view of a pocket hole drilling system with an adjustable lip assembly, in accordance with one or more arrangements; the view showing a rear handle assembly, the adjustable lip assembly, and a vacuum connector disconnected from the system.

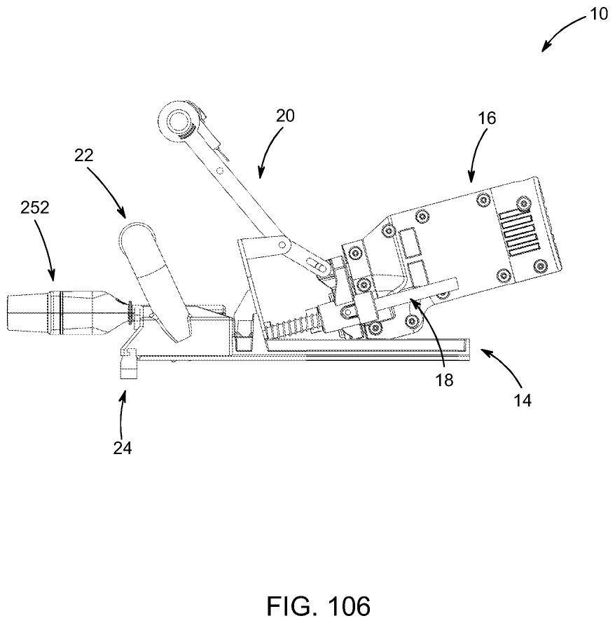

FIG. 107 shows an exploded upper rear right perspective view of an adjustable lip assembly of the pocket hole drilling system shown in FIG. 106, in accordance with one or more arrangements; the view showing a sliding lip member and guide members detached from a receiver of the adjustable lip member.

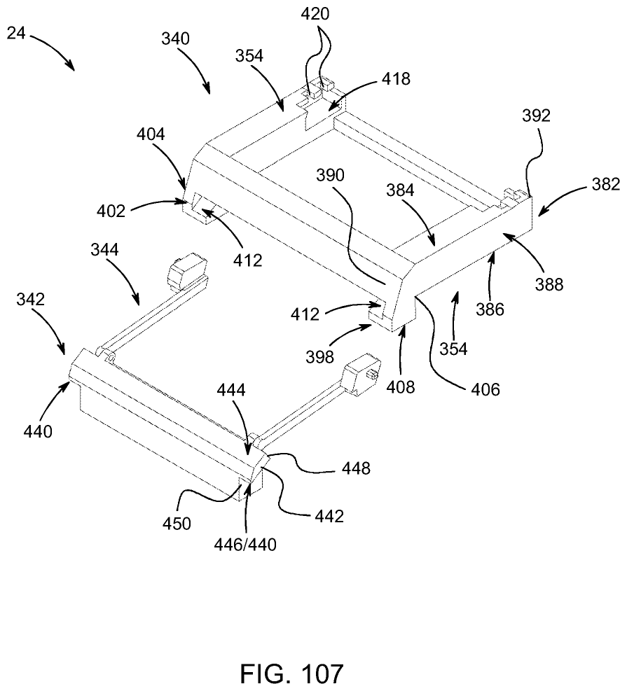

FIG. 108 shows an exploded upper rear right perspective view of an adjustable lip assembly of the pocket hole drilling system shown in FIG. 106, in accordance with one or more arrangements; the view showing a sliding lip member, guide members, and a receiver of the adjustable lip member detached from one another.

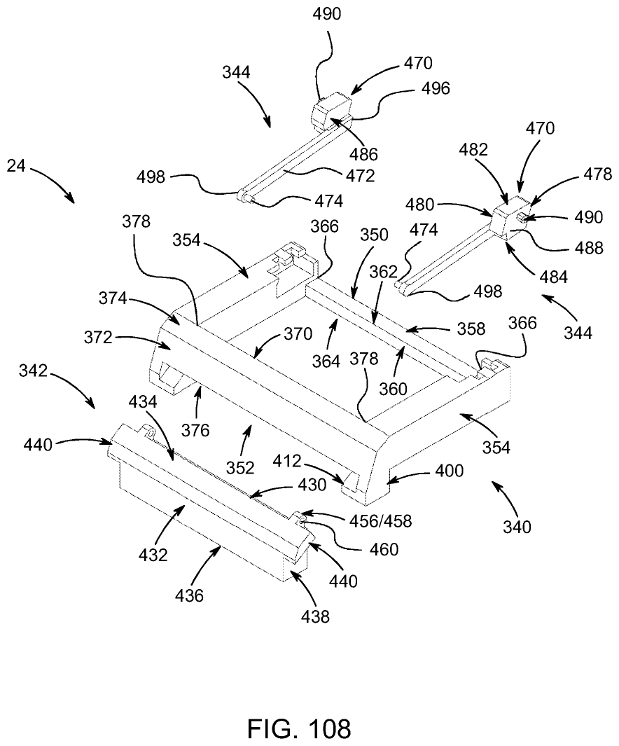

FIG. 109 shows an upper rear right perspective view of an adjustable lip assembly of the pocket hole drilling system shown in FIG. 106, in accordance with one or more arrangements; the view showing a cross section of a side member of the adjustable lip assembly.

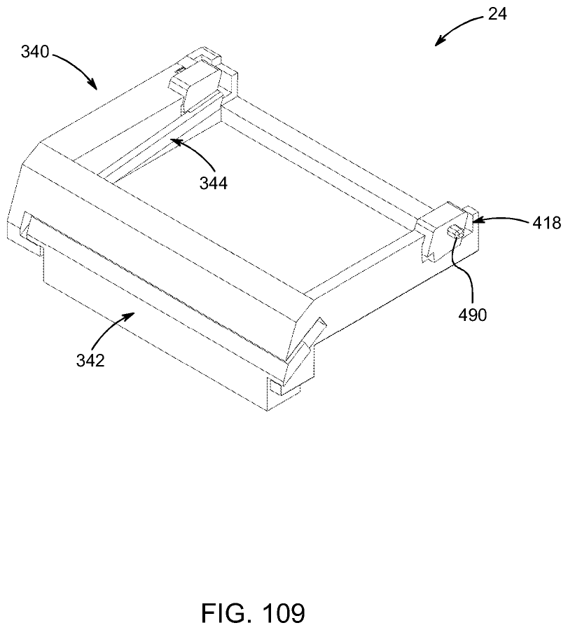

FIG. 110 shows an upper rear right perspective view of an adjustable lip assembly of the pocket hole drilling system shown in FIG. 106, in accordance with one or more arrangements; the view showing a sliding lip member of the adjustable lip assembly moved to a lower rearward position.

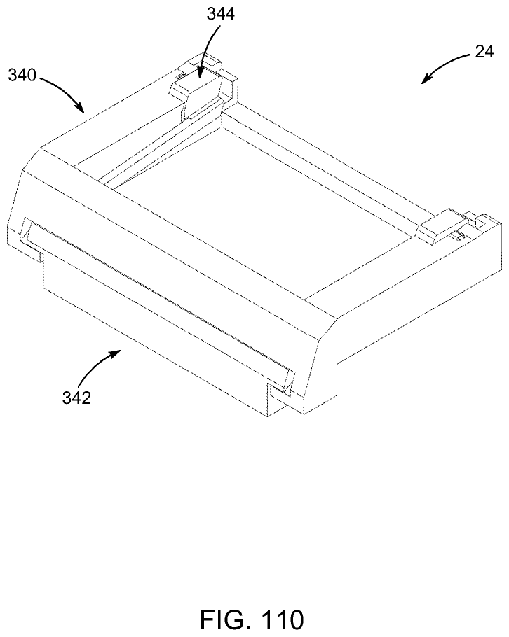

FIG. 111 shows an upper front left perspective view of an adjustable lip assembly of the pocket hole drilling system shown in FIG. 106, in accordance with one or more arrangements; the view showing a sliding lip member of the adjustable lip assembly moved to a lower rearward position.

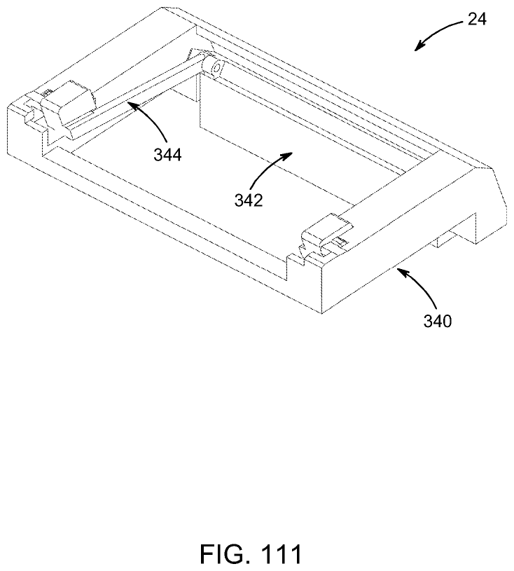

FIG. 112 shows an upper rear right perspective view of an adjustable lip assembly of the pocket hole drilling system shown in FIG. 106, in accordance with one or more arrangements; the view showing a sliding lip member of the adjustable lip assembly moved to an upper forward position.

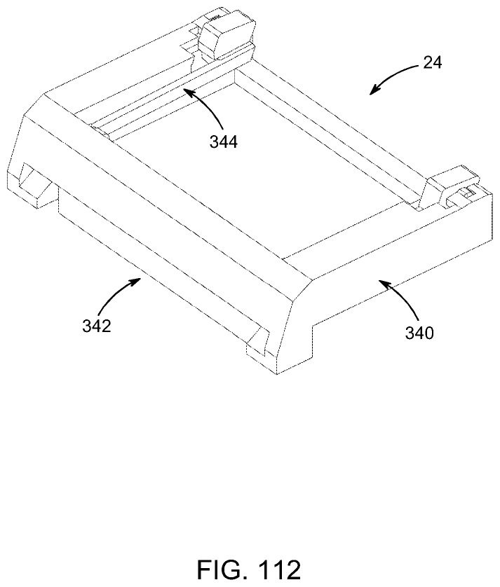

FIG. 113 shows an upper front left perspective view of an adjustable lip assembly of the pocket hole drilling system shown in FIG. 106, in accordance with one or more arrangements; the view showing a sliding lip member of the adjustable lip assembly moved to an upper forward position.

FIG. 114 shows a left side view of a pocket hole drilling system with an adjustable lip assembly, in accordance with one or more arrangements; the view showing a rear handle assembly omitted; the view showing a drill guide assembly in a retracted position; the view showing a sliding lip member of an adjustable lip assembly moved to a rearward position; the view showing the pocket hole drilling system having a front support assembly.

FIG. 115 shows a right side view of a pocket hole drilling system with the adjustable lip assembly shown in FIG. 114, in accordance with one or more arrangements; the view showing a rear handle assembly omitted; the view showing a drill guide assembly in a retracted position; the view showing a sliding lip member of an adjustable lip assembly moved to a rearward position; the view showing the adjustable lip assembly having a drill stop assembly; the view showing the pocket hole drilling system having a front support assembly.

FIG. 116 shows a left side view of a pocket hole drilling system with an adjustable lip assembly, in accordance with one or more arrangements; the view showing a rear handle assembly omitted; the view showing a drill guide assembly in a retracted position; the view showing a sliding lip member of the adjustable lip assembly moved to a rearward position; the view showing the adjustable lip assembly having a drill stop assembly; the view showing the pocket hole drilling system having a front support assembly.

FIG. 117 shows a left side view of a pocket hole drilling system with an adjustable lip assembly, in accordance with one or more arrangements; the view showing a rear handle assembly omitted; the view showing a drill guide assembly in an extended position; the view showing a sliding lip member of the adjustable lip assembly moved to a rearward position; the view showing the adjustable lip assembly having a drill stop assembly; the view showing the pocket hole drilling system having a front support assembly.

FIG. 118 shows a left side view of a pocket hole drilling system with an adjustable lip assembly, in accordance with one or more arrangements; the view showing a rear handle assembly omitted; the view showing a drill guide assembly in a retracted position; the view showing a sliding lip member of the adjustable lip assembly moved to an intermediate position; the view showing the adjustable lip assembly having a drill stop assembly; the view showing the pocket hole drilling system having a front support assembly.

FIG. 119 shows a right side view of a pocket hole drilling system with an adjustable lip assembly, in accordance with one or more arrangements; the view showing a rear handle assembly omitted; the view showing a drill guide assembly in a retracted position; the view showing a sliding lip member of the adjustable lip assembly moved to an intermediate position; the view showing the adjustable lip assembly having a drill stop assembly; the view showing the pocket hole drilling system having a front support assembly.

FIG. 120 shows a left side view of a pocket hole drilling system with an adjustable lip assembly, in accordance with one or more arrangements; the view showing a rear handle assembly attached to system; the view showing a drill guide assembly in a retracted position; the view showing a sliding lip member of the adjustable lip assembly moved to an intermediate position; the view showing the adjustable lip assembly having a drill stop assembly; the view showing the pocket hole drilling system having a front support assembly.

FIG. 121 shows a left side view of a pocket hole drilling system with an adjustable lip assembly, in accordance with one or more arrangements; the view showing a rear handle assembly omitted; the view showing a drill guide assembly in an extended position; the view showing a sliding lip member of the adjustable lip assembly moved to an intermediate position; the view showing the adjustable lip assembly having a drill stop assembly; the view showing the pocket hole drilling system having a front support assembly.

FIG. 122 shows a left side view of a pocket hole drilling system with an adjustable lip assembly, in accordance with one or more arrangements; the view showing a rear handle assembly omitted; the view showing a drill guide assembly in a retracted position; the view showing a sliding lip member of the adjustable lip assembly moved to a forward position; the view showing the adjustable lip assembly having a drill stop assembly; the view showing the pocket hole drilling system having a front support assembly.

FIG. 123 shows a right side view of a pocket hole drilling system with an adjustable lip assembly, in accordance with one or more arrangements; the view showing a rear handle assembly omitted; the view showing a drill guide assembly in a retracted position; the view showing a sliding lip member of the adjustable lip assembly moved to a forward position; the view showing the adjustable lip assembly having a drill stop assembly; the view showing the pocket hole drilling system having a front support assembly.

FIG. 124 shows a left side view of a pocket hole drilling system with an adjustable lip assembly, in accordance with one or more arrangements; the view showing a rear handle assembly attached to the system; the view showing a drill guide assembly in a retracted position; the view showing a sliding lip member of the adjustable lip assembly moved to a forward position; the view showing the adjustable lip assembly having a drill stop assembly; the view showing the pocket hole drilling system having a front support assembly.

FIG. 125 shows a left side view of a pocket hole drilling system with an adjustable lip assembly, in accordance with one or more arrangements; the view showing a rear handle assembly omitted; the view showing a drill guide assembly in an extended position; the view showing a sliding lip member of the adjustable lip assembly moved to a forward position; the view showing the adjustable lip assembly having a drill stop assembly; the view showing the pocket hole drilling system having a front support assembly.

FIG. 126 shows an exploded upper rear left perspective view of a pocket hole drilling system with an adjustable lip assembly, in accordance with one or more arrangements; the view showing the adjustable lip assembly having a drill stop assembly; the view showing the pocket hole drilling system having retractable guides; the view showing the pocket hole drilling system having a front support assembly.

FIG. 127 shows an exploded upper rear right perspective view of a pocket hole drilling system with an adjustable lip assembly, in accordance with one or more arrangements; the view showing the adjustable lip assembly having a drill stop assembly; the view showing the pocket hole drilling system having retractable guides.

FIG. 128 shows an upper rear right perspective view of the retractable guides of the pocket hole drilling system shown in FIGS. 127 and 126, in accordance with one or more arrangements.

FIG. 129 shows a close up exploded upper rear right perspective view of the adjustable lip assembly of the pocket hole drilling system shown in FIG. 128, in accordance with one or more arrangements.

FIG. 130 shows an upper rear right perspective view of a pocket hole drilling system, in accordance with one or more arrangements; the view showing the pocket hole drilling system having an adjustable lip assembly with a drill stop assembly; the view showing the pocket hole drilling system having retractable guides; the view showing a rear handle assembly omitted; the view showing a drilling assembly in a retracted position; the view showing the pocket hole drilling system having a front support assembly.

FIG. 131 shows an upper front right perspective view of a pocket hole drilling system, in accordance with one or more arrangements; the view showing the pocket hole drilling system having an adjustable lip assembly with a drill stop assembly; the view showing the pocket hole drilling system having retractable guides; the view showing a rear handle assembly omitted; the view showing a drilling assembly in a retracted position; the view showing the pocket hole drilling system having a front support assembly.

FIG. 132 shows an upper rear right perspective view of a pocket hole drilling system, in accordance with one or more arrangements; the view showing the pocket hole drilling system having an adjustable lip assembly with a drill stop assembly; the view showing the pocket hole drilling system having retractable guides; the view showing a rear handle assembly omitted; the view showing a drilling assembly in an extended position; the view showing the pocket hole drilling system having a front support assembly.

FIG. 133 shows an upper front right perspective view of a pocket hole drilling system, in accordance with one or more arrangements; the view showing the pocket hole drilling system having an adjustable lip assembly with a drill stop assembly; the view showing the pocket hole drilling system having retractable guides; the view showing a rear handle assembly omitted; the view showing a drilling assembly in an extended position.

FIG. 134 shows a partial upper front right perspective view of a pocket hole drilling system, in accordance with one or more arrangements; the view showing the pocket hole drilling system having an adjustable lip assembly with a drill stop assembly; the view showing the pocket hole drilling system having retractable guides; the view showing a drilling assembly in an extended position; the view showing a cover of a front support assembly omitted.

FIG. 135 shows a partial upper front left perspective view of a pocket hole drilling system, in accordance with one or more arrangements; the view showing the pocket hole drilling system having an adjustable lip assembly with a drill stop assembly; the view showing the pocket hole drilling system having retractable guides; the view showing a drilling assembly in an extended position; the view showing a cover of a front support assembly omitted.

FIG. 136 shows an upper rear left perspective view of a pocket hole drilling system, in accordance with one or more arrangements; the view showing the pocket hole drilling system having an adjustable lip assembly with a drill stop assembly; the view showing the pocket hole drilling system having retractable guides; the view showing a rear handle assembly omitted; the view showing a drilling assembly in an extended position; the view showing the pocket hole drilling system having a front support assembly.

FIG. 137 shows a left side view of a pocket hole drilling system with an adjustable lip assembly, in accordance with one or more arrangements; the view showing a rear handle assembly omitted; the view showing a drill guide assembly in a retracted position; the view showing a sliding lip member of the adjustable lip assembly moved to an intermediate position; the view showing the adjustable lip assembly having a drill stop assembly; the view showing the pocket hole drilling system having a front support assembly.

FIG. 138 shows an upper front left perspective view of a front support assembly of a pocket hole drilling system with an adjustable lip assembly, in accordance with one or more arrangements.

FIG. 139 shows a partial bottom view of a pocket hole drilling system with an adjustable lip assembly, in accordance with one or more arrangements; the view showing the pocket hole drilling system having a front support assembly; the view showing housing of front support assembly omitted.

FIG. 140 shows a front view of a pocket hole drilling system with an adjustable lip assembly, in accordance with one or more arrangements; the view showing the pocket hole drilling system having a front support assembly.

FIG. 141 shows an exploded upper front left perspective view of a front support assembly base, and drill guide assembly of a pocket hole drilling system, in accordance with one or more arrangements.

FIG. 142 shows a lower front right perspective view of a pocket hole drilling system with an adjustable lip assembly, in accordance with one or more arrangements; the view showing the pocket hole drilling system positioned on a ½ inch workpiece; the view showing support legs of a front support assembly and the adjustable lip assembly in position for drilling pocket holes on the ½ inch workpiece.

FIG. 143 shows a lower front left perspective view of a pocket hole drilling system with an adjustable lip assembly, in accordance with one or more arrangements; the view showing the pocket hole drilling system positioned on a ½ inch workpiece; the view showing support legs of a front support assembly and the adjustable lip assembly in position for drilling pocket holes on the ½ inch workpiece.

FIG. 144 shows a partial upper front left perspective view of a pocket hole drilling system with an adjustable lip assembly, in accordance with one or more arrangements; the view showing the pocket hole drilling system positioned on a ½ inch workpiece; the view showing support legs of a front support assembly and the adjustable lip assembly in position for drilling pocket holes on the ½ inch workpiece; the view showing the pocket hole drilling system having a front support assembly; the view showing the housing of the front support assembly omitted.

FIG. 145 shows a left side view of a pocket hole drilling system with an adjustable lip assembly, in accordance with one or more arrangements; the view showing the pocket hole drilling system positioned on a ½ inch workpiece; the view showing support legs of a front support assembly and the adjustable lip assembly in position for drilling pocket holes on the ½ inch workpiece.

FIG. 146 shows a front view of a pocket hole drilling system with an adjustable lip assembly, in accordance with one or more arrangements; the view showing the pocket hole drilling system positioned on a ½ inch workpiece; the view showing support legs of a front support assembly and the adjustable lip assembly in position for drilling pocket holes on the ½ inch workpiece; the view showing the pocket hole drilling system having a front support assembly; the view showing the housing of the front support assembly omitted.

FIG. 147 shows a left side view of a pocket hole drilling system with an adjustable lip assembly, in accordance with one or more arrangements; the view showing the pocket hole drilling system positioned on a ¾ inch workpiece; the view showing support legs of a front support assembly and the adjustable lip assembly in position for drilling pocket holes on the ¾ inch workpiece.

FIG. 148 shows a front view of a pocket hole drilling system with an adjustable lip assembly, in accordance with one or more arrangements; the view showing the pocket hole drilling system positioned on a ¾ inch workpiece; the view showing support legs of a front support assembly and the adjustable lip assembly in position for drilling pocket holes on the ¾ inch workpiece; the view showing the pocket hole drilling system having a front support assembly; the view showing the housing of the front support assembly omitted.

FIG. 149 shows a left side view of a pocket hole drilling system with an adjustable lip assembly, in accordance with one or more arrangements; the view showing the pocket hole drilling system positioned on a 1 inch workpiece; the view showing support legs of a front support assembly and the adjustable lip assembly in position for drilling pocket holes on the 1 inch workpiece.

FIG. 150 shows a front view of a pocket hole drilling system with an adjustable lip assembly, in accordance with one or more arrangements; the view showing the pocket hole drilling system positioned on a 1 inch workpiece; the view showing support legs of a front support assembly and the adjustable lip assembly in position for drilling pocket holes on the 1 inch workpiece; the view showing the pocket hole drilling system having a front support assembly; the view showing the housing of the front support assembly omitted.

FIG. 151 shows a lower front right perspective view of a pocket hole drilling system with an adjustable lip assembly, in accordance with one or more arrangements; the view showing the pocket hole drilling system having a front support assembly with support legs in a retracted position; the view showing the housing of the front support assembly omitted; the view showing an adjustment assembly of the front support assembly in an unlocked position.

FIG. 152 shows a lower front right perspective view of a pocket hole drilling system with an adjustable lip assembly, in accordance with one or more arrangements; the view showing the pocket hole drilling system having a front support assembly with support legs in a retracted position; the view showing the housing of the front support assembly omitted; the view showing an adjustment assembly of the front support assembly in a locked position.

FIG. 153 shows a front view of a pocket hole drilling system with an adjustable lip assembly, in accordance with one or more arrangements; the view showing the pocket hole drilling system having a front support assembly; the view showing the housing of the front support assembly omitted.

FIG. 154 shows an upper rear left view of a pocket hole drilling system, in accordance with one or more arrangements; the view showing the pocket hole drilling system having a window and indicator configured to aid in positioning the system for drilling a pocket hole at a particular location.

FIG. 155 shows a close up partial view the window and indicator of the pocket hole drilling system shown in FIG. 154, in accordance with one or more arrangements.

FIG. 156 shows a close up partial view the window and indicator of the pocket hole drilling system shown in FIG. 154, in accordance with one or more arrangements; the view showing a cutaway view of an adjustable lip assembly.

FIG. 157 shows a partial upper forward left view of a pocket hole drilling system in accordance with one or more arrangements; the view showing the pocket hole drilling system having a window and indicator configured to aid in positioning the system for drilling a pocket hole at a particular location.

FIG. 158 shows a lower rear left view of a pocket hole drilling system in accordance with one or more arrangements; the view showing the pocket hole drilling system having retractable guides extended to facilitate positioning of the system on a workpiece.

FIG. 159 shows a partial lower front left view of a pocket hole drilling system in accordance with one or more arrangements; the view showing the pocket hole drilling system having retractable guides extended to facilitate positioning of the system on a workpiece.

FIG. 160 shows a partial lower front right view of a pocket hole drilling system in accordance with one or more arrangements; the view showing the pocket hole drilling system having retractable guides extended to facilitate positioning of the system on a workpiece.

FIG. 161 shows a partial lower front right view of a pocket hole drilling system in accordance with one or more arrangements; the view showing the pocket hole drilling system having retractable guides extended to facilitate positioning of the system on a workpiece.

FIG. 162 shows a lower rear left view of a pocket hole drilling system in accordance with one or more arrangements; the view showing the pocket hole drilling system having retractable guides extended.

FIG. 163 shows a lower front right view of a pocket hole drilling system in accordance with one or more arrangements; the view showing the pocket hole drilling system having retractable guides extended.

FIG. 164 shows a lower front right view of a pocket hole drilling system in accordance with one or more arrangements; the view showing the pocket hole drilling system having retractable guides extended.

FIG. 165 shows a lower front left view of a pocket hole drilling system in accordance with one or more arrangements; the view showing the pocket hole drilling system having retractable guides retracted.

FIG. 166 shows a lower front right view of a pocket hole drilling system in accordance with one or more arrangements; the view showing the pocket hole drilling system having retractable guides retracted.

FIG. 167 shows a close up view of a grip pad on a lower surface of a base of a pocket hole drilling system in accordance with one or more arrangements.

FIG. 168 shows a lower rear right view of a pocket hole drilling system in accordance with one or more arrangements; the view showing the pocket hole drilling system having a safety interlock system.

FIG. 169 shows a rear view of a pocket hole drilling system in accordance with one or more arrangements; the view showing the pocket hole drilling system having a safety interlock system; the view showing buttons of the safety interlock depressed when the system is placed on a workpiece.

FIG. 170 shows a rear view of a pocket hole drilling system in accordance with one or more arrangements; the view showing the pocket hole drilling system having a safety interlock system; the view showing buttons of the safety interlock system released when the system is placed on a workpiece.

FIG. 171 shows an exploded lower front right view of a pocket hole drilling system in accordance with one or more arrangements; the view showing the pocket hole drilling system having a safety interlock system.

FIG. 172 shows an exploded upper rear left view of a pocket hole drilling system in accordance with one or more arrangements; the view showing the pocket hole drilling system having a safety interlock system.

FIG. 173 shows close up exploded upper rear left view of the safety interlock system of the pocket hole drilling system shown in FIG. 172.

FIG. 174 shows a right side view of a pocket hole drilling system having a drill assembly with a dust collection system, in accordance with one or more arrangements.

FIG. 175 shows an upper rear left perspective view of a pocket hole drilling system having a dust collection system, in accordance with one or more arrangements.

FIG. 176 shows a right side view of a dust collection system of a drill assembly of a pocket hole drilling system, in accordance with one or more arrangements.

FIG. 177 shows a rear view of a dust collection system of a drill assembly of a pocket hole drilling system, in accordance with one or more arrangements.

FIG. 178 shows a front view of a dust collection system of a drill assembly of a pocket hole drilling system, in accordance with one or more arrangements.

FIG. 179 shows a left side view of a dust collection system of a drill assembly of a pocket hole drilling system, in accordance with one or more arrangements.

FIG. 180 shows a right side view of a dust collection system of a drill assembly of a pocket hole drilling system, in accordance with one or more arrangements.

FIG. 181 shows an upper rear right perspective view of a dust collection system of a drill assembly of a pocket hole drilling system, in accordance with one or more arrangements; the view showing a cross-section of the dust collection system to show airflow paths.

FIG. 182 shows a right side view of a dust collection system of a drill assembly of a pocket hole drilling system, in accordance with one or more arrangements; the view showing a cross-section of the dust collection system to show airflow paths.

FIG. 183 shows an upper rear right perspective view of a dust collection system of a drill assembly of a pocket hole drilling system, in accordance with one or more arrangements; the view showing a cross-section of the dust collection system; the cross-section showing the inside of a fan housing of the drill assembly.

FIG. 184 shows a rear view of the cross-section of the dust collection system shown in FIG. 183, in accordance with one or more arrangements.

FIG. 185 shows a front view of a drill assembly with a dust collection system, in accordance with one or more arrangements.

### DETAILED DESCRIPTION

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation to encompass all such modifications and similar arrangements and procedures. For instance, although aspects and features may be illustrated in and/or described with reference to certain figures and/or embodiments, it will be appreciated that features from one figure and/or embodiment may be combined with features of another figure and/or embodiment even though the combination is not explicitly shown and/or explicitly described as a combination. In the depicted embodiments, like reference numbers refer to like elements throughout the various drawings.

Any advantages and/or improvements discussed herein may not be provided by various disclosed embodiments, and/or implementations thereof. The contemplated embodiments are not so limited and should not be interpreted as being restricted to embodiments which provide such advantages and/or improvements. Similarly, it should be understood that various embodiments may not address all or any objects of the disclosure and/or objects of the invention that may be described herein. The contemplated embodiments are not so limited and should not be interpreted as being restricted to embodiments which address such objects of the disclosure and/or invention. Furthermore, although some disclosed embodiments may be described relative to specific materials, embodiments are not limited to the specific materials and/or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer,” and the like as may be used herein, merely describe points of reference and do not limit the present invention to any particular orientation and/or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of such articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected and/or engaged, respectively, in any manner that facilitates operation, which may include being directly connected, indirectly connected, electronically connected, wirelessly connected and/or connected by any other manner, method and/or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments and/or methods.

Similarly, the structures and operations discussed herein may occur out of the order described and/or noted in the figures. For example, two operations and/or figures shown in succession may in fact be executed concurrently and/or may sometimes be executed in the reverse order, depending upon the functionality/acts involved. Similarly, individual operations within example methods described below may be executed repetitively, individually, and/or sequentially, to provide looping and/or other series of operations aside from single operations described below. It should be presumed that any embodiment and/or method having features and functionality described below, in any workable combination, falls within the scope of example embodiments.

As used herein, various disclosed embodiments may be primarily described in the context of drilling pocket holes. However, the embodiments are not so limited. It is appreciated that the embodiments may be adapted for use in various other applications, which may be improved by the disclosed structures, arrangements and/or methods. The system is merely shown and described as being used in the context of drilling pocket holes for ease of description and as one of countless examples.

### System 10:

With reference to the figures, a pocket hole drilling system 10 (or simply “machine” or “system” 10) is presented. In one or more arrangements, the pocket hole drilling system 10 includes a base assembly 14, a drilling assembly 16, a drill guide assembly 18, an actuating assembly 20, a rear handle assembly 22, and a lip assembly 24, among other components.

### Base Assembly 14:

Base assembly 14 is formed of any suitable size, shape, and design and is configured to engage a surface of a workpiece 12 in a secure manner to facilitate drilling of a pocket hole therein. In the arrangement shown, as one example, base assembly 14 includes a plate 30, support members 32, and one or more grip pads 34, among other components.

### Plate 30:

Plate 30 is formed of any suitable size, shape, and design and comprises a lower surface 40 that is arranged to engage a surface of a workpiece 12 and an upper surface 42 that facilitates operable connection with drilling assembly 16, drill guide assembly 18, actuating assembly 20, rear handle assembly 22, lip assembly 24, and/or other components of system 10. In the arrangement shown, as one example, plate 30 has a generally rectangular planar shape extending in a generally planar lower surface 40 and a generally planar upper surface 42 between a generally straight forward edge 44, a generally straight rearward edge 46, and generally straight opposing side edges 48. In this example arrangement, plate 30 includes a drill bit opening 50.

In the arrangement shown, as one example, upper surface 42 and lower surface 40 extend in approximate parallel spaced relation to one another. In the arrangement shown, as one example, forward edge 44 and rearward edge 46 extend in approximate parallel spaced relation to one another. In the arrangement shown, as one example, upper surface 42 and lower surface 40 extend in approximate perpendicular alignment to forward edge 44 and rearward edge 46. In the arrangement shown, as one example, opposing side edges 48 extend in approximate parallel spaced relation to one another; and in the arrangement shown, as one example, opposing side edges 48 extend in approximate perpendicular alignment to upper surface 42 and lower surface 40; and in the arrangement shown, as one example, opposing side edges 48 extend in approximate perpendicular alignment to forward edge 44 and rearward edge 46. In this way, upper surface 42 and lower surface 40, forward edge 44 and rearward edge 46, and opposing side edges 48 form a generally square or rectangular cubic shaped member that forms plate 30. However, any other shape is hereby contemplated for use.

In the arrangement shown, as one example, plate 30 includes a drill bit opening 50. Drill bit opening 50 may be formed of any suitable size, shape and design and is configured to facilitate the passage of a drill bit 58 through plate 30. In the arrangement shown, as one example, drill bit opening 50 is approximately in the shape of an ellipse and is disposed to receive a drill bit 58 at an angle to form pocket holes in a workpiece 12. In the arrangement shown, as one example, drill bit opening 50 extends through plate 30 from upper surface 42 to lower surface 40 in a generally centrally located position between opposing side edges 48. In the arrangement shown, as one example, drill bit opening 50 extends through plate 30 from upper surface 42 to lower surface 40 in a position located toward rearward edge 46.

In one or more arrangements, plate 30 is formed of a metallic material, such as aluminum, steel, or an alloy or any other metallic material to provide extreme ruggedness and durability as well as a durable flat surface. Additionally or alternatively, in one or more arrangements, plate 30 is formed of a plastic material, a nylon material, a fiberglass material, a Ultra High Molecular Weight (“UHMW”) material, or any other composite and/or non-metallic material. Additionally, or alternatively, in one or more arrangements, plate 30 is formed of a combination of metallic materials or components and non-metallic materials or components.

In the arrangement shown, upper surface 42 and lower surface 40 of plate 30 are generally flat planar surfaces that extend in approximate parallel spaced relation to one another. However, embodiments are not so limited. Rather, it is contemplated that plate 30 may be implemented to have various shapes or textures formed into upper surface 42 and/or lower surface 40. For example, in one or more arrangements, upper surface 42 and/or lower surface 40 of plate 30 may have a pattern of planes and grooves which provide a flat and flush planar work surface. This pattern of planes and grooves may also provides limited relief for particles, such as wood chips, to fall or fit within the grooves to prevent the particles from interfering with the planar work surface and the engagement between the planar work surface of lower surface 40 of plate 30 and the upper surface of workpiece 12. In one arrangement, plate 30 is formed, and then upper surface 42 and/or lower surface 40 are machined flat to take up any dimensional variance imparted through the manufacturing process. In this manner, an extremely flat surface may be formed.

### Support Members 32:

Support members 32 are formed of any suitable size, shape, and design and are configured to provide structural support and/or rigidity to plate 30. In the arrangement shown, as one example, support members 32 have generally planar shapes which extend upward from lower ends 52 that are connected to upper surface 42 of plate 30, to upper ends 54. In the arrangement shown, as one example, two support members 32 are positioned alongside side edges 48 and intersect with another support member 32 that is positioned along forward edge 44. However, embodiments are not so limited. Rather, it is contemplated that base assembly 14 may include any number of support members 32, which may be positioned and/or interconnected in any arrangement to provide structural reinforcement and/or rigidity to plate 30.

### Grip Pad(s) 34:

In one or more arrangements, plate 30 of base assembly 14 of system 10 is formed of a hard or rigid material (e.g., plastic, metal, and/or composite). Using a hard or rigid plastic, metal, or composite material provides a strong, durable, and long lasting tool that can handle daily use and abuse without significant wear or damage. One drawback, however, of using a hard or rigid plastic, metal, or composite material for plate 30 or other components of system 10 is that these materials tend to have a low coefficient of friction. Or, said another way, when plate 30 of base assembly 14 of system 10 is placed on workpiece 12 to drill a pocket hole, there is a low amount of friction or grip between plate 30 and workpiece 12. This means that plate 30 may easily slide on workpiece 12. Or, said another way, this means that an increased amount of down-pressure is required to hold workpiece 12 in place relative to plate 30 of base assembly 14 of system 10. It is undesirable to have plate 30 easily move on workpiece 12 during use. Such movement can cause an inaccurate pocket hole placement, damage to workpiece 12, rough pocket holes, and/or injury to a user.

In one or more arrangements, system 10 includes one or more grip pads 34 positioned on lower surface 40 of plate 30. Grip pad(s) 34 are formed of a material that is more flexible and/or more compressible than the plastic, metal, or composite material that forms plate 30 and/or other components of system 10 on which grip pad(s) 34 are positioned. Grip pad(s) 34 are formed of any suitable size shape or design and of any material that that has a higher coefficient of friction than the material of the surface upon which grip pad(s) 34 are positioned. This facilitates improved grip of system 10 with surfaces of other objects during use. In various arrangements, grip pad(s) 34 may be formed of various materials including but not limited to, for example, a rubber material, a natural rubber material, a synthetic rubber material, a silicone material, an isoprene rubber material, ethylene propylene diene (“EPDM”) material, a nitrile rubber (“NBR”) material, a styrene butadiene rubber (“SBR”) material, a silicone rubber material, a butyl rubber material, a isobutylene isoprene rubber material, a polybutadiene rubber material, a foam rubber material, any compressible or high coefficient of friction plastic material, or any other material that is more-compressible than and/or has a higher coefficient of friction than the rigid materials used to form other components of system 10 that grip pad(s) 34 are attached to.

The enhanced grip of grip pad(s) 34 help system 10 to better stay in place during use. The enhanced grip of grip pad(s) 34 help to reduce the downward pressure a user must apply to system 10 to hold system 10 in place on workpiece 12. The enhanced grip of grip pad(s) 34 helps to prevent marking (e.g., scrapes or scratches) of workpiece 12 when in use. It is hereby contemplated that system 10 may include grip pad(s) 34 on any place or portion of system 10 that come into contact with or could come into contact with workpiece 12 during use as is further described herein.

In one arrangement, a single continuous grip pad 34 extends across the entire bottom surface of plate 30. In this arrangement, the surface area of grip pad 34 is maximized on plate 30. In an alternative arrangement, a single grip pad 34 is positioned on the bottom surface of plate 30 that covers some of the surface area of plate 30, leaving other areas not covered by grip pad 34. In an alternative arrangement, multiple grip pads 34 are positioned on the bottom surface of plate 30 that cover all or some of the surface area of plate 30.

In one or more arrangements, grip pad(s) 34 have a wavy or ridged lower surface, formed by recesses 36 positioned between raised portions or flat contact portions 38, to improve contact with workpiece 12. This configuration of recesses 36 and ridges or raised contact portions 38 on the grip pad(s) 34 cause an increased amount of force to be applied to the contact portions 38 of the grip pad(s) 34 that make contact with workpiece 12. By positioning recesses 36 between ridges or raised contact points 38, the surface area of contact between the upper surface of workpiece 12 and grip pad(s) 34 is reduced. This has the effect of spreading out the down-pressure force over less surface area of contact between the upper surface of workpiece 12 and the ridges or raised contact portions 38 of grip pad(s) 34, thereby increasing the amount of friction or grip between workpiece 12 and the ridges or raised contact portions 38 of grip pad(s) 34. This holds workpiece 12 in place better with the same down-pressure (as compared to having a flat bottom surface of grip pad(s) 34). Or, said another way, if the bottom surface of grip pad(s) 34 was flat and placed on the flat upper surface of workpiece 12, the down-pressure applied by the user during use would be spread out over a greater surface area which would generate less overall grip and friction. As such, by placing the recesses 36, waves, grooves, or cuts into the lower surface of grip pad(s) 34 and reducing the surface area of contact between grip pad(s) 34 and workpiece 12, somewhat counterintuitively, the effective friction or grip is increased thereby holding workpiece 12 in place better.

The recesses 36 and contact portions 38 on grip pad(s) 34 also help maintain friction when or if sawdust or wood chips are present on workpiece 12. When work tools have a hard planar lower surface, friction may be reduced when sawdust or wood chips are trapped between the lower surface and workpiece 12 in a way that limits contact. Sawdust or wood chips may also scratch or be pushed into workpiece 12 if force is applied by a user or a clamp to hold such a work tool in place during use. When the grip pad(s) 34 have a wavy, grooved, or ridged lower surface, sawdust or wood chips may additionally be accommodated in recesses 36, thereby permitting ridges or raised contact portions 38 of the waves of grip pad(s) 34 to more easily contact workpiece 12. The flexible material of the grip pad(s) 34 of system 10 may also allow sawdust or wood chips to be pushed into the grip pad(s) 34 (as opposed to being pushed into the surface of workpiece 12 thereby causing scratches or indents) and allow the grip pad(s) 34 to properly contact workpiece 12.

In the arrangement shown, as one example, recesses 36 or grooves and the ridges or raised contact portions 38 extend in approximate parallel spaced alignment with the forward-to-back length of pocket hole jig system 10 and the forward-to-back length of plate 30. Or, said another way, the alignment of the recesses 36 or grooves and the ridges or raised contact portions 38 extend in approximate parallel alignment to the sides of plate 30 and extend in approximate perpendicular alignment to the ends of plate 30. This parallel arrangement helps to maintain alignment of workpiece 12 when grip pad(s) 34 are placed on workpiece 12. In most cases, when grip pad(s) 34 is placed on workpiece 12, the length of workpiece 12 extends in approximate parallel alignment with plate 30 or in approximate perpendicular alignment with plate 30. As such, the parallel alignment of the features of grip pad(s) 34 help to form or maintain a stable engagement between grip pad(s) 34 and workpiece 12. However, any other configuration is hereby contemplated for use.

In the arrangement shown, as one example, the recesses 36 or grooves and the ridges or raised contact portions 38 extend in a curved shape from one side to the other of plate 30. That is, in the arrangement shown, as one example, the recesses 36 of grip pad(s) 34 are curved concave recesses that connect to curved concave recesses of adjacent recesses 36. In this arrangement, adjacent concave recesses 36 connect to adjacent recesses 36 at peaks or points that form ridges or raised contact portions 38. These recesses 36 and raised contact portions 38 extend in continuous parallel fashion from the front end of plate 30 to the rear end of plate 30.

In an alternative arrangement, to increase surface area of the ridges or raised contact portions 38 between recesses 36, instead of adjacent recesses 36 connecting to one another at a point, a flat portion may be positioned between the ends of adjacent concave curved recesses 36. This arrangement increases the surface area of raised contact portions 38 which form flat strips of grip pad(s) 34 that extend the length of grip pad(s) 34 from the front end to the rear end of plate 30.

In an alternative arrangement, recesses 36 may be formed of generally square or rectangular recesses or grooves, as opposed to concave curved recesses 36. Any other configuration of recesses 36 and raised contact portions 38 is hereby contemplated for use. This includes any tread pattern, such as those used on tires, waves that extend back and forth across the bottom surface of grip pad(s) 34, or any other shapes or configurations.

In the arrangement shown, as one example, the recesses 36 and raised contact portions 38 are generally symmetric across the bottom surface of plate 30. That is, the features of recesses 36 and raised contact portions 38 are centered on the center of plate 30. This centered and symmetric configuration of recesses 36 and raised contact portions 38 help to provide balance when forming pocket holes in workpiece 12.

### Drilling Assembly 16:

Drilling assembly 16 is formed of any suitable size, shape, and design and is configured to facilitate the drilling of pocket holes in workpiece 12. In the arrangement shown, as one example, drilling assembly 16 includes a drill motor 70, a chuck 72, and a collar assembly 74, among other components.

### Drill Motor 70:

Drill motor 70 is formed of any suitable size, shape, and design and is configured to operably connect with and rotate chuck 72 and drill bit 58 when operated. In the arrangement shown, as one example, drill motor 70 is an electrically powered Alternating Current (“AC”) motor. However, embodiments are not so limited. Rather, it is contemplated that drill motor 70 may be implemented using any type of motor including but not limited to, for example, an AC electric motor, a Direct Current (“DC”) electric motor, a pneumatic motor, a hydraulic motor, a combustion motor, and/or any other form of a motor.

### Chuck 72:

Chuck 72 is formed of any suitable size, shape, and design and is configured to receive and hold drill bit 58 to facilitate the drilling of pocket holes. In the arrangement shown, as one example, chuck 72 is a heavy-duty square or hex-drive quick release drill chuck with a spring loaded locking sleeve 92 positioned over a square or hexagonal bore which quickly and easily receives and locks drill bits 58 therein. Quick release chucks of this and other various designs are well known in the industry and are made by various manufacturers. However, embodiments are not so limited. Rather, it is contemplated that chuck 72 may be implemented using any type of chuck including but not limited to, for example, a keyed chuck, a double sleeve chuck, a single sleeve keyless chuck, a Slotted Drive Shaft/System (“SDS”) chuck, a hex connection chuck, and/or any other type of chuck.

### Collar Assembly 74:

Collar assembly 74 is formed of any suitable size, shape, and design and is configured to facilitate an operable connection between drill assembly 16, drill guide assembly 18 and actuating assembly 20. In the arrangement shown, as one example, collar assembly 74 has a generally planar main body 76 extending between and connecting a collar 78, connecting member 80, and alignment guides 82. In this example arrangement, main body 76 also includes flanges 84 that extend outward from main body 76 around peripheral edges. Flanges 84 provide additional strength and rigidity to collar assembly 74.

### Collar 78:

Collar 78 is formed of any suitable size, shape, and design and is configured to receive and hold a front end of drill motor 70 and permit the rotating shaft and/or chuck 72 of drilling assembly 16 to extend through collar 78. In the arrangement shown, as one example, collar 78 is a generally cylindrical shaped tube extending through main body 76. In this example arrangement, collar 78 is configured to fit over a cylindrical front end of drill motor 70. In one or more arrangements, collar assembly 74 is held onto the front end of drill motor 70 by one or more fasteners (not shown) that extend through one or more holes (not shown) in main body 76 to connect with drilling assembly 16. However, the embodiments are not so limited. Rather, it is contemplated that collar assembly 74 may be secured to drilling assembly 16 using various means and methods known in the art including but not limited to, for example, adhesive bonding, chemical bonding, welding, and/or mechanical attachment means such as screws, bolts, threading, interlocks, clips, pins, or other coupling devices.

### Alignment Guides 82:

Alignment guides 82 are formed of any suitable size, shape, and design and are configured to engage and guide drill assembly 16 along guide rods 90 of drill guide assembly 18. In the arrangement shown, as one example, alignment guides 82 are generally cylindrical shaped tubes extending through main body 76. In this example arrangement, alignment guides 82 are positioned to the sides of collar 78 and are spaced to facilitate insertion of guide rods 90 through alignment guides 82. In this example arrangement, alignment guides 82 are sized and shaped to allow guide rods 90 to pass there through with close sliding alignment. In this way, the front to back actuation of drill motor 70 is aligned with the axis of guide rods 90.

### Connecting Member 80:

Connecting member 80 is formed of any suitable size, shape, and design and is configured to facilitate operable connection between drill assembly 16 and actuating assembly 20. In the arrangement shown, as one example, connecting member 80 is a tab positioned above collar assembly 74 on a rearward side of main body 76. In this example arrangement connecting member 80 is centrally positioned with respect to alignment guides 82, which are positioned on opposite sides of drill motor 70. In this example arrangement, connecting member 80 includes a hole 86 to facilitate connection (e.g., by a fastener) with lever 152 of actuating assembly 20, which serves to move drill motor 70 back and forth along drill guide assembly 18 between an extended position and a retracted position. However, embodiments are not so limited. Rather, it is contemplated that connecting member 80 may connect with lever 152 using various means and methods known in the art including but not limited to, for example, adhesive bonding, chemical bonding, welding, and/or mechanical attachment means such as screws, bolts, threading, interlocks, clips, pins, or other coupling devices.

### Drill Guide Assembly 18:

Drill guide assembly is formed of any suitable size, shape, and design and is configured to operably connect with drilling assembly 16 and facilitate movement of drilling assembly 16 between the extended and retracted positions. In the arrangement shown, as one example, drill guide assembly 18 includes a guide block 88 and a set of guide rods 90, among other components.

### Guide Block 88:

Guide block 88 is formed of any suitable size, shape, and design and is configured to operably connect guide rods 90 with plate 30 of base assembly 14. In the arrangement shown, as one example, guide block 88 includes a front wall 96, a rear wall 98, openings 100, guide rod supports 102, guide rod connection members 104, and a drill bit guide 106, among other components.

In this example arrangement, front wall 96 has a generally rectangular shape, when viewed from the front, extending between a lower edge 112, an upper edge 114 and opposing side edges 116 proximate to side edges 48 of plate 30. In this example arrangement, when viewed from the side, front wall 96 has a wider lower edge 112 and narrows as front wall 96 extends upward to upper edge 114. In this example arrangement, rear wall 98 also has a generally rectangular planar shape extending between a lower edge 120, an upper edge 122, and opposing side edges 124, which are proximate to side edges 48 of plate 30. In the arrangement shown, front wall 96 and rear wall 98 have openings 100 configured to receive guide rods 90 and drill bit guide 106.

### Guide Rod Supports 102:

In this example arrangement, guide block 88 includes guide rod supports 102 positioned proximate to openings 100 of rear wall 98. Guide rod supports 102 are formed of any suitable size, shape, and design and are configured to receive and hold ends of guide rods 90. In the arrangement shown, as one example, guide rod supports 102 each have a semi cylindrical body 130 connected to upper surface 42 of plate 30 and have a cylindrical recess 132 (not shown) extending rearward from opening 100 of rear wall 98 into body 130 of guide rod support 102. When system 10 is fully assembled, the ends of guide rods 90 are positioned in cylindrical recess 132 of guide rod supports 102 with guide rods 90 extending forward from guide rod supports 102 through openings 100 in front wall 96 and rear wall 98. The guide rod supports 102 and openings 100 in front wall 96 and rear wall 98 hold the guide rods 90 at an angle at which holes are to be drilled into workpiece 12 for formation of pocket holes. Although the precise angle can vary, a drilling angle of about 15 degrees is commonly used to form pocket joints in wooden or composite (i.e., material dense fiberboard (MDF), particle board, etc.) workpieces 12. However, embodiments are not so limited. Rather, it is contemplated that guide rods 90 can be positioned at other angles to facilitate drilling of pocket holes at angles greater or less than 15 degrees.

In various different arrangements, guide rods 90 may be secured within guide rod supports 102 using various means and methods known in the art including but not limited to, for example, adhesive bonding, chemical bonding, welding, and/or mechanical attachment means such as screws, bolts, threading, interlocks, clips, pins, or other coupling devices. In the arrangement shown, guide rods 90 are secured in place by guide rod connection members 104 positioned between front wall 96 and rear wall 98.

### Guide Rod Connection Members 104:

Guide rod connection members 104 are formed of any suitable size, shape, and design and are configured to engage and hold guide rods 90 secure within guide rod supports 102. In the arrangement shown, as one example, guide rod connection members 104 have a generally cylindrically shaped body 136 having a hole 138, proximate to opening 100 in front wall 96, that extends from a forward side of body 136 to a rearward side of body 136. In this example arrangement, guide rod connection members 104 have a threaded hole 140 extending from a top of body 136 into hole 138. When system 10 is fully assembled, guide rods 90 extend through hole 138 and a fastener (e.g., a screw or bolt) is threaded into threaded hole 140 and tightened to clamp guide rod 90 into position.

### Drill Bit Guide 106:

Drill bit guide 106 is formed of any suitable size, shape, and design, and is configured to guide and support drill bit 58 in proper alignment for drilling of pocket holes in workpiece 12. In the arrangement shown, as one example, drill bit guide 106 has a cylindrical tube shape extending between a forward end 202 and a rearward end 204. When system 10 is fully assembled, forward end 202 is positioned proximate to opening 100 in front wall 96 of guide block 88 and rearward end 204 is positioned proximate to drill bit opening 50 of plate 30. In this example arrangement, drill bit guide 106 includes chip openings 206 positioned proximate to rearward end 204 to allow dust, particles, and shavings generated by drilling to exit drill bit guide 106.

### Guide Rods 90:

Guide rods 90 are formed of any suitable size, shape, and design and are configured to guide drilling assembly 16 along an angled path to facilitate drilling angled pocket holes in workpiece 12. In the arrangement shown, as one example, guide rods 90 have a generally cylindrical shaped exterior surface extending between opposing ends 146. However, embodiments are not so limited. Rather, it is contemplated that guide rods 90 may have a cross section with any other shape (e.g. circular, triangular, square, rectangular, pentagonal, hexagonal, or any other shape). Additionally or alternatively, guide rods may provide a track within which drilling assembly 16 is guided along the angled path.

### Actuating Assembly 20:

Actuating assembly 20 is formed of any suitable size, shape, and design and is configured to actuate movement of drilling assembly 16 along guide rods 90 of drill guide assembly 18 between an extended position and a retracted position. As used herein, extended position refers to a position of drilling assembly 16 at which drill bit 58 in chuck 72 extends through drill bit opening 50 of plate 30 and beyond lower surface 40 of plate 30. As used herein, retracted position refers to a position of drilling assembly 16 at which drill bit 58 in chuck 72 does not extend through drill bit opening 50 of plate 30 and beyond lower surface 40 of plate 30. In the arrangement shown, as one example, actuating assembly 20 is formed of a fulcrum bracket 150, a lever 152, a handle 154, and a switch 156, among other components.

### Fulcrum Bracket 150:

Fulcrum bracket 150 is formed of any suitable size, shape, and design and is configured to operably connect with base assembly 14 and operate as a fulcrum for lever 152. In the arrangement shown, as one example, fulcrum bracket 150 has a planar arch shaped main body 164 extending from outward lower ends 166 to a central upper end 168. In this example arrangement, lower ends 166 have notches 170 configured to rest atop support members 32 between front wall 96 and rear wall 98. In this example arrangement, lower ends 166 also have holes 172 through which guide rods 90 extend when system 10 is fully assembled. In the arrangement shown, fulcrum bracket 150 includes connection tabs 176 that extend rearward from main body 164, over upper edges 122 of rear wall 98, and then downward to upper surface 42 of plate 30. In this arrangement, lower ends 166 of main body 164 and connection tabs 176 operate together to securely hold fulcrum bracket 150 in place on base assembly 14.

In the arrangement shown, a pair of tabs 180 extend forward from upper end 168 of main body 164 of fulcrum bracket 150 to respective outward ends 182. In this example arrangement, tabs 180 include holes 184 positioned proximate to outward ends 182 to facilitate a hinged connection with lever 152 by fastener 186. Fastener 186 operates as a pivot point for lever 152.

### Lever 152:

Lever 152 is formed of any suitable size, shape, and design and is configured to operably connect with fulcrum bracket 150 and drilling assembly 16 and facilitate controlled movement of drilling assembly 16 along drilling guide assembly 18. In the arrangement shown, as one example, lever 152 has a generally elongated shaped extending between a first end 190 operably connected to a handle 154, a second end 192 operably connected to drilling assembly 16, and a pivot connection 194 located between first end 190 and second end 192. In this example arrangement, pivot connection 194 is a hole, through which fastener 186 is inserted to provide a hinged connection with fulcrum bracket 150. In this example arrangement, lever 152 is slightly angled at pivot connection 194. However, embodiments are not so limited. Rather, it is contemplated that lever 152 may be straight, curved, have a greater or lesser angle, or be any other shape.

In various different arrangements, second end 192 of lever 152 may be operably connected to drilling assembly 16 using various different attachment means or methods. In the arrangement shown, as one example, second end 192 of lever 152 is configured to connect to connecting member 80 of drilling assembly 16. In this example arrangement, lever 152 includes a slot 196 positioned proximate to second end 192. In this example arrangement, a fastener 198 extends through slot 196 of lever 152 and through hole 86 of connecting member 80. When drilling assembly 16 is moved along guide rods 90 (e.g., between an extended position and a retracted position), fastener 198 is free to move within slot 196 to permit drilling assembly 16 to move along the linear path of the guide rods 90 while remaining connected with second end 192 of lever 152 which moves in an arc. However, embodiments are not so limited. Rather, it is contemplated that second end 192 of lever 152 may be connected to connecting member 80 and/or other component of drilling assembly 16 using various means, methods, and techniques known in the art including but not limited to, for example, adhesive bonding, chemical bonding, welding, and/or mechanical attachments means such as screws, bolts, threading, interlocks, clips, pins, or other coupling devices.

### Handle 154:

Handle 154 is formed of any suitable size, shape, and design and is configured to facilitate hand-controlled movement of first end 190 of lever 152 by a user. In the arrangement shown, as one example, handle 154 is a horizontal hand grip extending outward to the side from the first end 190 of lever 152. However, embodiments are not so limited. Rather, it is contemplated that handle 154 may be implemented using various different types of handgrips including but not limited to horizontal handgrips, vertical handgrips, knobs, wheels, loops, and/or any other type of handle or handgrip.

### Switch 156:

In the arrangement shown, as one example, switch 156 is positioned on handle 154 to facilitate easy operation with a hand that is holding handle 154. A cord, not shown, electrically connects switch 156 to drill motor 70 of drilling assembly 16 to facilitate turning drill motor 70 on and off. Switch 156 is formed of any suitable size, shape, and design and is configured to initiate operation of drill motor 70. In the arrangement shown, as one example, switch 156 is a momentary switch configured to turn on drill motor 70 when depressed and turn off drill motor 70 when released. In this arrangement, switch 156 operates to prevent potentially unsafe operation of drilling assembly 16 when a user is not holding handle 154 (for example if user loses hold of handle 154 during drilling). However, embodiments are not so limited. Rather, it is contemplated that switch 156 may be implemented using any type of switch and/or may be located at any position on system 10.

In one or more arrangements, system 10 may additionally or alternatively include one or more safety switches 160 (not shown) to prevent accidental operation of drill motor if switch 156 is accidentally pressed or bumped. For example, in one or more arrangements, safety switch 160 may be positioned on handle 154 of actuating assembly 20 and configured to prevent switch 156 from being depressed and/or able to enable operation of the drill motor 70 unless safety switch 160 is first pressed. However, embodiments are not so limited. Rather, it is contemplated that safety switch 160 may be implemented using any type of switch and/or may be located at any position on system 10.

### Bias Member 200:

In one or more arrangements, system 10 includes a bias member 200. Bias member 200 is formed of any suitable size, shape, and design and is configured to attach to and between components of drill guide assembly 18 and drilling assembly 16 and provide a bias force between drill guide assembly 18 and drilling assembly 16 sufficient to move drilling assembly 16 to a retracted position in the absence of an opposing rearward/downward force (e.g., placed on drilling assembly 16 by actuating assembly 20). In the arrangement shown, as one example, bias member 200 is a spring positioned on one of guide rods 90. In this example arrangement, the bias member 200 is configured to engage a forward surface of front wall 96 of guide block 88 or drill guide assembly 18 and engage a reward surface of one connecting member 80 of collar assembly 74, to move drill guide assembly 18 and drilling assembly 16 away from each other. In various arrangements, bias member 200 may utilize various mechanisms to move drill guide assembly 18 and drilling assembly 16 away from each other including but not limited to, for example, one or more springs, one or more gas pistons, one or more gas springs, one or more hydraulic pistons, one or more actuators, one or more solenoids, one or more pneumatic members, and/or any other force generating means or combination thereof

### Stop Member 210:

In one or more arrangements, system 10 includes a stop member 210. Stop member 210 is formed of any suitable size, shape, and design and is configured to set a lowest position that drilling assembly 16 may be moved along drill guide assembly 18. In the arrangement shown, as one example, stop member 210 includes a generally cylindrical collar 212 configured to attach to one of guide rods 90. In this example arrangement, collar 212 has a hollow interior that is sized and shaped to fit over and be moved along the one of the guide rods 90. In this example arrangement, stop member 210 includes set screw 214 extending from an external surface of collar 212 into the hollow interior. When tightened, set screw 214 engages guide rod 90 to secure stop member 210 in place. A user may loosen set screw 214 and move stop member 210 to a desired position along guide rod 90. Once in position, the set screw 214 may be tightened to set the lowest position that drilling assembly 16 may be moved along drill guide assembly 18. By controlling the lowest position that drilling assembly 16 may be moved along drill guide assembly 18, the maximum amount that drill bit 58 can be extended through drill bit opening 50 of plate 30 can be controlled. In this manner, a user can control the depth at which pocket holes are drilled.

In one or more arrangements, guide rod 90 may include measuring indica (not shown) marking positions at which stop member 210 should be secured for drilling pocket holes to the proper depth for various workpiece 12 thicknesses. As an illustrative example, such measuring indica may mark positions for workpiece 12 thicknesses of ¼″, ½″, ¾″, 1″, 1¼″, 1½″, or any other measurement.

### Rear Handle Assembly 22:

Rear handle assembly 22 is formed of any suitable size, shape, and design and is configured to facilitate secure holding and control of system 10 by a user during operation. In the arrangement shown, rear handle assembly includes a main body 220 and a handle 222.

### Main Body 220:

Main body 220 is formed of any suitable size, shape, and design and is configured to engage a rearward end of base assembly 14 and provide secure connection between handle 222 and base assembly 14. In the arrangement shown, main body 220 includes a front 230, a back 232, a top 234, a bottom 236, and opposing sides 238. In this example arrangement, recesses 240 are formed in bottom 236 of main body 220, which provide hollow interiors when rear handle assembly 22 is connected to base assembly 14. In this example arrangement, a center cylindrical shaped recess 242 in bottom 236 is configured to engage and support an upper end of drill bit guide 106 when rear handle assembly 22 is connected to base assembly 14.

In various different arrangements, rear handle assembly 22 may be connected to base assembly 14 in various different ways. In the arrangement shown, as one example, sides 238 of main body 220 of rear handle assembly 22 are configured to fit over side edges 48 of plate 30 of base assembly 14. In this example arrangement, lower inner edges 244 of sides 238 are configured to engage or snap into recessed channels 250 in side edges 48. However, the embodiments are not so limited. Rather, it is contemplated that rear handle assembly 22 may be connected to base assembly 14 using any means and methods known in the art including but not limited to, for example, adhesive bonding, chemical bonding, welding, and/or mechanical attachment means such as screws, bolts, threading, interlocks, clips, pins, or other coupling devices.

### Passageway 246:

In this example arrangement, main body 220 includes a passageway 246 in main body 220. Passageway 246 is formed of any suitable size, shape, and design and is configured to facilitate removal of drill shavings and chips. In this example arrangement, passageway 246 is a generally rectangular opening with rounded edges extending from front 230 to back 232 in main body 220. In this example arrangement, passageway 246 also includes an opening 248 that extends from passageway 246 to an area of cylindrical recess 242 located proximate to chip openings 206 of drill bit guide 106.

### Vacuum Connector 252:

In one or more arrangements, air is pulled outward through passageway 246 and opening 248 (e.g., by a vacuum) to facilitate removal of wood chips and shavings created when drilling through chip openings 206 of drill bit guide 106. In one or more arrangements, system 10 includes a vacuum connector 252 to facilitate connection to the vacuum. Vacuum connector 252 is formed of any suitable size, shape, and design and is configured to be inserted into passageway 246 from back 232 of main body 220 and provide a fluidic connection between a vacuum tube (not shown) through passageway 246 and opening 248 to facilitate removal of wood chips and shavings generated during drilling.

### Insert Portion 254:

In the arrangement shown, as one example, vacuum connector 252 includes an insert portion 254 and a tube portion 256. Insert portion 254 is formed of any suitable size, shape, and design and is configured to be inserted into passageway 246 from back 232 of main body 220 and provide a fluidic connection between a first end 280 of tube portion 256 and opening 248. In the arrangement shown, as one example, insert portion 254 has a planar rectangular shape having a front 260, back 262, opposing sides 264, top 266, and bottom 268, which form a hollow interior 270. In this example arrangement, insert portion 254 is shaped and sized to fit snuggly within passageway 246 when inserted.

In this example arrangement, insert portion 254 includes an opening 272 in bottom 268 that aligns with opening 248, when insert portion 254 is inserted within passageway 246, and provides a fluidic connection between opening 248 and hollow interior 270. In this example arrangement, insert portion 254 also includes an opening 276 in top 266 to facilitate cleaning of insert portion 254 when removed from passageway 246. When a vacuum is connected to vacuum connector 252 and operated, suction through opening 276 helps ensure frictional engagement between insert portion 254 and an interior surface of passageway 246 to prevent insert portion 254 from being accidentally removed from passageway 246. However, in various embodiments insert portion 254 may be held within passageway 246 using various other connection means of methods including but not limited to frictional fittings, screws, bolts, threading, clips, pins, interlocks, and/or other coupling devices.

In this example arrangement, insert portion 254 also includes an opening 274 (not shown) in back 262 that provides a fluidic connection between hollow interior 270 and tube portion 256. When insert portion 254 is inserted within passageway 246, opening 276 is closed off by top 234 of main body 220 and insert portion 254 provides a fluidic connection from opening 248, through opening 272 in bottom 268, through hollow interior 270, and through opening 274 in back 262 to tube portion 256.

### Tube Portion 256:

Tube portion 256 is formed of any suitable size, shape, and design and is configured to facilitate connection with a vacuum tube and provide a fluidic connection from opening 274 in back 262 of insert portion 254 to the vacuum tube. In the arrangement shown, as one example, tube portion 256 has an elongated tube shape extending from a first end 280 to a second end 282. In this example arrangement, first end 280 has generally rectangular shape when viewed from the front and is connected to the back 262 of insert portion 254. In this example arrangement, second end 282 has a generally circular shape when viewed from the rear. In this example arrangement, second end 282 is configured to facilitate connection with a vacuum tube (e.g., of a commercial vacuum) by either inserting an end of the vacuum tube into an interior of second end 282, or by inserting second end 282 into the end of the vacuum tube.

### Handle 222:

Handle 222 is formed of any suitable size, shape, and design and is configured to provide a firm hand hold for a user to position and hold system 10 during operation for drilling pocket holes. In the arrangement shown, as one example, handle 222 is a generally loop shaped handle having a central section 290, side sections 292, and curved sections 294 that connect side sections 292 to central section 290. In this example arrangement, central section 290 has an elongated cylindrical shape extending horizontally between opposing ends 296, where central section connects to curved sections 294. In this example arrangement, curved sections 294, curve downward approximately 100 degrees before connecting with side sections 292. In this example arrangement, each side section 292 has an elongated cylindrical shape extending downward from an upper end 298, where side section 292 connects to a curved section 294, to a lower end 300, where side section 292 connects to main body 220 of rear handle assembly 22.

In this example arrangement, lower ends 300 of side sections 292 of handle 222 connect to main body 220 at locations where the top 234 and sides 238 meet. However, the embodiments are not so limited. Rather, it is contemplated that handle 222 may be located at any position on main body 220 or any other position of system 10. Furthermore, it is contemplated that handle 222 may be implemented using various different types of handgrips including but not limited to horizontal handgrips, vertical handgrips, knobs, wheels, loops, and/or any other type of handle or handgrip.

In the arrangements shown, as one example, handle 222 and main body 220 are formed as a unitary member. However, embodiments are not so limited. Rather, it is contemplated that handle 222 and main body 220 may be separate parts that are connected together using various means and methods known in the art including but not limited to, for example, adhesive bonding, chemical bonding, welding, and/or mechanical attachment means such as screws, bolts, threading, interlocks, clips, pins, or other coupling devices.

### Lip Assembly 24:

Lip assembly 24 is formed of any suitable size, shape, and design and is configured to facilitate proper positioning of system 10 on workpiece 12 for drilling of pocket holes.

### Lip Member 310:

In an arrangement shown, as one example, lip assembly 24 includes a lip member 310 attached to the bottom 236 of main body 220 of rear handle assembly 22 proximate to back 232 of main body 220. Lip member 310 is formed of any suitable size, shape, and design and is configured to provide a front surface configured to engage a rearward edge for workpiece 12 to facilitate positioning system 10 to drill pocket holes at a proper distance from the rearward edge of workpiece 12. In the arrangement shown, lip member 310 has an elongated rectangular shape having a front 314, a rear 316, a top 318, a bottom 320, and opposing sides 322. In this example arrangement, lip member 310 has a notch 324 centrally positioned between opposing sides and extending inward from front 314 and top 318 of lip member 310. Notch 324 provides space for drill bit 58 to extend through a rear edge of workpiece 12 when a pocket hole is being drilled.

In various different arrangements, lip member 310 may be connected to bottom 236 of main body 220 in various different ways. In the arrangement shown, as one example, top 318 of lip member 310 includes a connection feature 326 configured to be inserted into and held within a recessed slot 328 formed in bottom 236 of main body 220. However, the embodiments are not so limited. Rather, it is contemplated that rear handle assembly 22 may be connected to base assembly 14 using any means and methods known in the art including but not limited to, for example, adhesive bonding, chemical bonding, welding, and/or mechanical attachment means such as screws, bolts, threading, interlocks, clips, pins, or other coupling devices.

### Adjustable Lip Assembly 24:

It should be understood that the proper distance from a rearward edge of workpiece 12 at which a pocket hole should be drilled depends on the thickness of the workpiece 12. Generally speaking, as thickness of a workpiece 12 increases, pocket holes should be drilled further away from the rearward edge of the workpiece 12. Conversely, as thickness of a workpiece 12 decreases, pocket holes should be drilled closer to the rearward edge of the workpiece 12. In one or more arrangements, lip assembly 24 is adjustable (adjustable lip assembly 24) to position front 314 of lip member 310 closer to or further away from drill bit opening 50, at which drilling assembly 16 is configured to drill pocket holes.

Adjustable lip assembly 24 is formed of any suitable size, shape, and design and is configured to facilitate proper positioning of system 10 on workpiece 12 for drilling of pocket holes for workpieces of different thicknesses. In the arrangement shown, as one example, adjustable lip assembly 24, includes lip member 310 and a plurality of recessed slots 328 formed in bottom 236 of main body 220 of rear handle assembly 22. In this example arrangement, the plurality of recessed slots 328 extend in parallel spaced alignment to one another at respective distances from the back of 232 of main body 220. These pluralities of recessed slots 328 allow connection feature 326 of lip member 310 to be inserted various ones of recessed slots 328 at different positions, thereby permitting lip member 310 to be moved forward or backward relative to drill bit opening 50.

In one or more arrangements, system 10 may include measuring indica 334 (not shown) positioned in or on plate 30 and/or rear handle assembly 22 adjacent recessed slots 328 so as to help the user properly position and align lip member 310 based on workpiece 12 thickness. Measuring indica 334 may include, for example, ¼″, ½″, ¾″, 1″, 1¼″, 1½″, or any other measurement.

### Alternative Adjustable Lip Assembly 24:

In one or more arrangements, adjustable lip assembly 24 has a lip member 342 that is configured be slidable forward and backward to facilitate repositioning of lip member 342. In an arrangement shown, as one example, adjustable lip assembly 24 includes a receiver 340, sliding lip member 342, and a set of guide members 344, among other components.

### Receiver 340:

Receiver 340 is formed of any suitable size, shape, and design and is configured to connect with base assembly 14, rear handle assembly 22, or other component of system 10 and receiver 340 and hold sliding lip member 342 while permitting sliding lip member 342 to be repositioned forward and backward in receiver 340. In the arrangement shown, as one example, receiver 340 has a front member 350, a rear member 352, and side members 354 connected in a generally rectangular arrangement.

In this example arrangement, front member 350 has an elongated rectangular shape having a front 358, a back 360, a top 362, and a bottom 364 extending between opposing ends 366, where front member 350 connects to a forward end 390 of side members 354.

In this example arrangement, rear member 352 has an elongated rectangular shape having a front 370, a back 372, a top 374, a bottom 376, extending between opposing ends 378, where rear member 352 connects to a rearward end 392 of side members 354. In this example arrangement, top 374 of rear member 352 is sloped downward as rear member 352 extends from front 370 to back 372.

In this example arrangement, side members 354 have a generally rectangular shaped upper portion 382 having a top 384, a bottom 386, and sides 388 extending from forward end 390 to rearward end 392. In this example arrangement, side members 354 have a rectangular shaped lower portion having a front 400, a back 402, sides 404, and extending from an upper end 406, connected to upper portion 382, to a lower end 408. In this example arrangement, each side member 354 has a recessed channel 412 formed in an inner one of the sides 404 and extending forward from the back 402 of lower portions 398 of side members 354.

### Recessed Channels 412:

Recessed channels 412 are formed of any suitable size, shape, and design and are configured to receive a slide connection member 440 of sliding lip member 342 and facilitate forward and backward movement of sliding lip member 342. In this example arrangement, recessed channels 412 extend forward and upward at an angle from the front 400 of lower portions 398 of side members 354. The angle of the recessed channels 412 helps maintain a proper height of sliding lip member 342 so sliding lip member 342 does not hold plate 30 off of workpiece 12 if sliding lip member 342 and workpiece 12 are both resting on a worktable. For thinner workpieces 12, sliding lip member 342 is moved forward so pocket holes will be drilled closer to the edge. Due to the angle of the recessed channels 412, sliding lip member 342 is moved upward as it is moved back so the distance that sliding lip member 342 extends below plate 30 is approximately the same as the thickness of the workpiece 12.

In the arrangement shown, as one example, side members 354 also include generally rectangular shaped recesses 418 proximate to forward end 390 of upper portion 382. In this example arrangement, recesses 418 are formed in a corner of side members 354, where top 384 and inner side 388 of upper portion 382 meet. In this example arrangement, recesses 418 include features 420 configured to hold guide members 344 at a plurality of different positions to facilitate positioning of sliding lip member 342 for drilling pocket holes for workpieces 12 of different thicknesses.

### Sliding Lip Member 342:

Sliding lip member 342 is formed of any suitable size, shape, and design and is configured to provide a surface configured to engage a rearward edge for workpiece 12 to facilitate positioning system 10 to drill pocket holes at a proper distance from the rearward edge of workpiece 12. In the arrangement shown, sliding lip member 342 has an elongated rectangular shape having a front 430, a rear 432, a top 434, a bottom 436, and opposing sides 438. In this example arrangement, sliding lip member 342 has slide connection members 440 that extend outward from sides 438 proximate top 434 to outward ends 442.

### Slide Connection Members 440:

Slide connection members 440 are formed of any suitable size, shape, and design and are configured to be inserted withing recessed channels 412 and slide forward and backward within recessed channels 412. In this example arrangement, slide connection members 440 have an angled planar shape having a parallel upper surface 444 and a lower surface 446 extending from an upper edge 448 to a lower edge 450 and from sides 438 to outward ends 442.

### Connection Features 456:

In the arrangement shown, sliding lip member 342 has connection features 456 positioned on front 430 proximate to top 434. Connection features 456 are formed of any suitable size, shape, and design and are configured to facilitate operable connection of sliding lip member 342 to guide members 344. In the arrangement shown, as one example, connection features 456 are semi-cylindrical shaped protrusions 458 extending forward from front 430. In this example arrangement, connection features 456 have holes 460 extending horizontally through protrusions 458. In this example arrangement, holes 460 are configured to receive connection features 474 of guide members 344 to operably connect sliding lip member 342 to guide members 344.

### Guide Members 344:

Guide members 344 are formed of any suitable size, shape, and design and are configured to reposition sliding lip member 342 to various positions to facilitate drilling of pocket holes for workpieces 12 of different thicknesses. In the arrangement shown, as one example, guide members 344 include position adjustment members 470, connecting rods 472, and connection features 474, among other components.

### Position Adjustment Members 470:

Position adjustment members 470 are formed of any suitable size, shape, and design and are configured to be inserted into recesses 418 of side members 354, be moved forward and backward within recesses 418, and hold position at a plurality of different positions within recesses 418. In this example arrangement, position adjustment members 470 have a generally rectangular shape having a front 478, a back 480, a top 482, a bottom 484, an inner side 486, and an outer side 488. In this example arrangement, position adjustment members 470 have a feature 490 formed on outer side 488.

### Features 490:

Features 490 are formed of any suitable size, shape, and design and are configured to engage features 420 in recesses 418 of side members 354 to hold position adjustment members 470 at a plurality of different positions within recesses 418. In the arrangement shown, features 490 are protrusions that are received and held within notches in side members 354 that form features 420. In this example arrangement, force must be applied by a user to cause the protrusion feature 490 to move between adjacent ones of the notches that form features 420. In this manner, position adjustment members 470 may be moved between and held at a plurality of different positions withing recesses 418 side members 354.

### Connecting Rods 472:

Connecting rods 472 are formed of any suitable size, shape, and design and are configured to facilitate operable connection between position adjustment members 470 and sliding lip member 342. In the arrangement shown, as one example, connecting rods 472 have an elongated rectangular shape extending from a forward end 496 to a rearward end 498. In this example arrangement, inner sides 486 of position adjustment members 470 are connected alongside connecting rods 472 at forward end 496. In this example arrangement, connecting features 474 are positioned at rearward ends 498 of connecting rods 472.

### Connection Features 474:

Connection features 474 are formed of any suitable size, shape, and design and are configured to operably connect with connection features 456 of sliding lip member 342. In this example arrangement, connection features 456 have holes 460 extending horizontally through protrusions 458. In this example arrangement, holes 460 are configured to receive connection features 474 of guide members 344 to operably connect sliding lip member 342 to guide members 344. In this example arrangement, connection features 456 are cylindrical shaped protrusions that extend out to the side from rearward ends 498 of connecting rods 472 and extend into holes 460 of connection features 456 of sliding lip member 342. However, embodiments are not so limited. Rather, it is contemplated that connection features 474 and connection features 456 may using various means and methods known in the art to provide an operable connection including but not limited to, for example, screws, bolts, threading, interlocks, clips, pins, or other coupling devices.

### In Operation:

System 10 is first adjusted based on thickness of the workpiece 12 for which pocket holes will be drilled. If lip assembly 24 is adjustable, lip member 310/sliding lip member 342 of adjustable lip assembly 24 is moved to a position forward and/or rearward on system 10 corresponding to the desired workpiece 12 thickness. In one or more arrangements, for example, the correct position for a desired workpiece 12 thickness may be set by moving lip member 310/sliding lip member 342 to align with measuring indica 334 on the base assembly 14, rear handle assembly 22, or other component of system 10.

Once lip member 310/sliding lip member 342 is in position, lower surface 40 of plate 30 and/or grip pad(s) 34 of system 10 are placed on workpiece 12 with front 314 of lip member 310 (or front 430 of sliding lip member 342) positioned flush against a rearward edge of workpiece 12. System 10 is then moved sideways as required to position drill bit opening 50 at the desired location for formation of a pocket hole.

Drill depth is also set based on thickness of the workpiece 12. To adjust drill depth, a user loosens set screw 214 of stop member 210 and moves stop member 210 to a desired position along guide rod 90. As previously described, in one or more arrangements, guide rod 90 may include indica marking positions at which stop member 210 should be secured for drilling pocket holes to the proper depth for various workpiece 12 thicknesses. Once in position, the set screw 214 is tightened to set the lowest position that drilling assembly 16 may be moved along drill guide assembly 18.

If the user desires to use a vacuum to facilitate removal of drill shavings and wood chips, a vacuum tube (e.g., of a commercial vacuum) is connected to system 10 by vacuum connector 262 before commencing drilling. More specifically, in the example arrangement shown, the user connects the vacuum tube to second end 282 of tube portion 256 of vacuum connector 262 and insert portion 254 of vacuum connector 262 is inserted into passageway 246 from back 232 of main body 220 of rear handle assembly 22.

The vacuum is turned on by the user before commencing drilling. As drill shavings and wood chips are produced during drilling, airflow induced by the vacuum pulls and wood chips and shavings out through chip openings 206 of drill bit guide 106, through opening 248 of main body 220 of rear handle assembly 22, through opening in bottom 268 of insert portion 254 and into hollow interior 270. The airflow induced by the vacuum continues to pull wood chips and shavings out from hollow interior 270, through opening 274 in back 262 of insert portion 254, through tube portion 256, to the vacuum hose. In this manner wood chips and shavings generated during drillings are removed from system 10 and collected by the vacuum.

Once system 10 is positioned on workpiece 12 to drill a pocket hole in the desired location and vacuum is turned on (if used), the user commences drilling. In this example arrangement, to commence drilling, the user holds handle 222 of rear handle assembly 22 in one hand and holds handle 154 of actuating assembly 20 with the user's other hand. At this time, handle 154, is in the most rearward most position and drilling assembly 16 is in a fully retracted position.

In this example arrangement, the user presses and holds switch 156 of actuating assembly 20 to turn on the drill motor 70. As previously described, in some arrangements, the system includes a safety switch 160 (not shown) that must be pressed prior to pressing switch 156 to permit switch 156 to be depressed and/or enable operation of the drill motor 70. Such safety switch 160 may help to prevent accidental operation of drill motor.

With drill motor 70 running, the user moves handle 154 connected to first end 190 of lever 152 of actuating assembly 20 forward, away from the user. As handle 154 is moved forward, lever 152 pivots about pivot connection 194, where lever 152 is connected to fulcrum bracket 150. As lever 152 pivots, second end 192 of lever 152 is moved rearward toward the user. An operable connection between second end 192 of lever 152 and drilling assembly 16 applies force to the drilling assembly 16 to counter force applied by bias member 200 and move drilling assembly 16 rearward and downward along guide rods 90 of drilling guide assembly 18.

At the same time, movement of handle 154 forward causes a downward force to be transferred through the fulcrum bracket 150 to the plate 30 of base assembly 14 and/or grip pad(s) 34. This downward force helps to prevent system 10 from being unintentionally moved from the desired position during the drilling process. Additionally or alternatively, in one or more arrangement, movement of handle 154 forward causes a lateral force to be transferred through the fulcrum bracket 150 and other components of system 10 to lip member 310 or sliding lip member 342. This forward force similarly helps to prevent system 10 from being unintentionally moved from the desired position during the drilling process.

As drilling assembly 16 is moved rearward toward the user, drill bit 58, that is connected in chuck 72 of drilling assembly 16, is moved through drill bit guide 106 and extended through drill bit opening 50 in plate 30 of base assembly 14. As drill bit 58 extends though drill bit opening 50 below a lower surface 40 of plate 30 and/or grip pad(s) 34, drill bit 58 begins drilling a pocket hole in the workpiece 12. As the user continues to move handle 154 forward, the drilling assembly 16 continues to be moved rearward and downward along guide rods 90 of drilling guide assembly 18, causing drill bit 58 to drill deeper into workpiece 12. Drilling continues in this manner until drilling assembly 16 encounters stop member 210, at which point drilling assembly 16 is prevented from drilling any deeper into the workpiece 12. Upon encountering stop member 210, the user moves handle 154 rearward to cause drilling assembly 16 to be moved forward and upward along guide rods 90, thereby retracting drill bit 58 back through drill bit opening 50. With drilling assembly 16 in a retracted position, the user may release switch 156 to turn drill motor 70 off.

While arrangements are primarily described with reference to user positioned rearward of system 10 and moving handle 154 forward away from the user to drill a pocket hole, the embodiments are not so limited. Rather, it is contemplated that in one or more arrangements, system 10 may be configured for a user to be positioned in front of system 10 and pull handle 154 toward the user to drill a pocket hole.

### Alternative Arrangement:

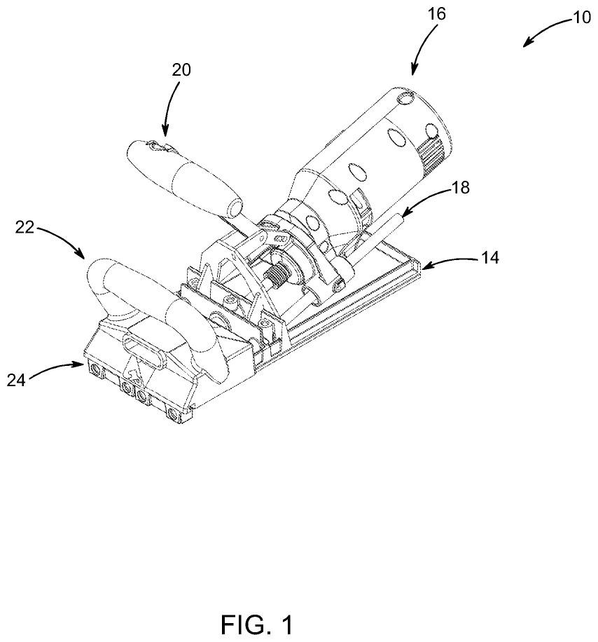

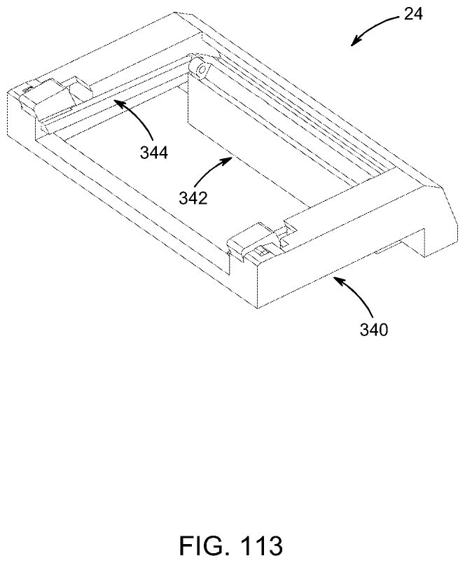

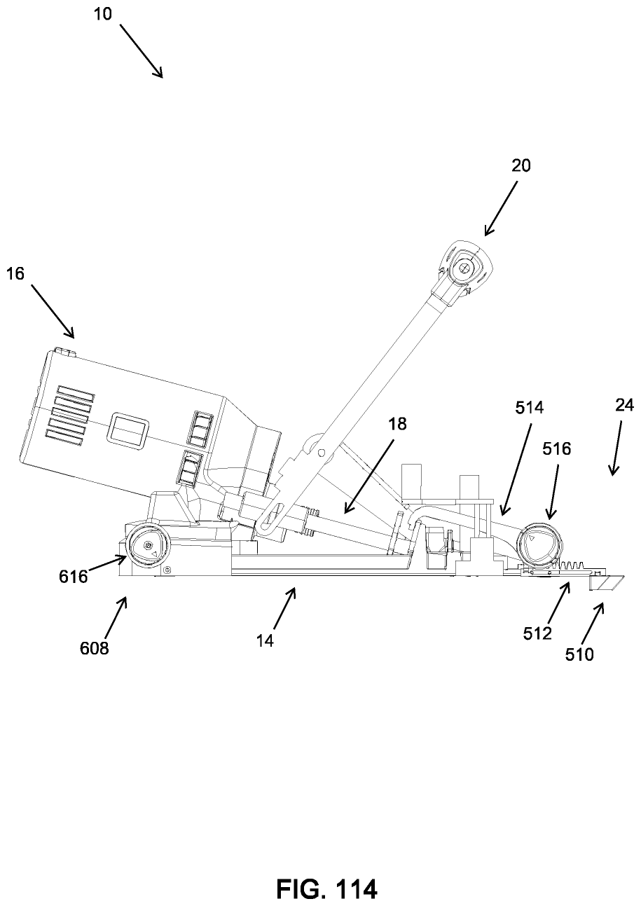

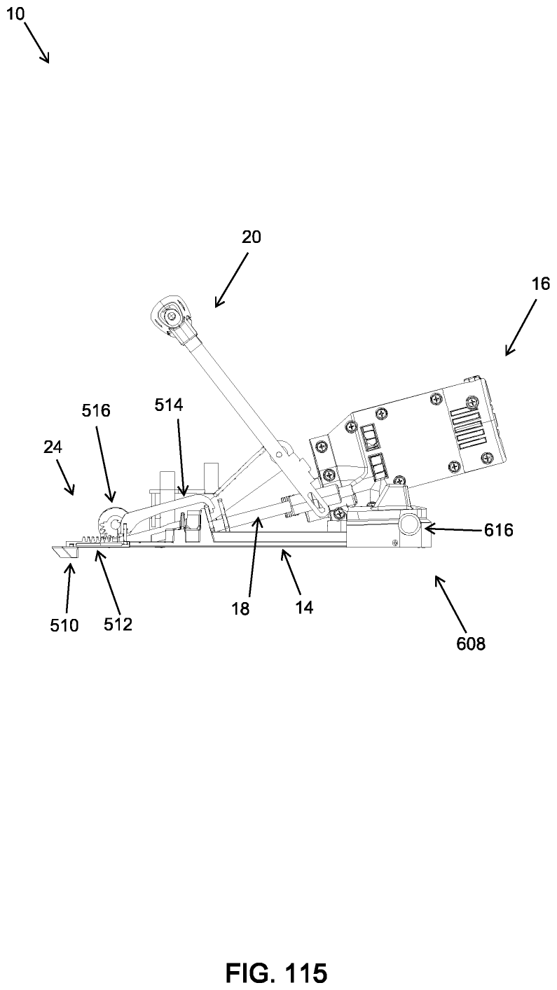

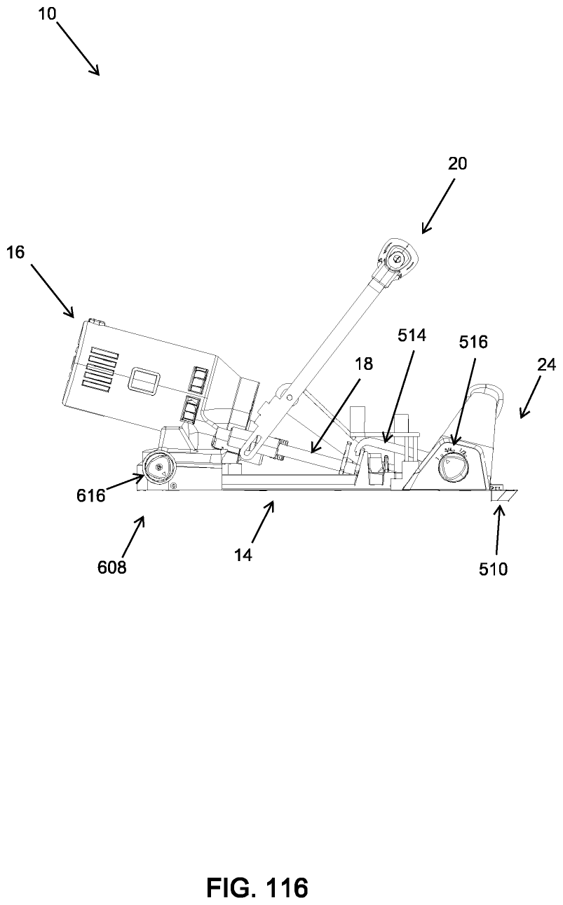

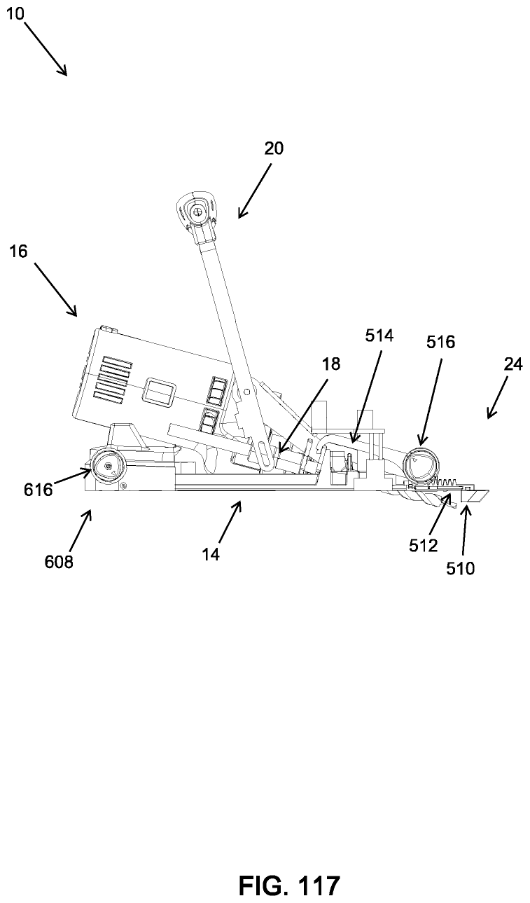

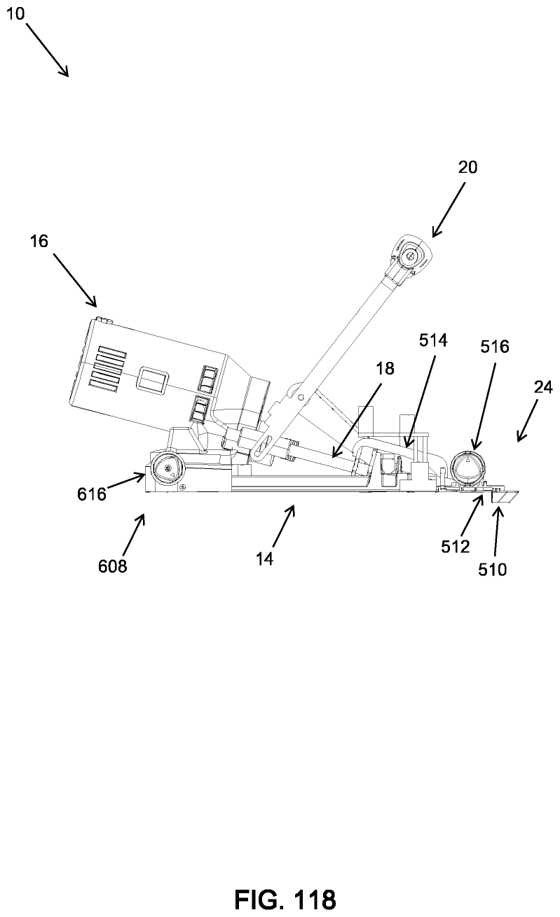

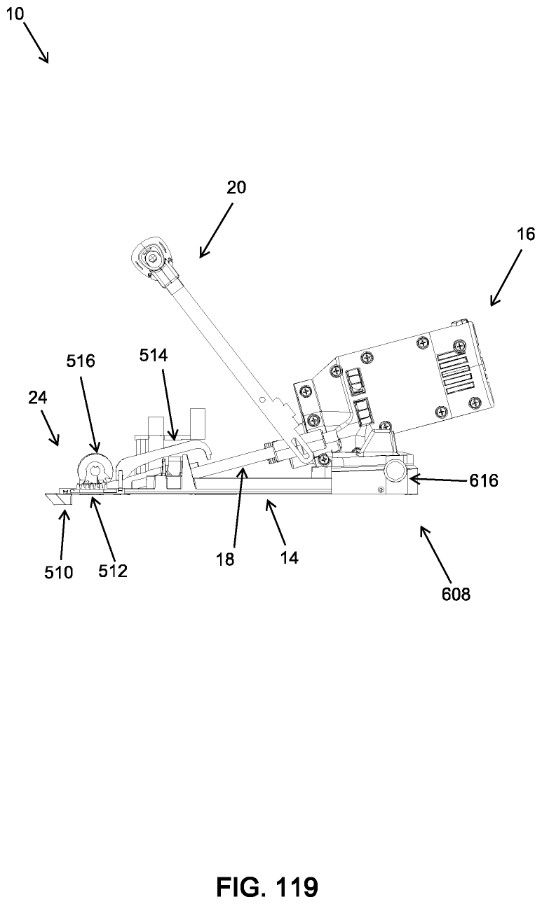

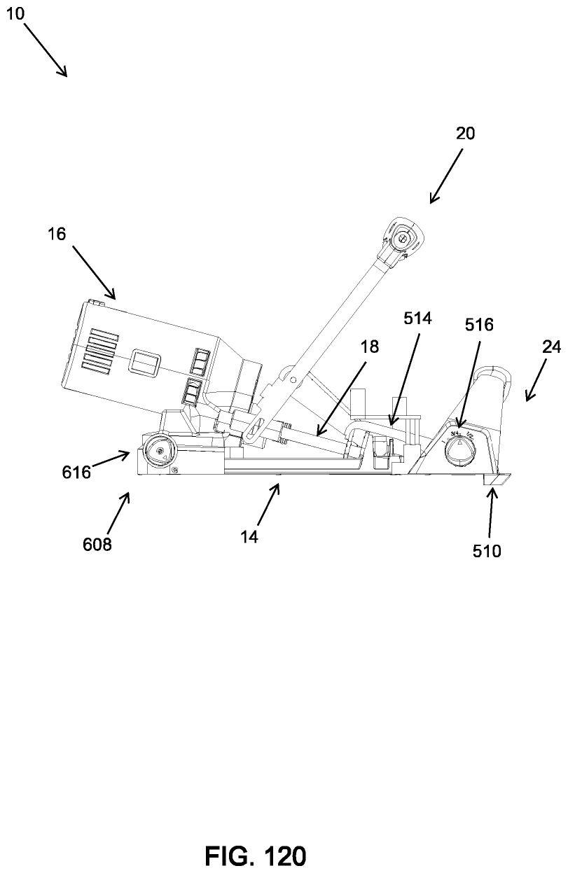

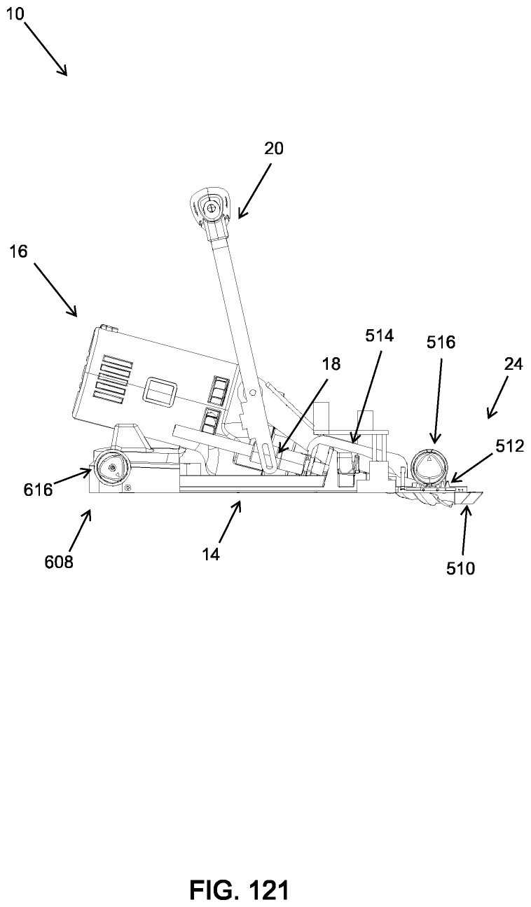

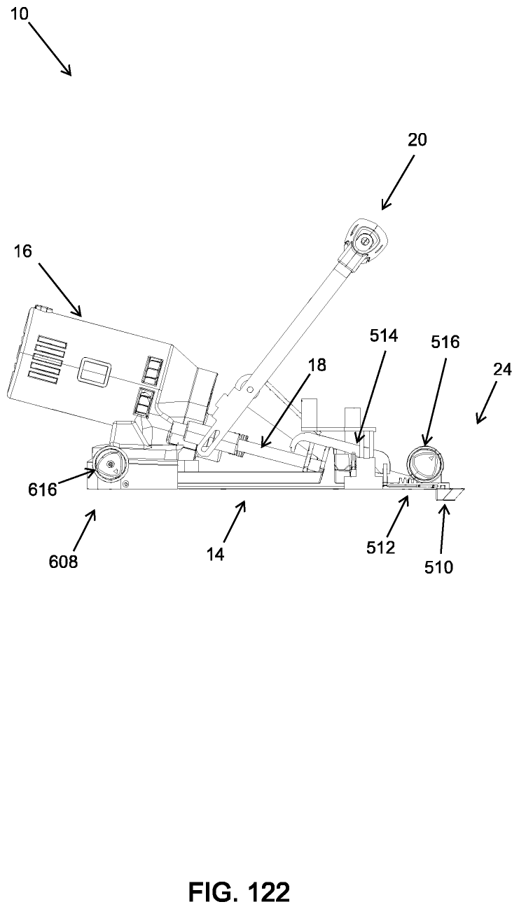

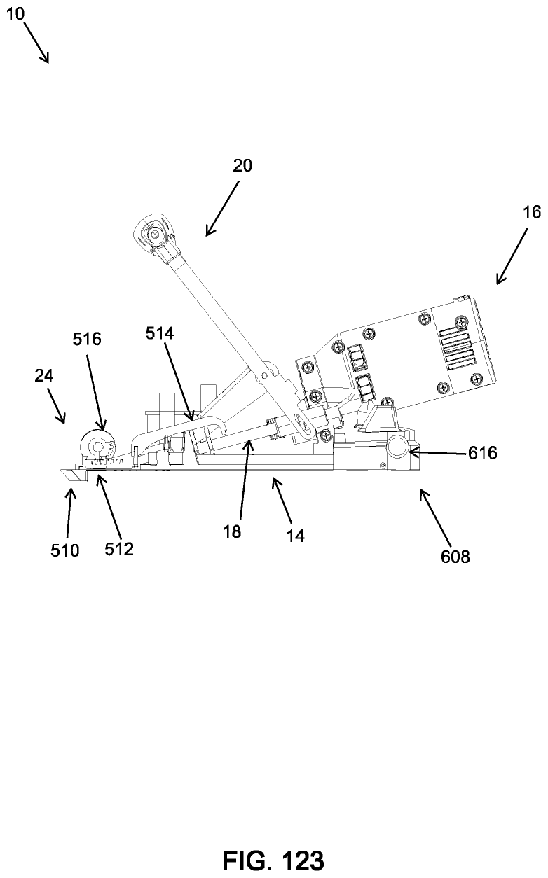

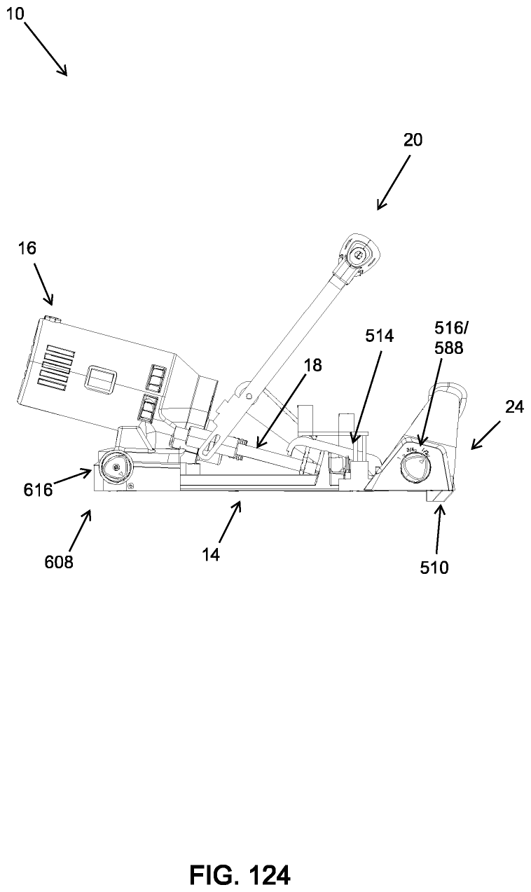

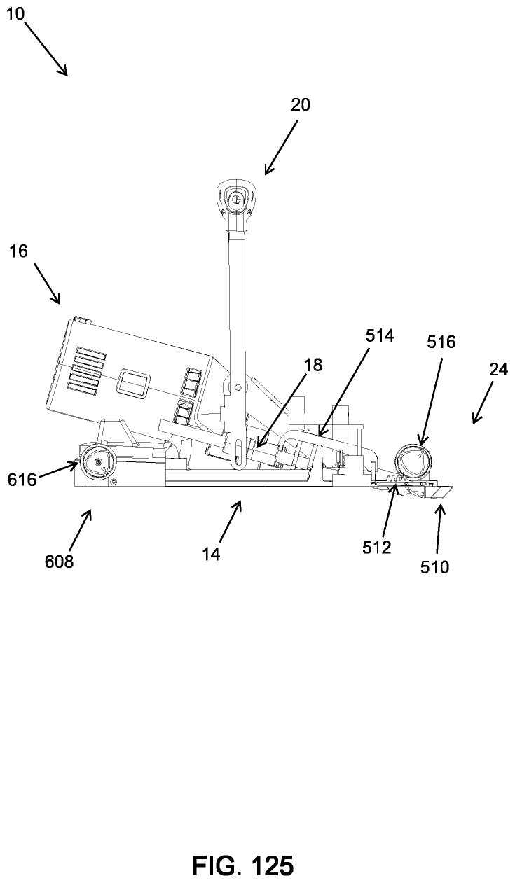

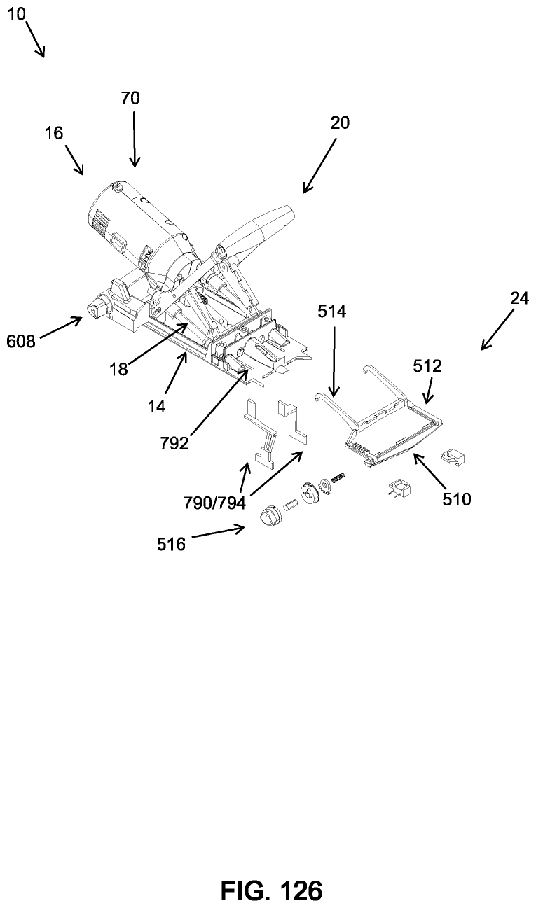

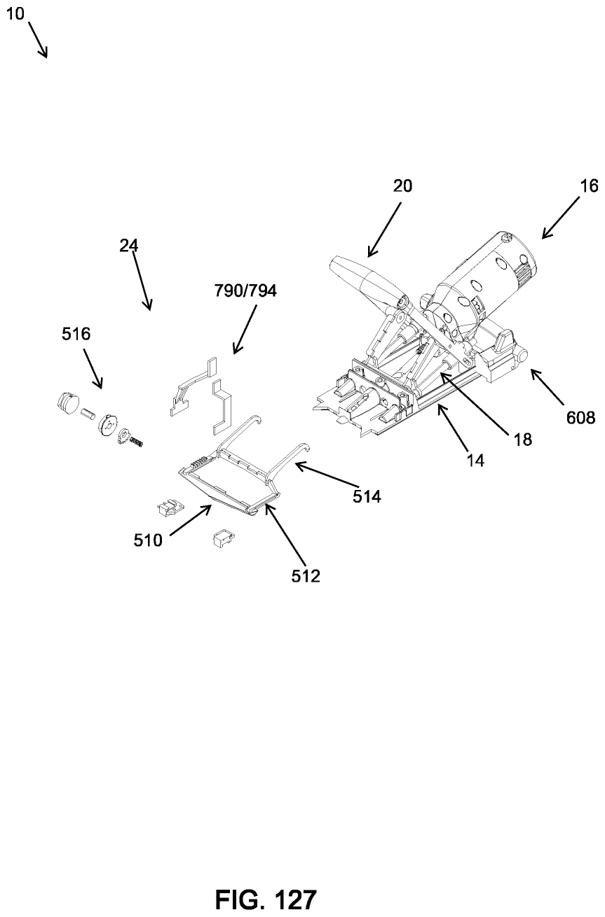

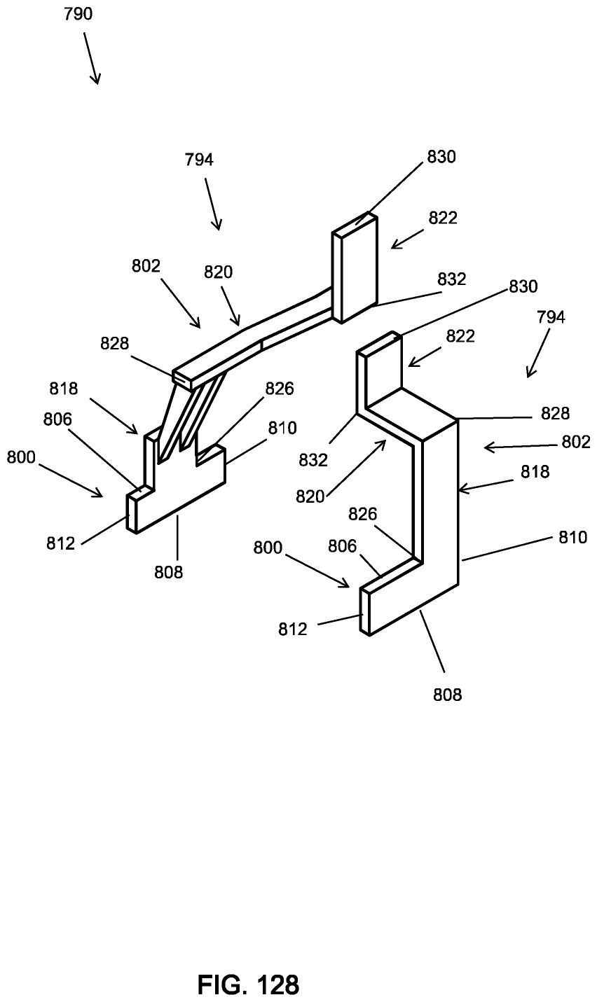

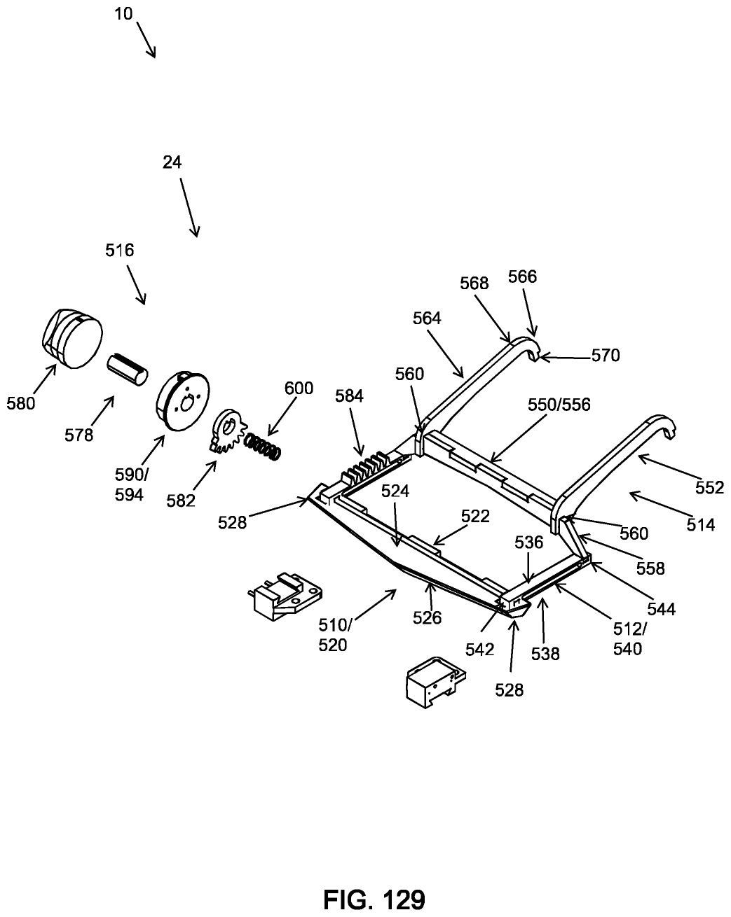

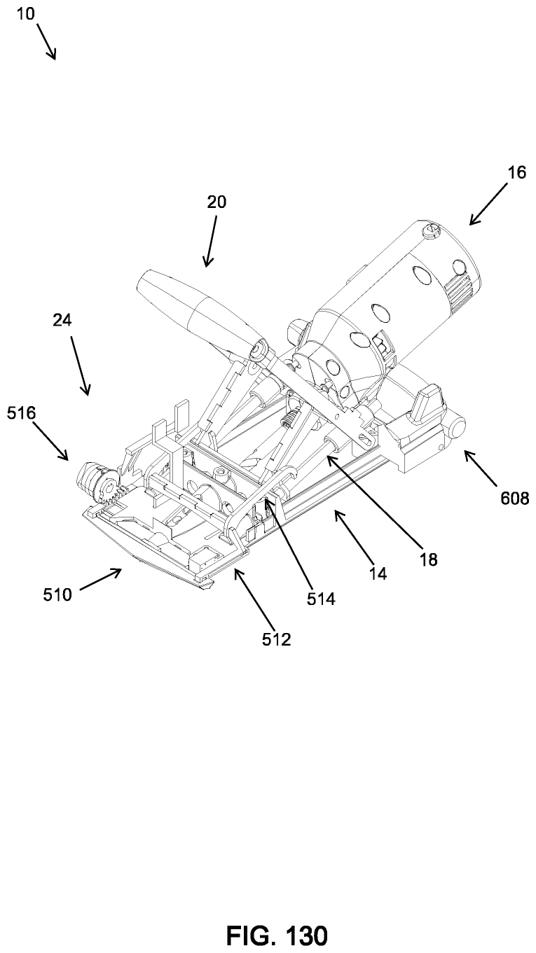

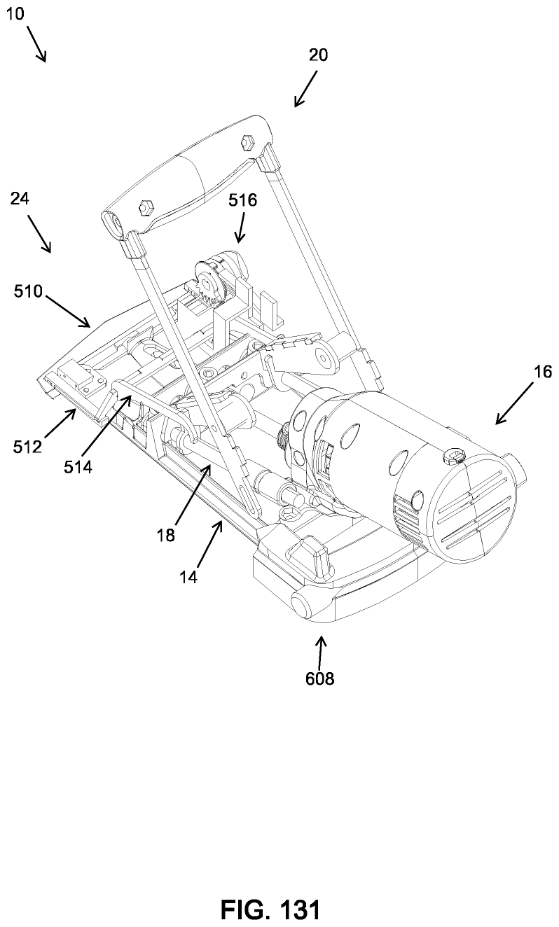

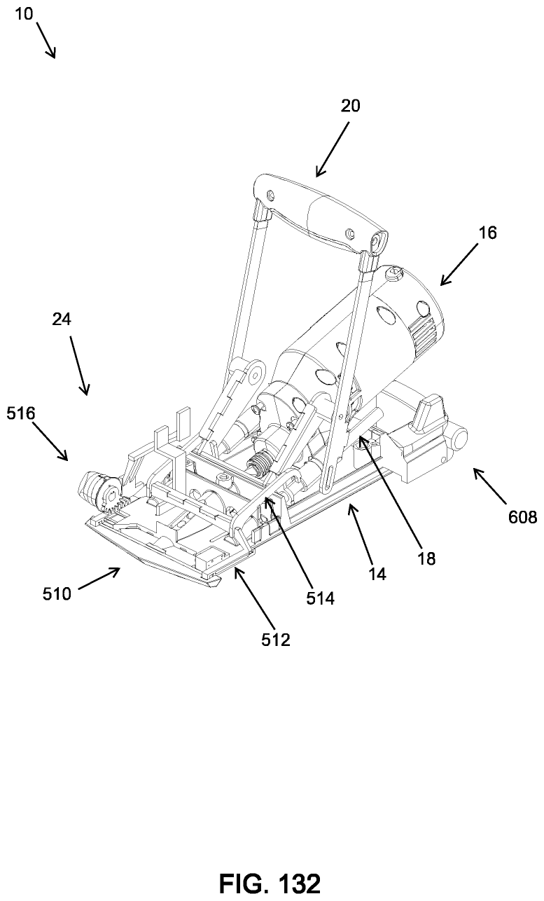

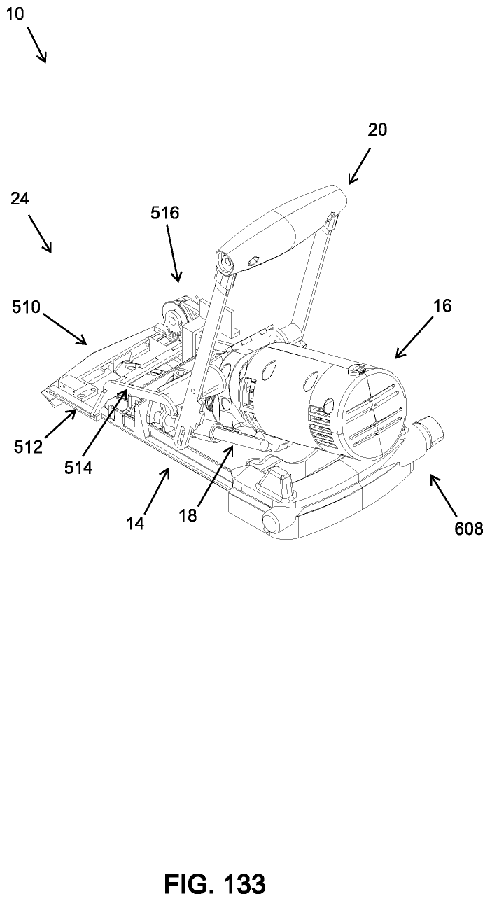

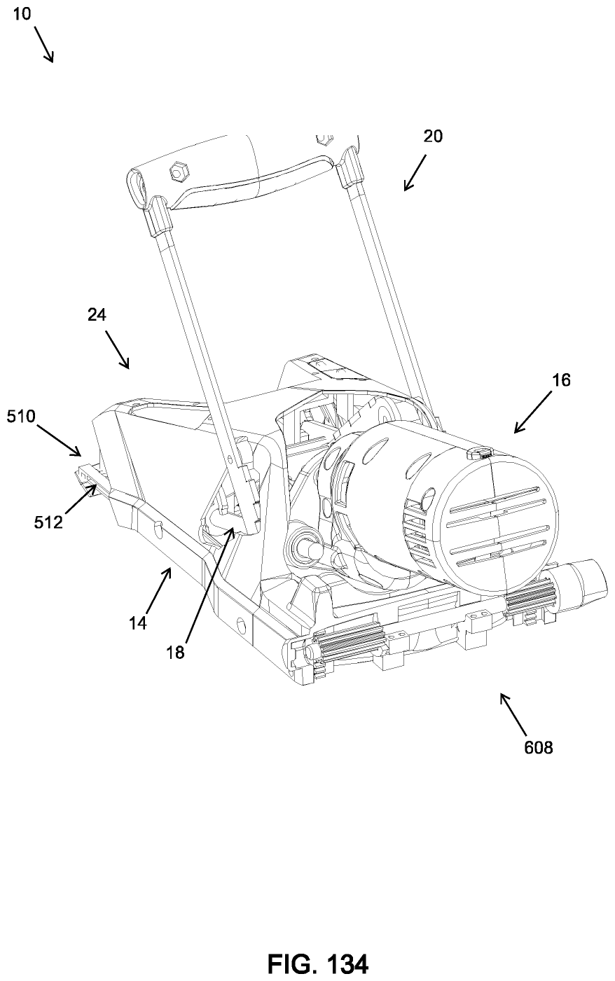

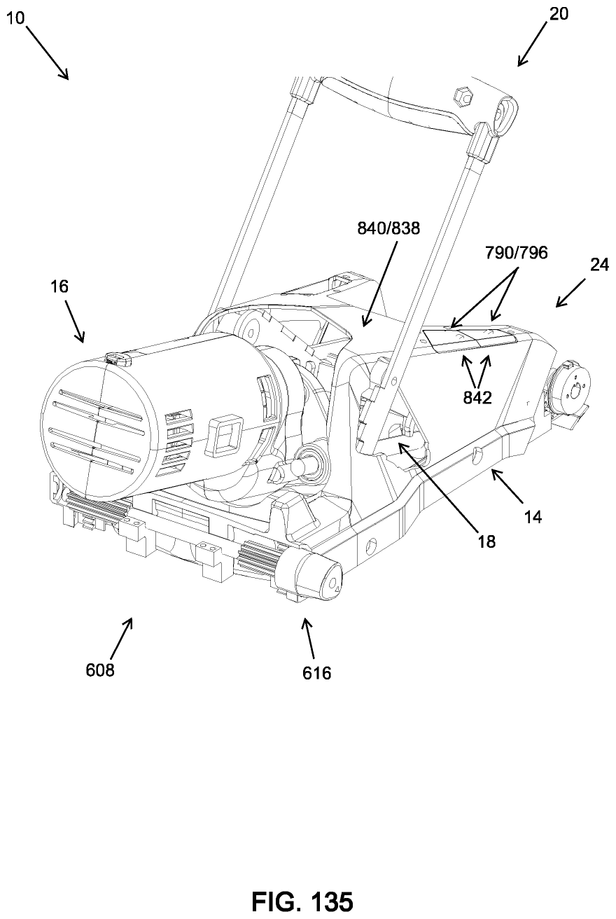

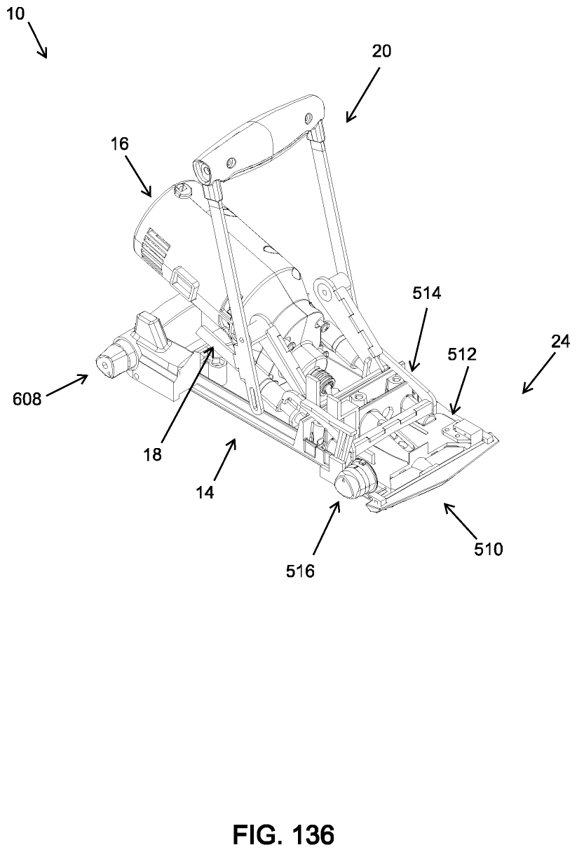

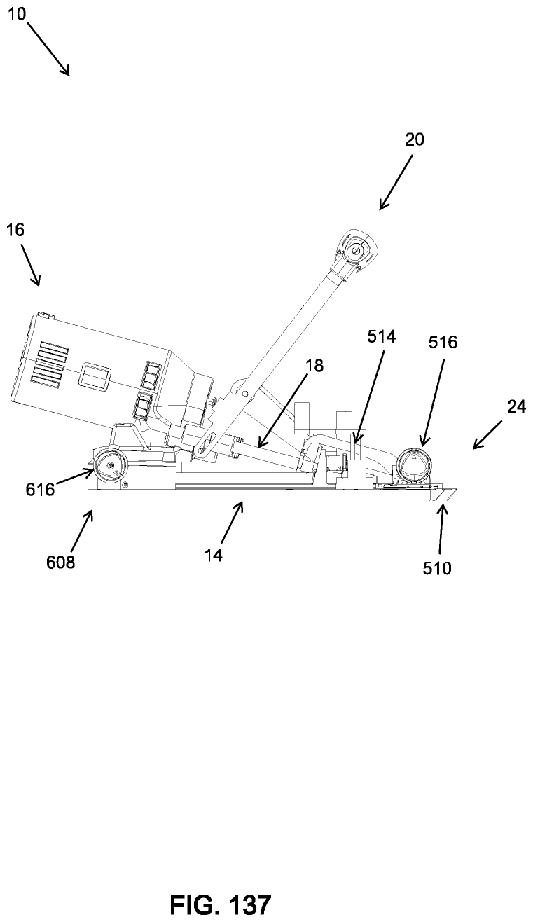

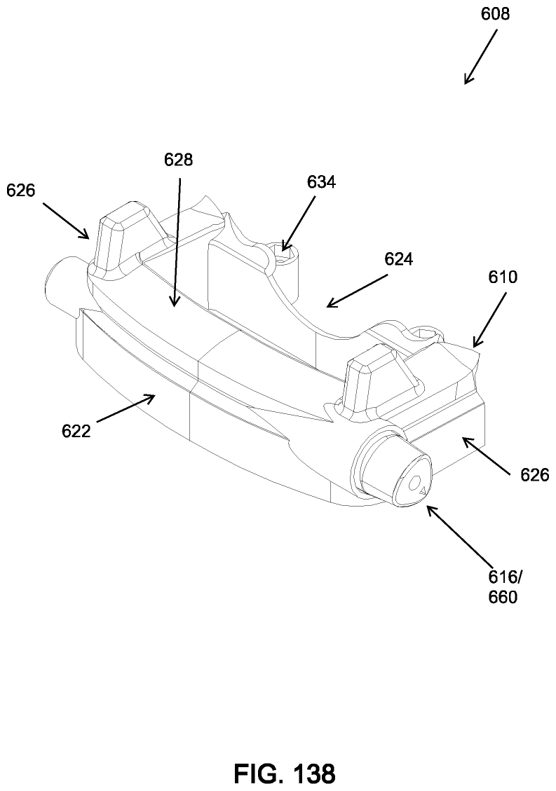

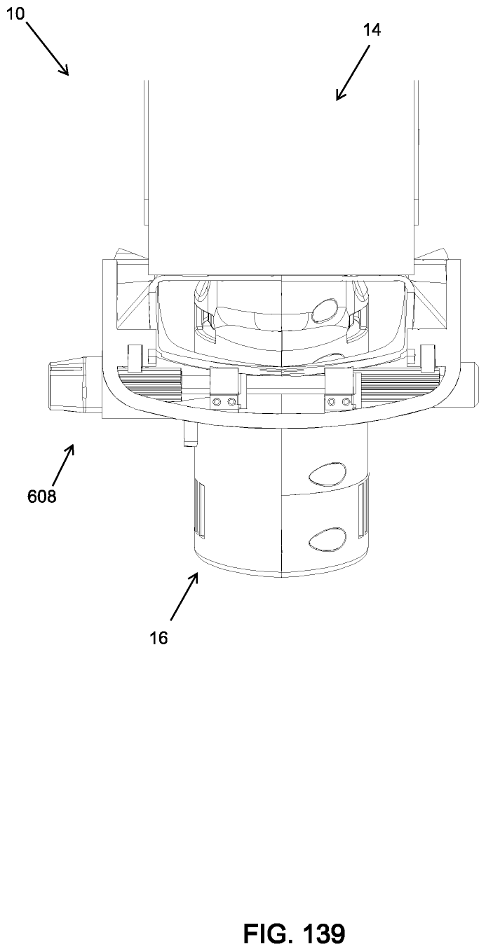

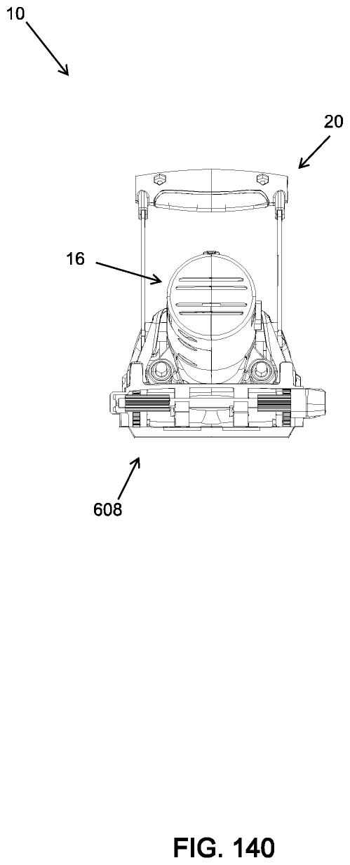

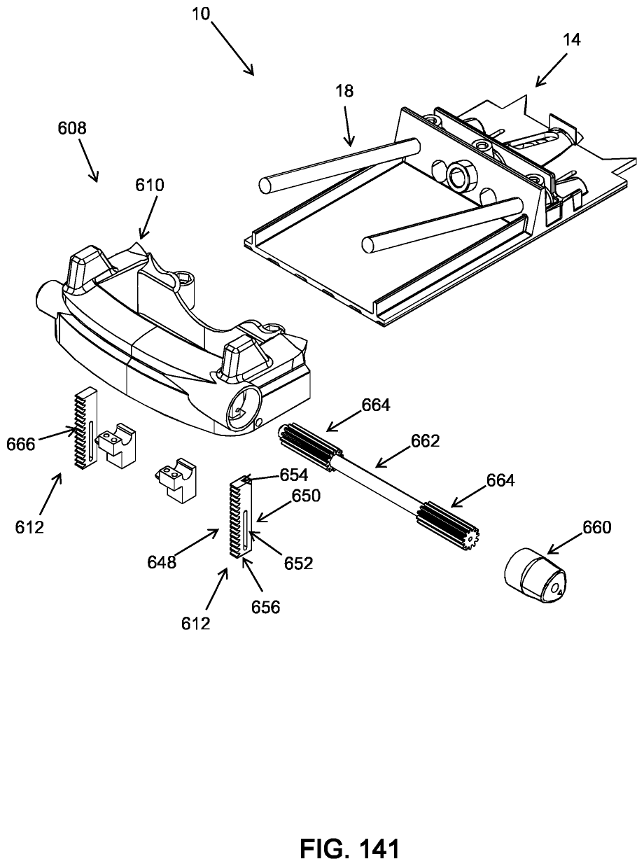

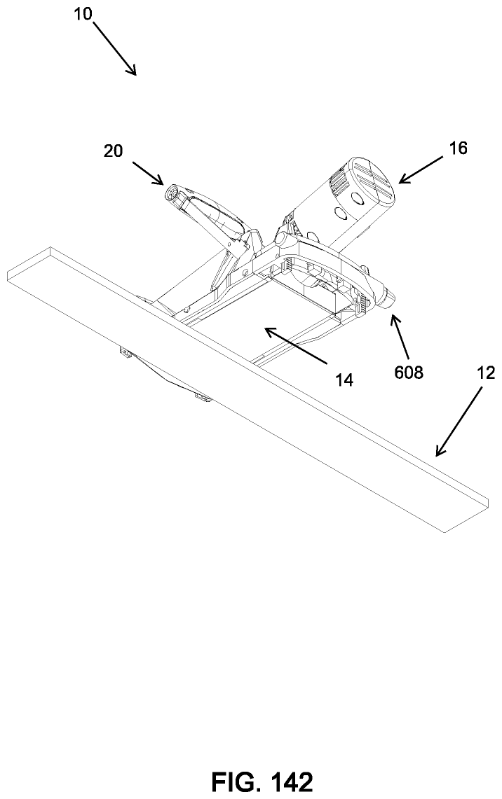

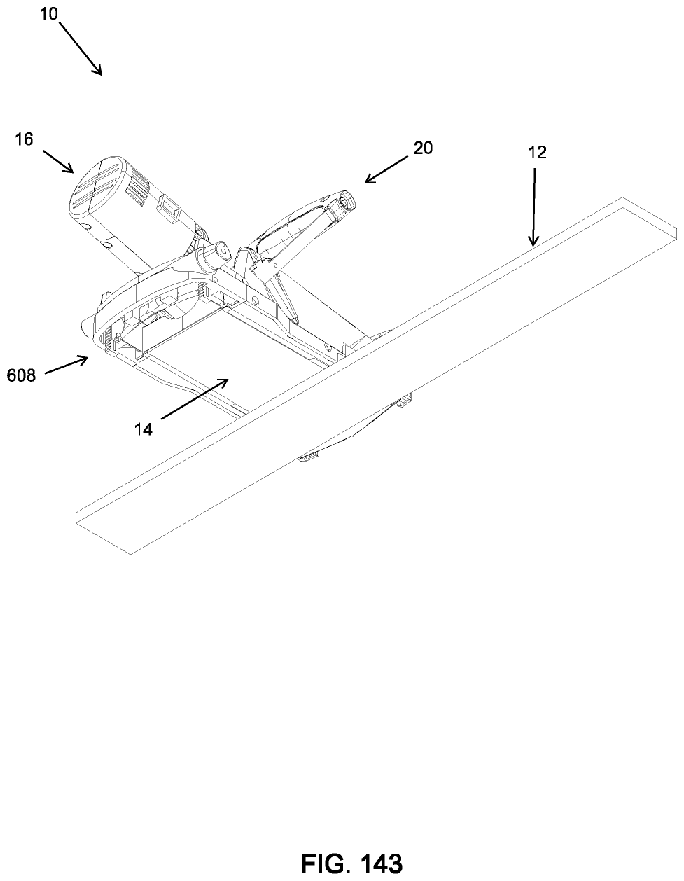

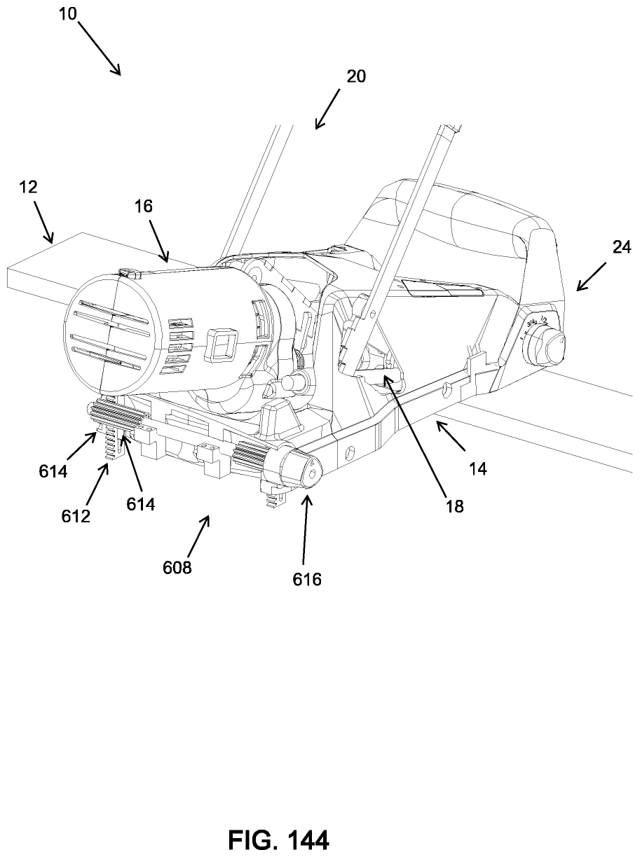

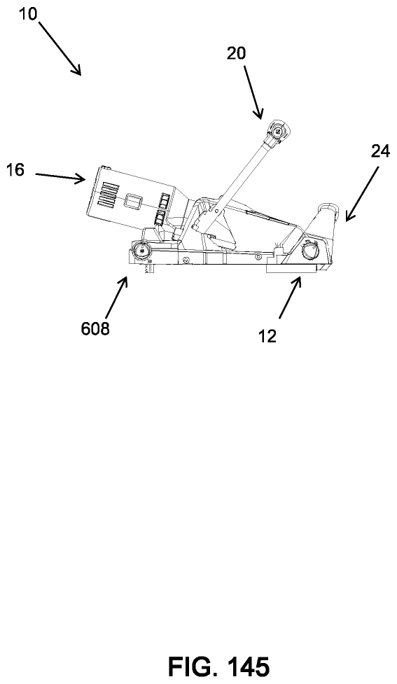

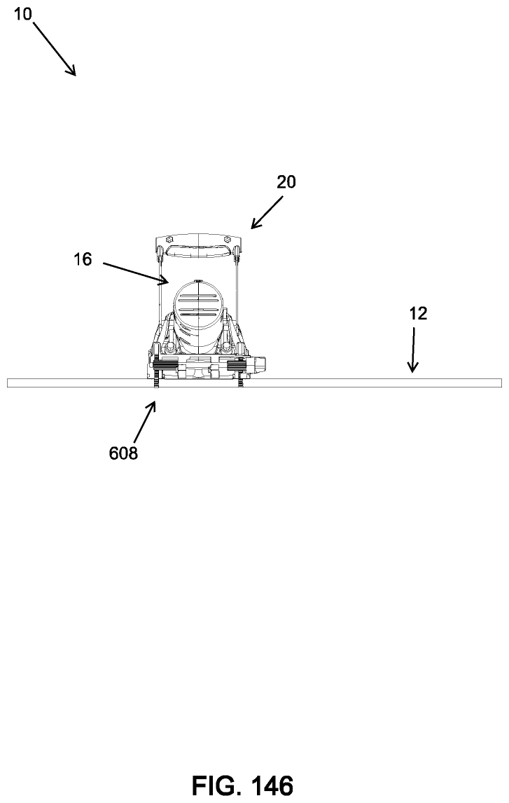

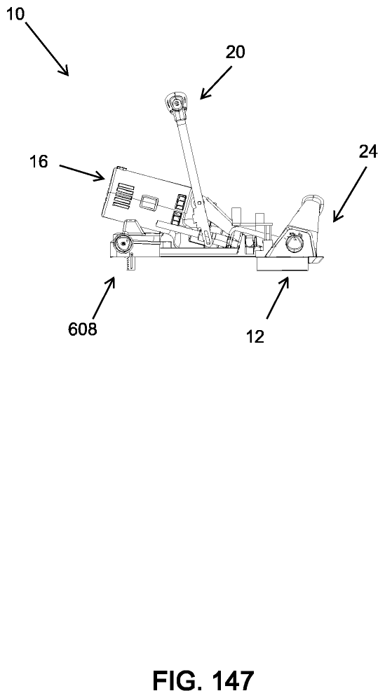

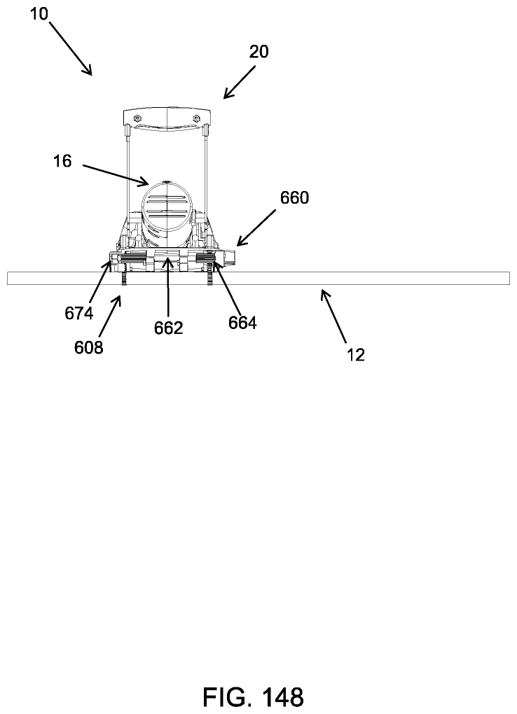

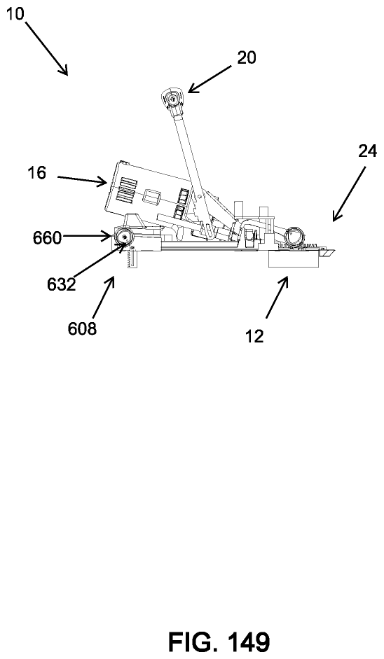

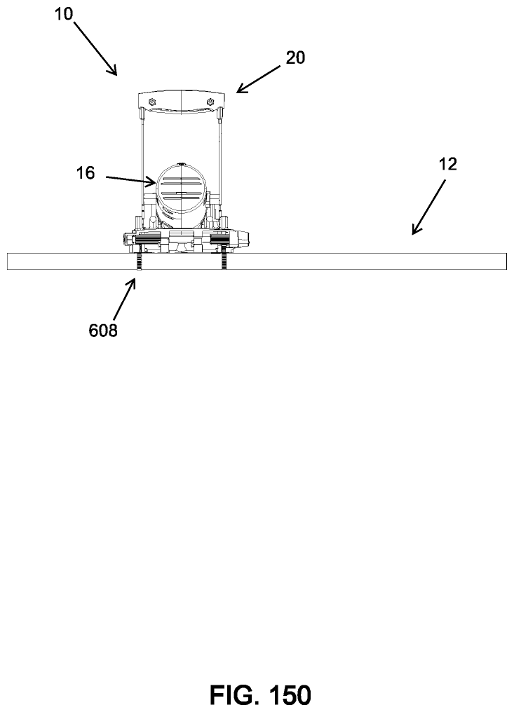

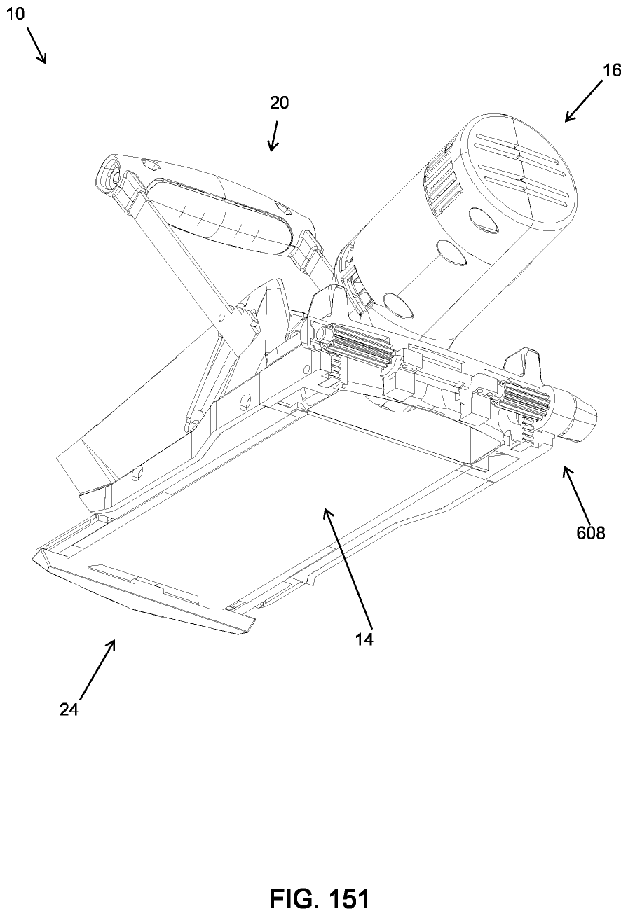

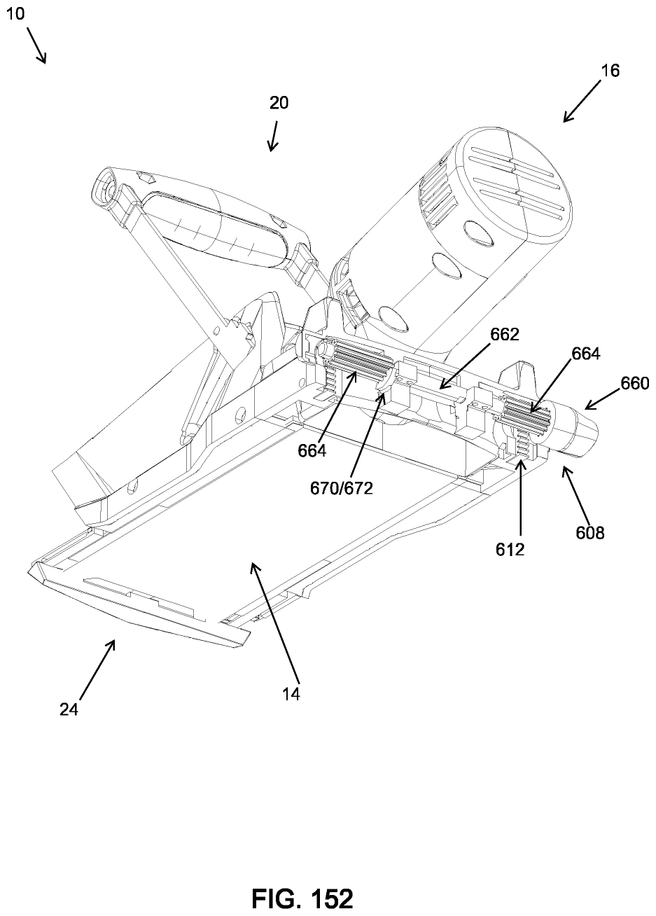

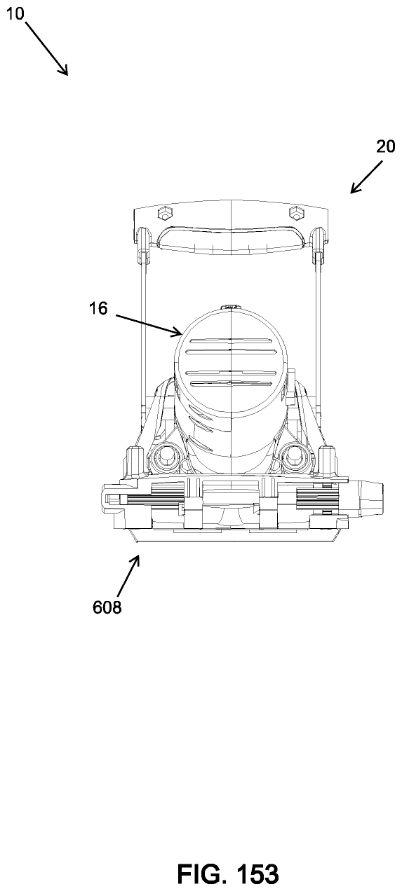

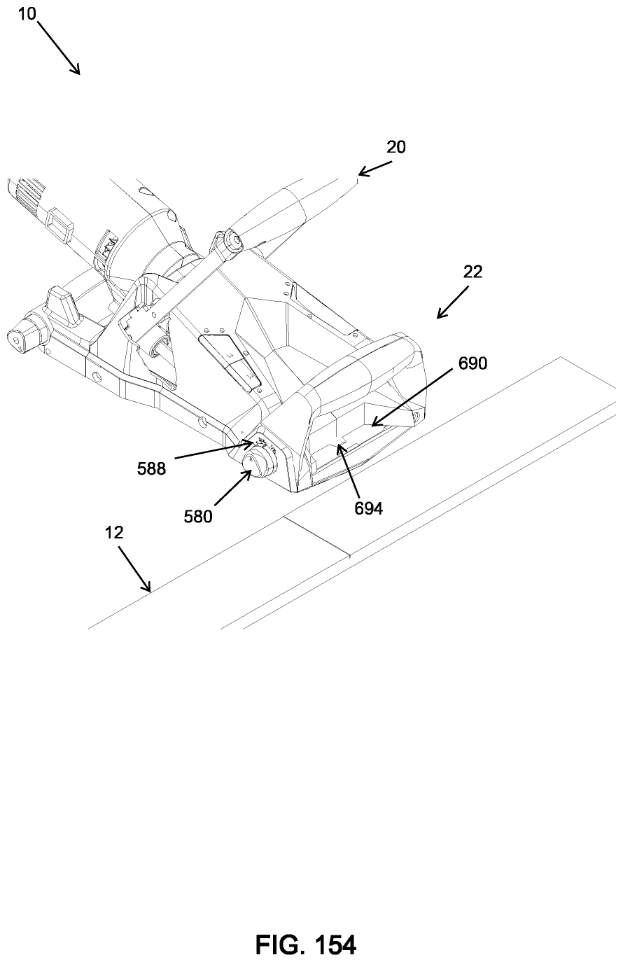

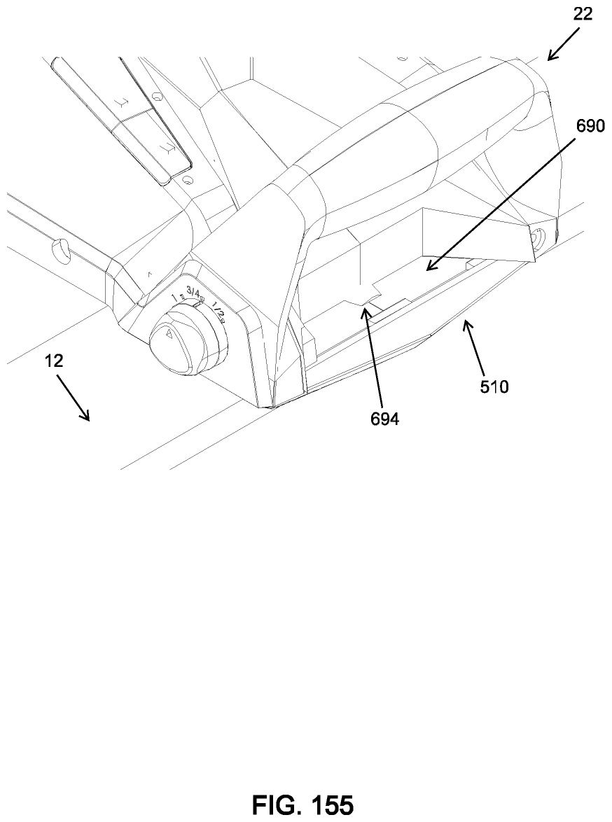

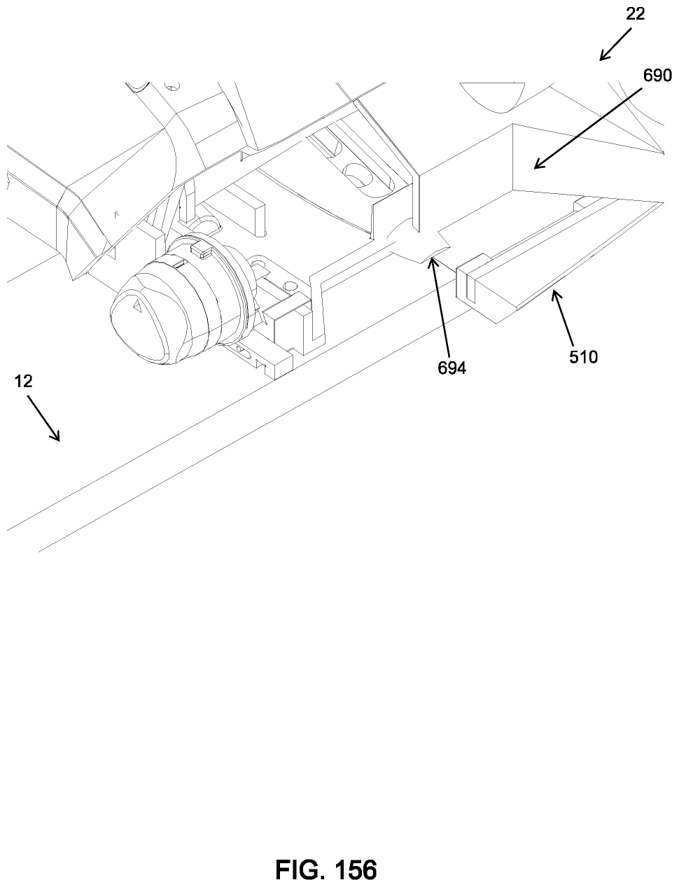

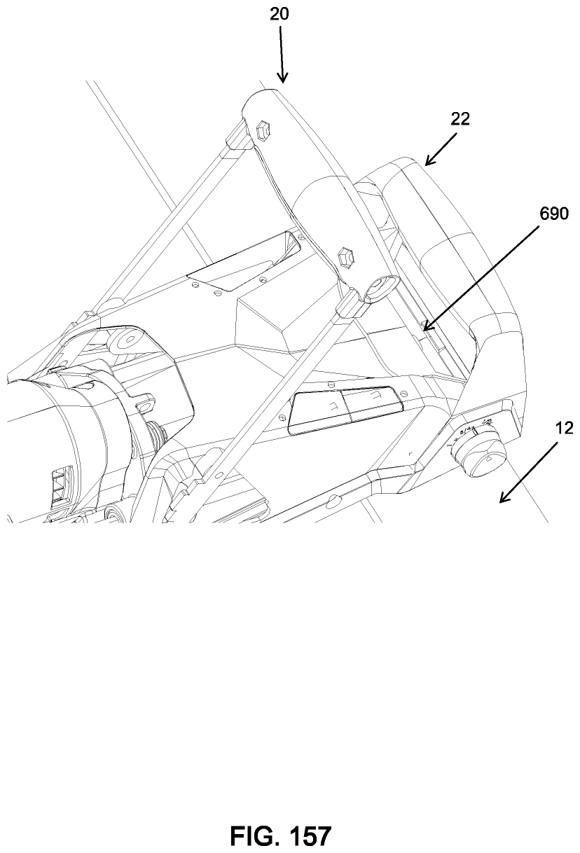

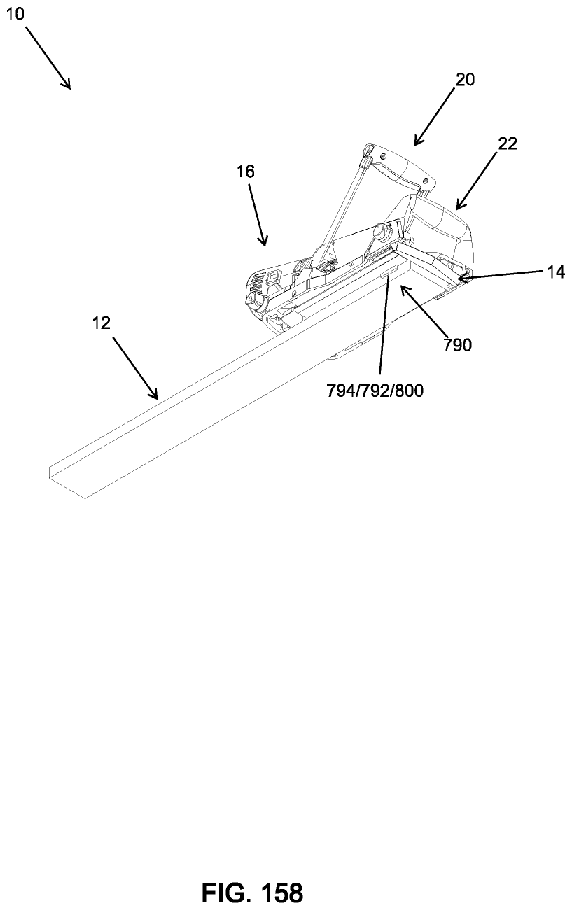

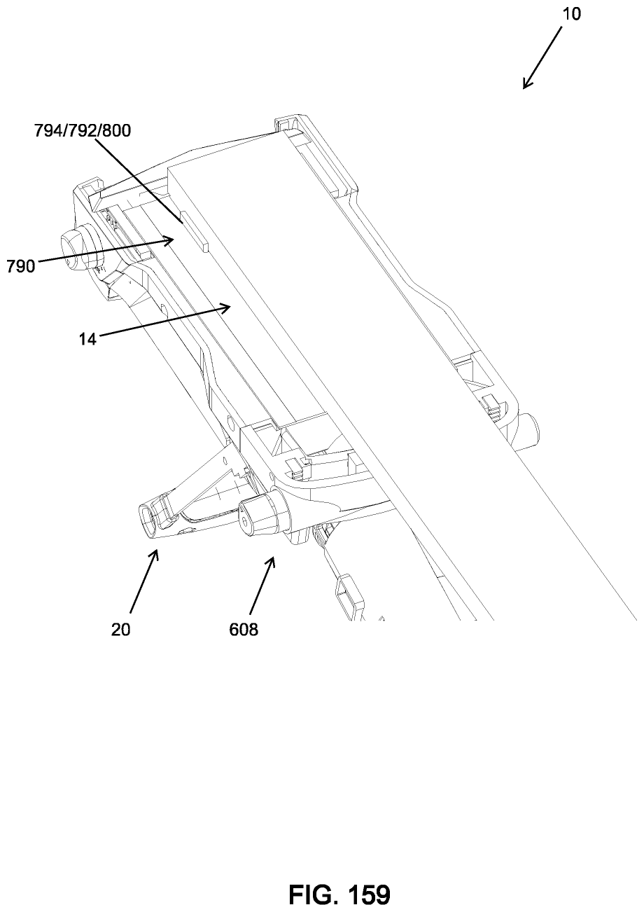

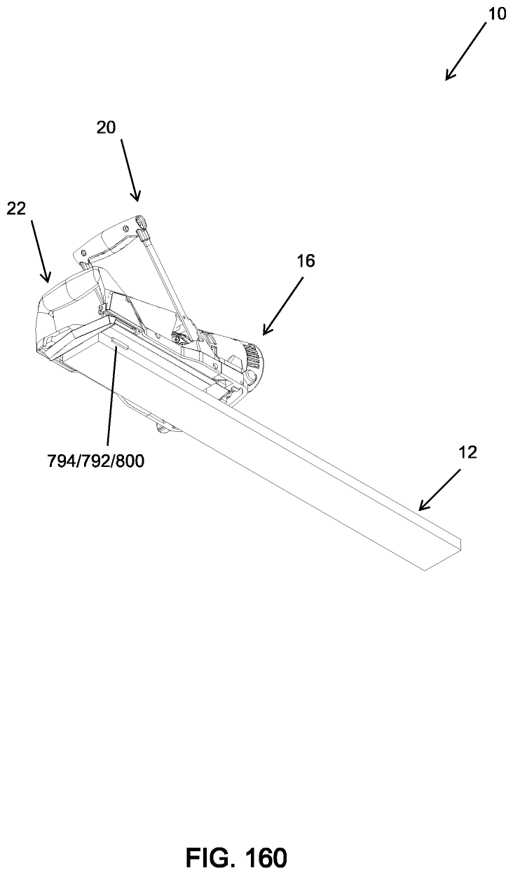

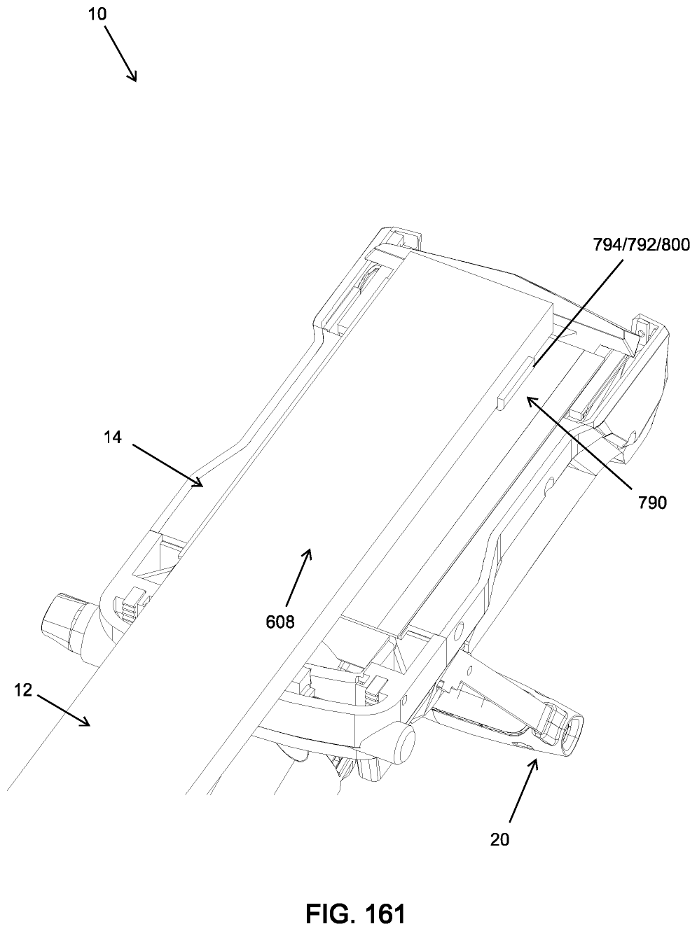

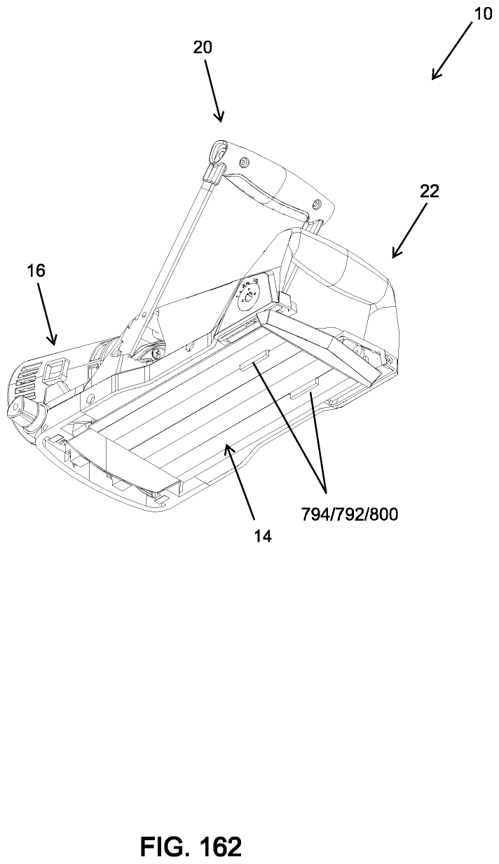

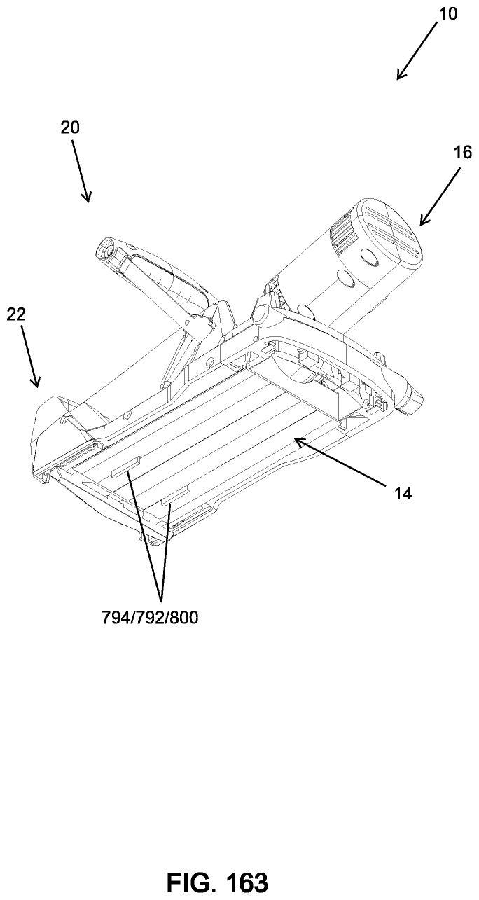

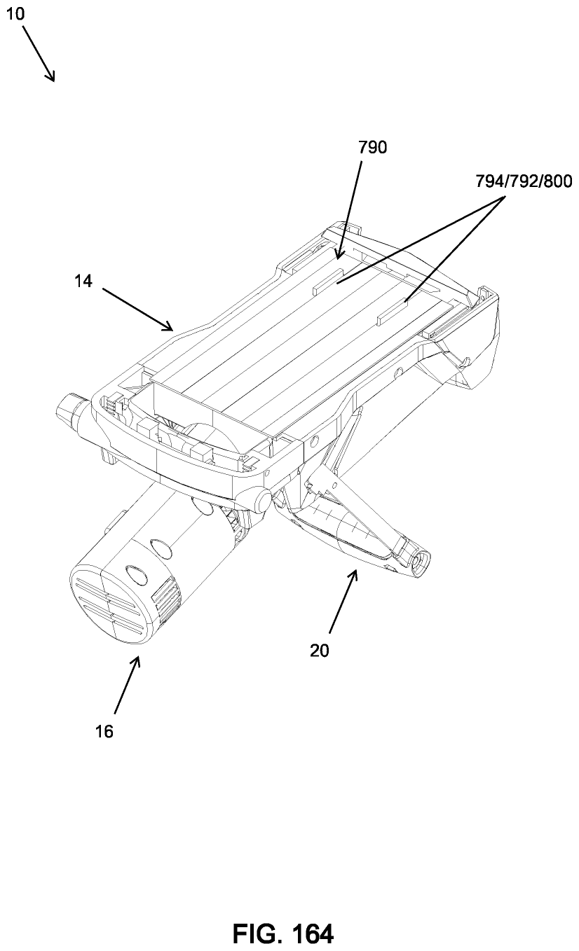

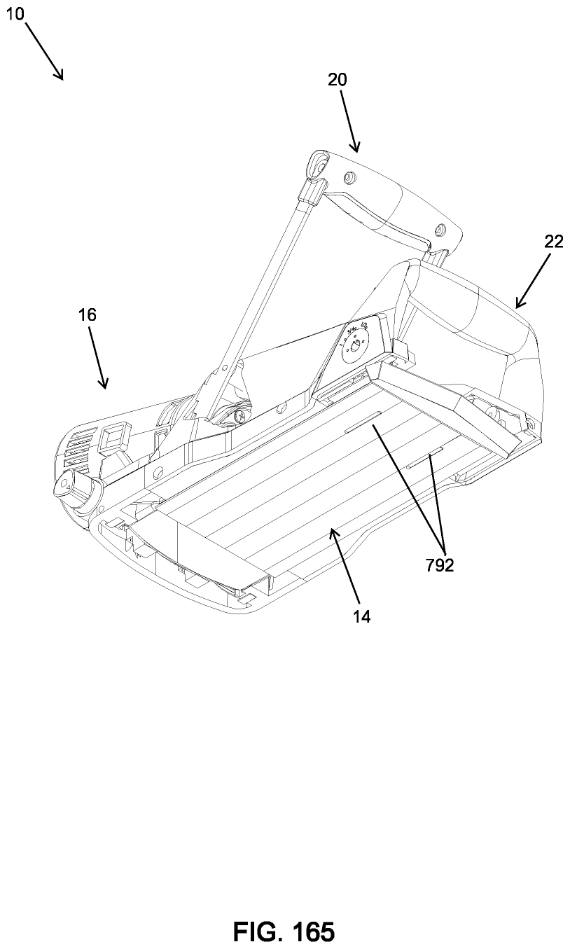

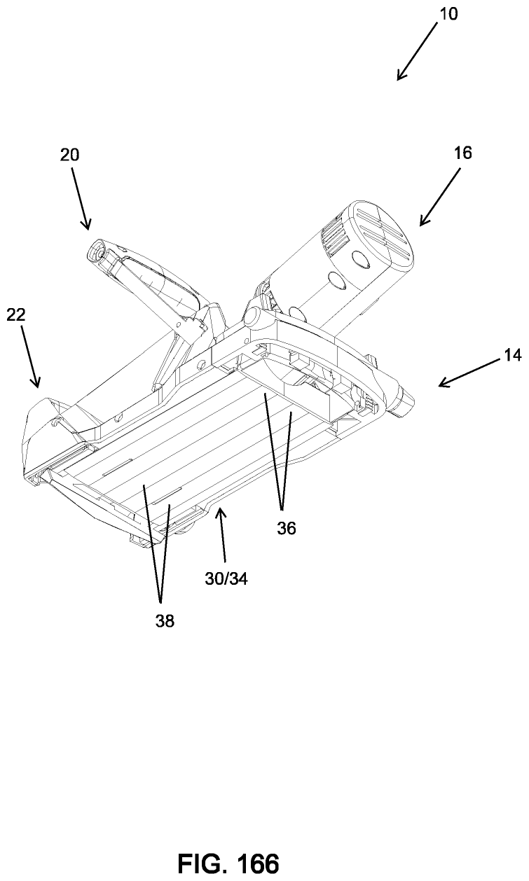

In the arrangements shown with reference to FIGS. 114-167, some example arrangements of system 10 are presented having another alternative adjustable lip assembly 24. The arrangements shown in FIGS. 114-167 are similar to the system 10 shown in FIGS. 1-113 and as such the disclosure related to the arrangements shown in FIGS. 1-113 applies to the arrangements shown in FIGS. 114-167 unless stated specifically herein. In one or more arrangements, adjustable lip assembly 24 has a sliding lip member 510, a set of guide members 512, a drill stop assembly 514, and a rear adjustment assembly 516 among other components.

### Sliding Lip Member 510:

Sliding lip member 510 is formed of any suitable size, shape, and design and is configured to provide a surface configured to engage a rearward edge for workpiece 12 to facilitate positioning system 10 to drill pocket holes at a proper distance from the rearward edge of workpiece 12. In the arrangement shown, sliding lip member 510 has an elongated shape having a front 520, a rear 522, a top 524, a bottom 526, and extending between opposing ends 528. In this example arrangement, rear 522 of sliding lip member 510 is angled forward from top 524 to bottom 526. In this example arrangement, rear 522 also angled forward from a center point to opposing ends 528.

### Guide Members 512:

Guide members 512 are formed of any suitable size, shape, and design and are configured to reposition sliding lip member 510 to various positions to facilitate drilling of pocket holes for workpieces 12 of different thicknesses. In the arrangement shown, as one example, guide members 512 each have a generally rectangular elongated shape having a top 536, a bottom 538, and sides 540 extending from a rearward end 542, where guide members 512 are connected to sliding lip member 510, to a forward end 544, where guide members 512 are connected to drill stop assembly 514.

### Drill Stop Assembly 514:

Drill stop assembly 514 is formed of any suitable size, shape, and design and is configured to set a lowest position that drilling assembly 16 can move along drill guide assembly 18 to set appropriate drilling depth for drilling pocket holes for different thicknesses of workpieces 12. In this example arrangement, drill stop assembly 514 includes a cross brace 550 and a pair of stop members 552. In this example arrangement, cross brace 550 includes a center portion 556 connected to forward ends 544 of guide members 512 by a pair of angled end portions 558. In this example arrangement, center portion 556 has an elongated L-shape extending between opposing ends 560. In this example arrangement, angled end portions 558 extend outward and downward from ends 560 of center portion 556 to forward ends 544 of guide members 512.

In this example arrangement, stop members 552 each have a generally straight portion 564 extending forward and upward at an angle from ends 560 of center portion 556 to a forward end 568. In this example arrangement, curved portion 566 extends forward and curved downward from forward end 568 to an outward end 570.

In this example arrangement, forward end 568 of drill stop assembly 514 is configured to engage collar assembly 74 when actuating assembly 20 moves drilling assembly 16 downward and forward along drill guide assembly 18 to set the lowest position that drilling assembly 16 is permitted to move and thereby set drilling depth. However, the embodiments are not so limited. Rather, it is contemplated that in some various arrangements, drill stop assembly 514 may be configured to engage various other components of or be operably connected to drilling assembly 16 to set a drilling depth.

### Rear Adjustment Assembly 516:

In the example arrangement shown, as one example, adjustable lip assembly 24 includes a rear adjustment assembly 516. Rear adjustment assembly 516 is formed of any suitable size, shape, and design and is configured to facilitate simultaneous adjustment of a position of sliding lip member 510 and drill stop assembly 514 of adjustable lip assembly 24 to configure system 10 for drilling pocket holes in workpieces 12 of various thicknesses.

In the arrangement shown, as one example, rear adjustment assembly 516 includes a knob 580 connected on a shaft 578, a pinion gear 582 connected to shaft 578, and a rack 584 operably connected to one of guide members 512 of adjustable lip assembly 24, among other components. In this example arrangement, rack 584 includes teeth formed on top 536 of guide members 512. In this example arrangement, pinion gear 582 has teeth positioned to engage teeth of rack 584. When knob 580 is rotated, shaft 578 and pinion gear 582 are rotated, which causes guide members 512 to move forward or rearward. Movement of guide members 512 forward or rearward causes sliding lip member 510 and drill stop assembly 514 to be moved forward or rearward to reposition sliding lip member 510 and drill stop assembly 514 for drilling pocket holes in workpieces 12 various thicknesses.

In the arrangement shown, knob 580 and sides 238 of main body 220 of rear handle assembly 22 include indica 588 indicating positions at which knob should be positioned for a plurality of different workpiece 12 thicknesses. In this example arrangement, indica 588 indicate positions for 1 inch, ¾ inch, and ½ inch thicknesses. However, the arrangements are not so limited. Rather, it is contemplated that in one or more arrangements, indica 588 may include marking for any number of different thicknesses.

In one or more arrangements, rear adjustment assembly 516 includes a lock assembly 590. Lock assembly 590 is formed of any suitable size, shape, and design and is configured to prevent rotation of shaft 578 when engaged. In this example arrangement, lock assembly 590 is a spring-loaded lock mechanism that prevents rotation of knob 580 and shaft 578 unless a user first presses knob 580 inward.

In this example arrangement, lock assembly 590 includes a cylindrical shaped tube member 594 positioned on shaft 578 with a feature 596 (not shown) configured to engage one or more features 598 (not shown) on an interior of a side 238 of main body 220 of rear handle assembly 22. In this example arrangement, feature 596 (not shown) is a protrusion configured to be received in recess type features 598 (not shown) when knob 580 is rotated to a position marked by indica 588. In this example arrangement, when knob 580 is moved into a marked position, lock assembly 590 is pushed outward by a spring 600 thereby moving protrusion feature 596 (not shown) into a recess feature 598 (not shown) and thereby locking rear adjustment assembly 516 in place.

### Front Support Assembly 608:

In one or more arrangements, system 10 may include a front support assembly 608. Front support assembly 608 is formed of any suitable size, shape, and design and is configured to support a front end of system 10, proximate to forward edge 44 of plate 30 in an elevated position above a worktable. Elevation of front end of system 10 may be useful, for example, when drilling pocket holes in narrow workpieces 12. When drilling pocket holes in narrow workpieces 12, it can be difficult to hold system 10 in a stable position with plate 30 flat again workpiece 12. In the arrangement shown, as one example, front support assembly 608 includes a pair of extendable support legs that can be moved downward to hold the front end of system 10 at a desired height so system 10 is correctly positioned on workpiece 12 for drilling of pocket holes. In this example arrangement, front support assembly 608 includes a housing 610, support legs 612, leg guides 614, and a forward adjustment assembly 616, among other components.

### Housing 610:

Housing 610 is formed of any suitable size, shape, and design and is configured to engage a forward edge 44 of plate 30 of base assembly 14 and house and interconnect support legs 612, leg guides 614, forward adjustment assembly 616 and/or other components of front support assembly 608. In the arrangement shown, housing 610 has a contoured semi-rectangular shape having a front 622, a back 624, opposing sides 626, and a top 628. In this example arrangement, front 622, back 624, opposing sides 626, and top 628 form a hollow interior configured to house components of front support assembly 608.

In various different arrangements, housing 610 may be connected to base assembly 14 in various different ways. In the arrangement shown, housing 610 is connected to plate 30 of base assembly 14 by fasteners (e.g., bolts) that extend through holes 634 in housing 610 and connect to base assembly 14. However, the embodiments are not so limited. Rather, it is contemplated that rear handle assembly 22 may be connected to base assembly 14 using any means and methods known in the art including but not limited to, for example, adhesive bonding, chemical bonding, welding, and/or mechanical attachment means such as screws, bolts, threading, interlocks, clips, pins, or other coupling devices.

### Support Legs 612:

Support legs 612 are formed of any suitable size, shape, and design and are configured to move between an extended position and a retracted position and facilitate support of system at an elevated position. In the arrangement shown, as one example, support legs 612 each have an elongated generally rectangular shape having a front 648, back 650, and opposing sides 652 extending from an upper end 654 to a lower end 656. In this example arrangement, front of support legs 612 includes teeth, which form a rack 666 of forward adjustment assembly 616 and which facilitate extending and retracting of support legs 612.

### Leg Guides 614:

Leg guides 614 are formed of any suitable size, shape, and design and are configured to facilitate movement of support legs 612 between the extended and retracted positions. In the arrangement shown, as one example, leg guides 614 are rectangular vertical channels formed within housing 610.

### Forward Adjustment Assembly 616:

Forward adjustment assembly 616 is formed of any suitable size, shape, and design and is configured to facilitate movement of support legs 612 between the extended and retracted positions to adjust elevation of the front end of system 10.

In the arrangement shown, as one example, forward adjustment assembly 616 includes a shaft 662, a knob 660 connected on shaft 662, pinion gears 664 connected to shaft 662, and racks 666 connected to support legs 612, among other components. In this example arrangement, racks 666 each include teeth formed on front of guide members 512. In this example arrangement, pinion gear 664 has teeth positioned to engage teeth of rack 666 formed on front 648 of support legs 612. When knob 660 is rotated, shaft 662 and pinion gears 664 are rotated, which causes support legs 612 to move downward to extend support legs 612 or upward to retract support legs 612.

In one or more arrangements, knob 660 and side 626 of housing 610 include indica 632 (not shown) indicating positions at which knob should be positioned for elevation of front end of system to facilitate cutting of workpieces 12 of various different thicknesses. In this example arrangement, indica 632 indicate positions for 1 inch, ¾ inch, and ½ inch thicknesses. However, the arrangements are not so limited. Rather, it is contemplated that in one or more arrangements, indica 632 may include marking for any number of different thicknesses.

In one or more arrangements, forward adjustment assembly 616 includes a lock assembly 670. Lock assembly 670 is formed of any suitable size, shape, and design and is configured to prevent rotation of shaft 662 when engaged. In this example arrangement, lock assembly 670 is a spring-loaded lock mechanism that prevents rotation of knob 660 and shaft 662 unless a user first presses knob 660 inward.

In this example arrangement, lock assembly 670 includes a stationary gear member 672 positioned adjacent to one of the pinion gears 664 of forward adjustment assembly 616. In this example arrangement, stationary gear member 672 has a set of teeth configured to receive and engage teeth of the pinion gear 664 when shaft 662 is moved to the left by a spring 674 (not shown). While teeth of pinion gear 664 are engaged by teeth of stationary gear member 672, shaft 662, pinion gears 664, and knob 660 are prevented from rotating, thereby locking support legs 612 in position. To extend or retract support legs 612, knob 660 must be pushed inward to move shaft 662 and pinion gears 664 rightward until teeth of the pinion gear 664 disengage from stationary gear member 672. With knob 660 pushed inward a user may rotate knob 660 to move support legs 612 to the desired position. Once support legs 612 are moved to the desired position a user may allow knob 660 to move outward to the left so teeth of pinion gear 664 are engaged by teeth of stationary gear member 672, thereby locking support legs 612 in position

### Retractable Guides 790:

In one or more arrangements, system 10 includes one or more retractable guides 790. Retractable guides 790 are formed of any suitable size, shape, and design and are configured to facilitate positioning of system 10 on a workpiece 12. In the arrangement shown, as one example, retractable guides 790 includes guide members 794 positioned in slotted openings 792 of plate 30 and buttons 796 operably connected to guide members 794 among other components.

### Guide Members 794:

Guide members 794 are formed of any suitable size, shape, and design and are configured to be optionally moved outward from a retracted position in plate 30 of base assembly 14 through slotted openings 792 to an extended position. In the arrangement shown, as one example, guide members 794 each include a tab 800 and a connection arm 802 extending upward from tab 800.

Tabs 800 are formed of any suitable size, shape, and design and are configured to, when guide members 794 are moved to the extended position, extend through slotted openings 792 and engage workpiece 12 to facilitate positioning of system 10 on workpiece 12. In this example arrangement, tabs 800 each have a generally rectangular planar shape extending from an upper edge 806, a lower edge 808, a front edge 810, and a rear edge 812.

Connection arms 802 are formed of any suitable size, shape, and design and are configured to operably connect tabs 800 with buttons 796. In this example arrangement, connection arms 802 have an elongated meandering shape having a lower portion 818, a center portion 820, and an upper portion 822. In this example arrangement, lower portion 818 has an elongated shape extending upward from a lower end 826, connected to upper edge 806 of tabs 800, to an upper end 828. In this example arrangement, upper portion 822 has an elongated shape extending downward from an upper end 830 to a lower end 832. In this example arrangement, center portion 820, has an elongated shape extending horizontally between upper end 828 of lower portion 818 and lower end 832 of upper portion 822.

### Buttons 796:

Buttons 796 are formed of any suitable size, shape, and design and are each configured to permit a user to move a respective guide member 794 between the extended position and retracted position. In this example arrangement, as one example, buttons 796 have a semi-rectangular shape positioned in openings 842 in an upper surface 840 of a cover 838. In this example arrangement, upper end 830 of upper portion 822 of connection arms 802 are connected to a lower surface (not shown) of buttons 796.

In one or more arrangements, the buttons 796 are momentary push type buttons configured to move guide members 794 from the retracted position to the extended position when buttons 796 are depressed and move the guide members 794 from the extended position to the retracted position when they are released. However, the embodiments are not so limited. Rather, it is contemplated that various arrangements may utilize various types of buttons including but not limited to, for example: momentary buttons, maintained buttons, latching buttons, toggle buttons, push buttons, rotary buttons, pull chains, slider buttons, rocker buttons, switch buttons, lever buttons or any other type of button or means for actuating guide members 794 between the extended and retracted positions.

In operation, a user may engage buttons 796 to move guide members 794 between an extended or a retracted position to facilitate easier positioning of system 10 on a workpiece 12. For example, a user may utilize retractable guide(s) 790 to position system 10 for drilling pocket hole at a set distance from a side edge of workpiece 12.

As an illustrative example, operation of retractable guides 790 having maintained type buttons is described. If use of a retractable guide 790 is desired, a user may press the button 796 for the desired retractable guide 790 to move and hold the retractable guide 790 in the extended position. With the retractable guide 790 in the extendable position, system 10 may be positioned with plate 30 of base assembly 14 on top of workpiece 12. System 10 may then be moved horizontally until retractable guide 790 engages a side edge of workpiece 12 and lip assembly 24 engages a rear edge of workpiece 12. With system 10 in position, a pocket hole may then be drilled in the set position as described herein. When retractable guide 790 is no longer required, the user may again press the corresponding button 796 to move the retractable guide 790 to the retracted position.

### Positioning of Retractable Guides 790:

In some various different arrangements, retractable guides 790 may be configured to extend downward from various positions along lower surface 40 of plate 30 to facilitate alignment of system 10 on workpiece 12 for drilling of pocket holes. For example, in one or more arrangements, retractable guides 790 are positioned and configured to facilitate drilling of pairs of pocket holes on the end of a workpiece 12 at equal distances from side edges of the workpiece 12. For example, in one or more arrangements shown, tabs 800 of retractable guides 790 are positioned proximate to rearward edge 46 of plate 30. In this example arrangement, tabs 800 of retractable guides 790 have an elongated rectangular shape extending along a forward/rearward direction parallel to side edges 48 of plate 30.

As an illustrative example, in one or more arrangements, a user may use buttons 796 to extend a pair of retractable guides 790 (independently or together) to facilitate drilling a pair of pocket holes on an end of a narrow workpiece 12. This is often performed when drilling pocket holes in the end of elongated rails. In this example arrangement, it is desirable to place two equally spaced pocket holes in the ends of the elongated rail. For instance, a user may line up a first retractable guide 790 on one side edge of the workpiece 12 to drill a first pocket hole a distance from a right edge, and then line up a second retractable guide 790 on the opposite side edge of the workpiece 12 to drill a second pocket hole the same distance from a left edge.

Although some arrangements may be primarily described with reference to a system 10 having two retractable guides 790 positioned near the rear end of plate 30 for drilling equidistant pocket holes, the embodiment are not so limited. Rather, it is contemplated that in one or more arrangements, system may have any number of retractable guides 790. It is further contemplated that in some various arrangements such retractable guides 790 may be configured to be extended together (e.g., by engagement of a single button 796) or may be configured to be extended independently (e.g., by engagement of respective buttons 796). It is further contemplated that in some various arrangements retractable guides 790 may additionally or alternatively be positioned at any other position along plate 30 to facilitate alignment of system 10 with workpiece 12 for drilling of pocket holes at various positions and/or distances from side edges.

### Alignment Window 690:

In one or more arrangements, system 10 includes an alignment window 690. Alignment window 690 is formed of any suitable size, shape, and design, and is configured to facilitate positioning of system 10 for drilling a pocket hole at a desired location on workpiece 12. In the arrangement shown, as one example, alignment window 690 includes a cutout in rearward edge 46 of plate 30 to provide a view of an edge of the workpiece 12 while the workpiece 12 is positioned under system 10 for drilling. In this example arrangement, alignment window includes an indicator 694 aligned with drill bit 58 and indicating the position at which a pocket hole will be formed. In operation, a user may position system 10 on workpiece 12 so that a measurement mark on workpiece 12 (e.g., a pencil mark) is visible in alignment window 690 and is aligned with indicator 694.

Indicator 694 may be formed of any suitable size, shape, and design, and is configured to indicate a lateral position at which a pocket hole will be drilled. In the arrangement shown, as one example indicator 694 is formed by drill bit guide 106 of guide block 88. However, the embodiments are not so limited. Rather, it is contemplated that indicator 694 may be formed of any structure or marking including but not limited to, for example, markings (e.g., arrows, lines, and/or any other marking), engravings, recesses, protrusions, notches, blades, posts, dovetails, rings, recitals, laser or light projection, or any other type of indicator.

### Alternative Arrangement:

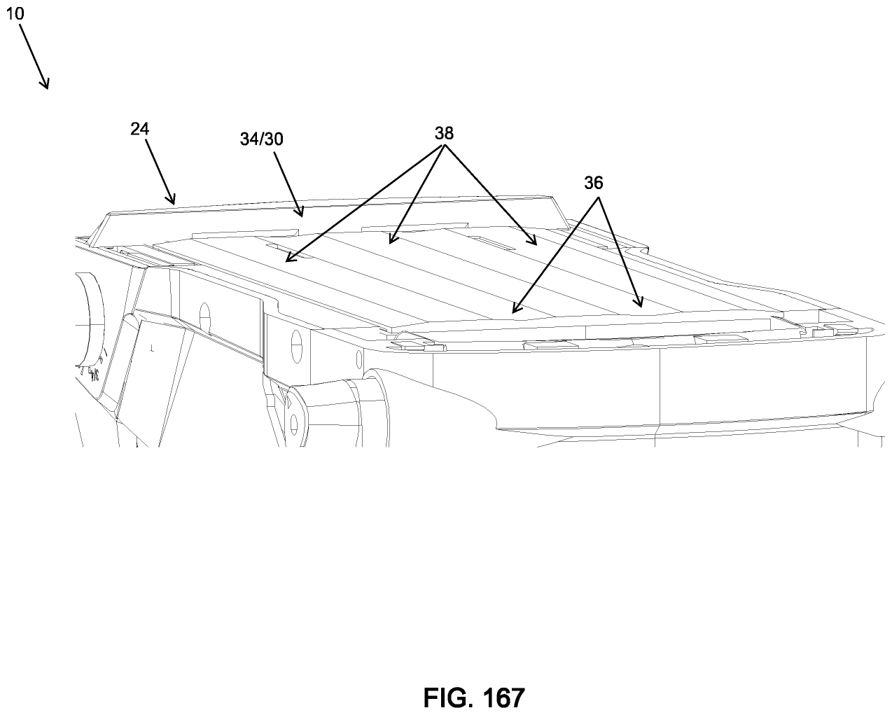

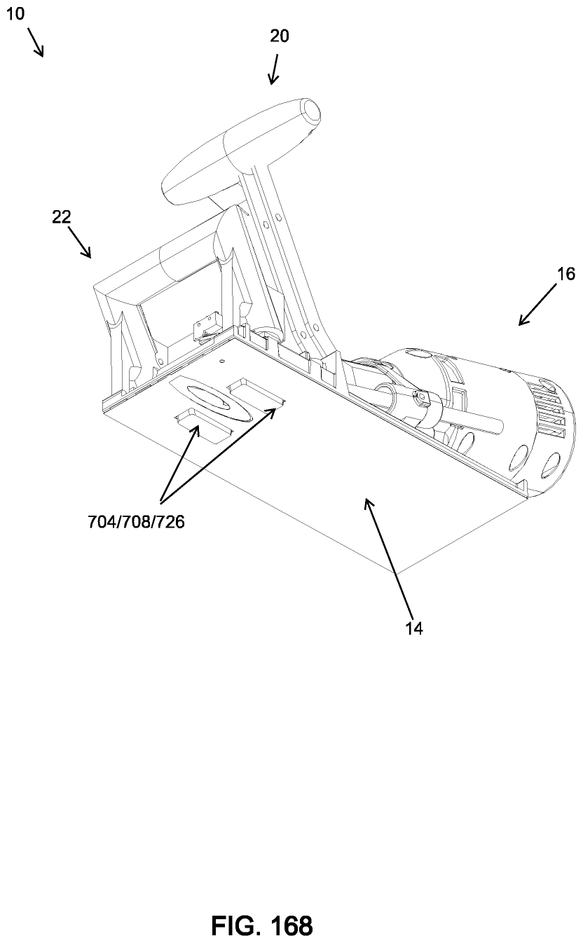

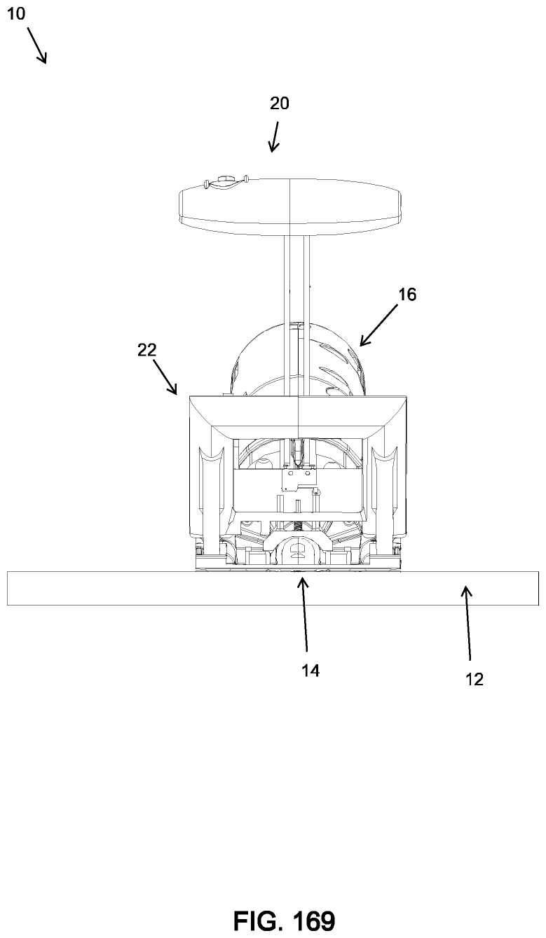

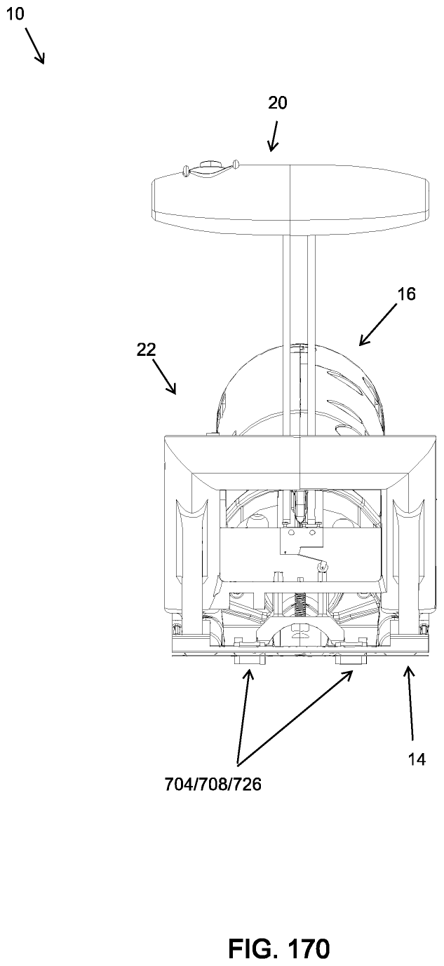

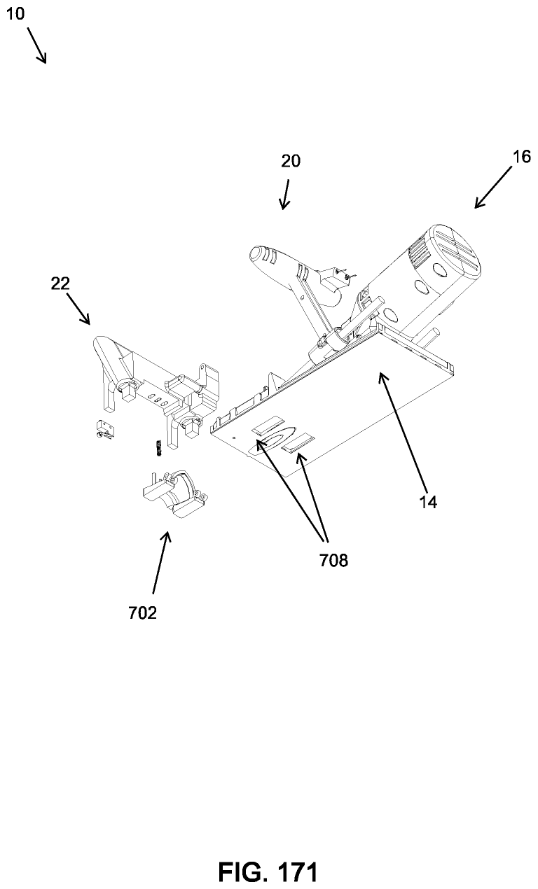

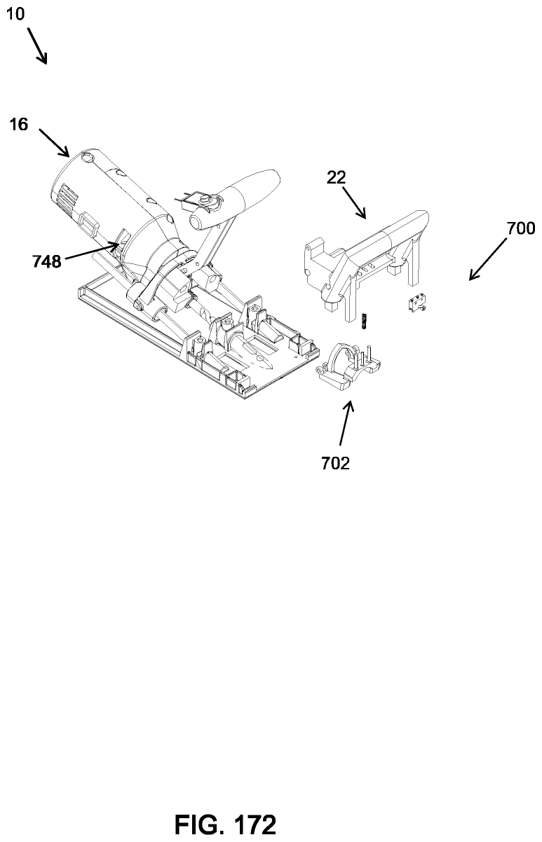

In the arrangements shown with reference to FIGS. 168-173, some example arrangements of system 10 are presented having a safety interlock system positioned on plate 30. The arrangements shown in FIGS. 168-173 are similar to the system 10 shown in FIGS. 1-167 and as such the disclosure related to the arrangements shown in FIGS. 1-167 applies to the arrangements shown in FIGS. 168-173 unless stated specifically herein.

### Safety Interlock System 700:

Safety interlock system 700 is formed of any suitable size, shape, and design and is configured to disable operation of system 10 unless plate 30 is placed on top of workpiece 12 with sufficient pressure. In this manner, injury may be avoided by accidental engaging of drill motor 70 when system 10 is not in position for drilling a pocket hole and system 10 is not held firmly in place with sufficient downward pressure.

### Switch Assembly 702:

In the arrangement shown, as one example, safety interlock system 700 includes a switch assembly 702 having a set of buttons 704 positioned in openings 708 of plate 30 of base assembly 14 and a switch 706 among other components. Switch assembly 702 is formed of any suitable size, shape, and design and is configured to engage switch 706 when buttons 704 are moved upward into opening 708 when system 10 is placed on an upper surface of a workpiece 12. In the arrangement shown, as one example, switch assembly 702 includes a pair of buttons 704, a connector 710 positioned at a forward end of buttons 704, a front cross member 712, and a rear cross member 714, among other components.

### Buttons 704:

Buttons 704 are formed of any suitable size, shape, and design and are configured to extend through openings 708 of plate 30 and move switch assembly 702 upward. In the arrangement shown, as one example, buttons 704 have a generally rectangular shape having a top surface 720, a bottom surface 722 extending between a forward end 724, a rearward end 726, and opposing sides 728. In this example arrangement, buttons 704 are slightly tapered with the thickness of buttons increasing as buttons extend rearward from forward end 724 to rearward end 726.

### Connector 710:

Connector 710 is formed of any suitable size, shape, and design and is configured to operably connect switch assembly 702 with plate 30 of base assembly 14 and facilitate movement of switch assembly 702 between a retracted position, in which buttons 704 are pressed into openings 708, and an extended position, in which buttons 704 extend outward through openings 708. In the arrangement shown, as one example, connector 710 is a hinged-type connector providing a hinged connection between a forward end 724 of buttons 704 and plate 30 of base assembly 14. However, the embodiments are not so limited. Rather, it is contemplated that connector 710 may be implemented using various types of connectors including but not limited to, for example, hinged connectors, sliding connectors, geared connectors, or any other method of means for operably connecting components.

### Front Cross Member 712 and Rear Cross Member 714:

Front cross member 712 is formed of any suitable size, shape, and design and is configured to operably connect forward ends 724 of buttons 704 without obstructing operation of system 10. In the arrangement shown, as one example, front cross member 712 has a general arch shape curving upward and inward from forward ends 724 of buttons 704 to a center point.

Rear cross member 714 is formed of any suitable size, shape, and design and is configured to operably connect rearward ends 726 of buttons 704 and engage switch 706 when buttons 704 are pressed upward and switch assembly 702 is moved to the retracted position. In the arrangement shown, as one example, rear cross member 714 has a general arch shape curving upward and inward from rearward ends 726 of buttons 704. In this example arrangement, rear cross member 714 includes a set of posts 732 and 734 extending upward from an upper surface 736 of rear cross member 714. In this example arrangement, a first post 732 is configured to engage switch 706 when buttons 704 are pressed upward and switch assembly 702 is moved to the retracted position. In this example arrangement, a spring 738 is positioned on a second post 734 and is configured to move switch assembly 702 downward to the extended position in absence of an opposing force.

### Switch 706:

Switch 706 is formed of any suitable size, shape, and design and is configured to disable operation of drill motor 70 when switch 706 is not engaged by switch assembly 702 and enable operation of drill motor 70 when switch 706 is engaged by switch assembly 702. In the arrangement shown, switch 706 is a microswitch type switch connected to form a closed circuit when switch 706 is engaged. For example, in one or more arrangements, switch 706 may be connected in series with switch 156 of actuating assembly 20 and/or safety switch 160. However, the embodiments are not so limited. Rather, it is contemplated that in one or more arrangements, switch 706 may be any type of switch connected in any circuit arrangement configured to disable operation when switch assembly 702 is in the extended position.

### Alternative Arrangement:

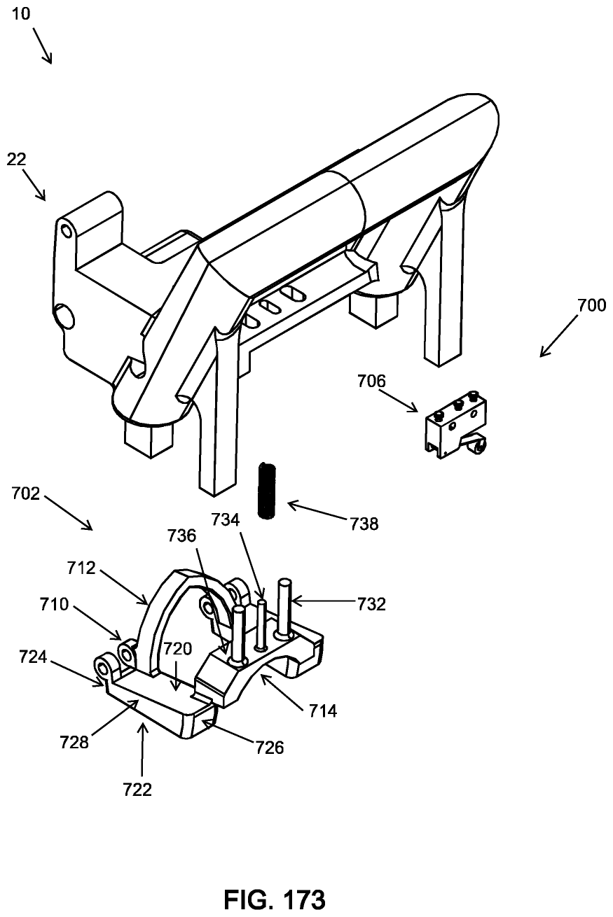

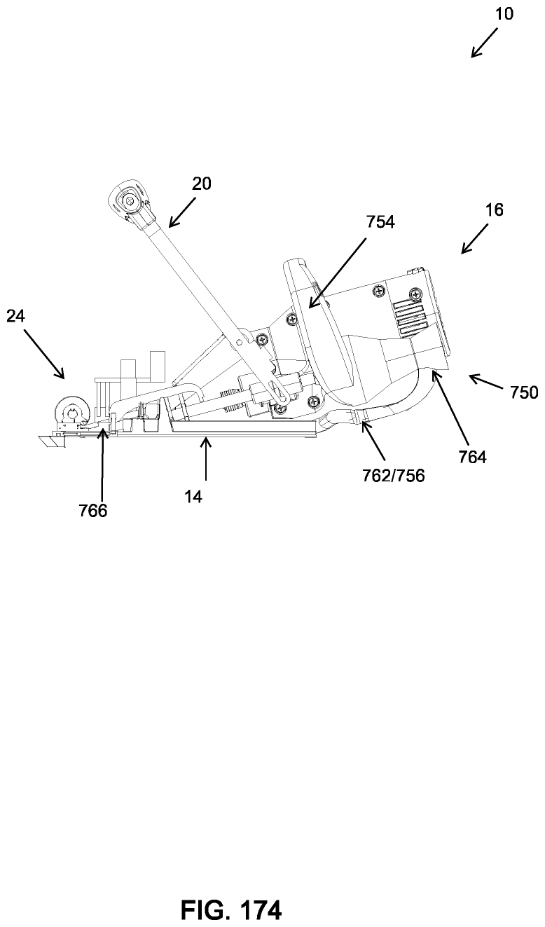

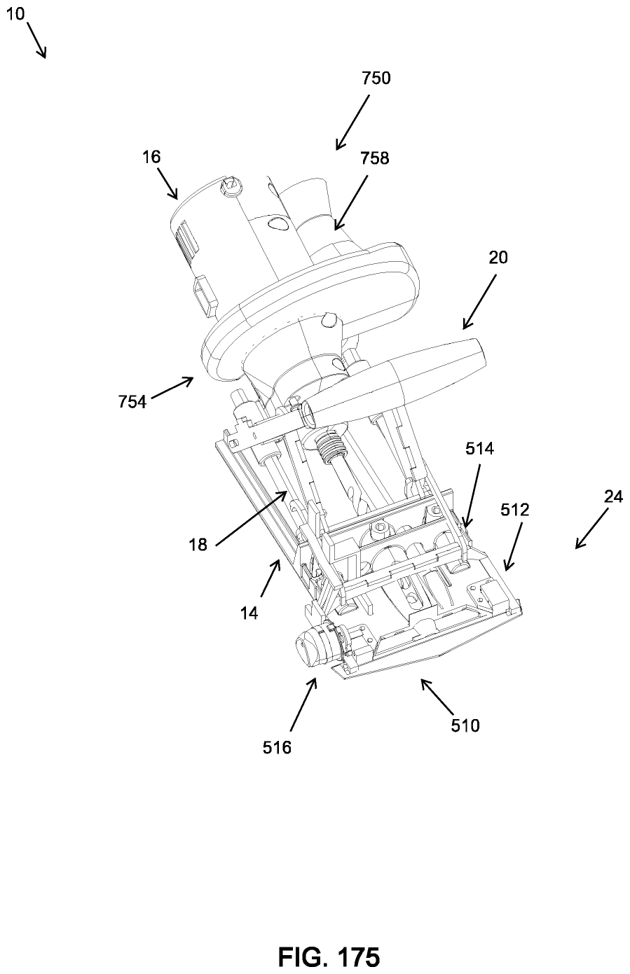

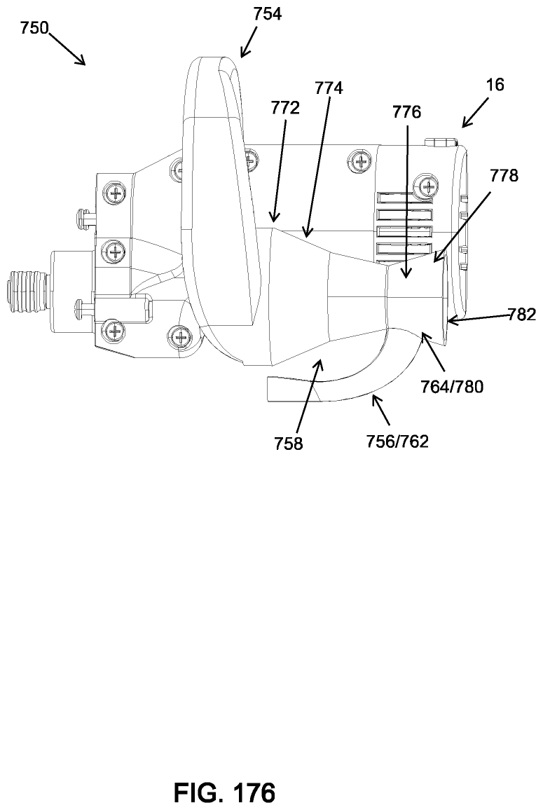

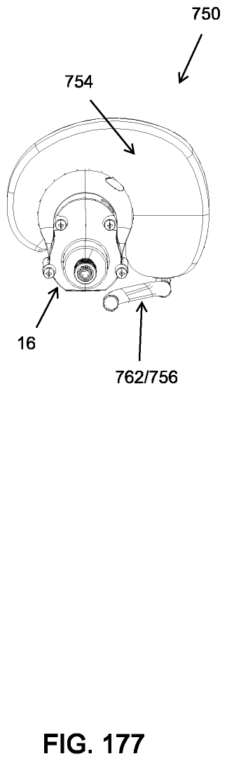

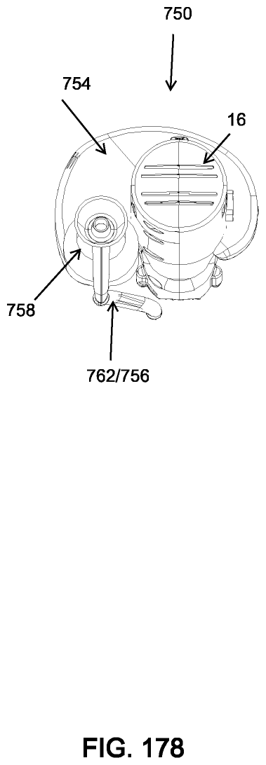

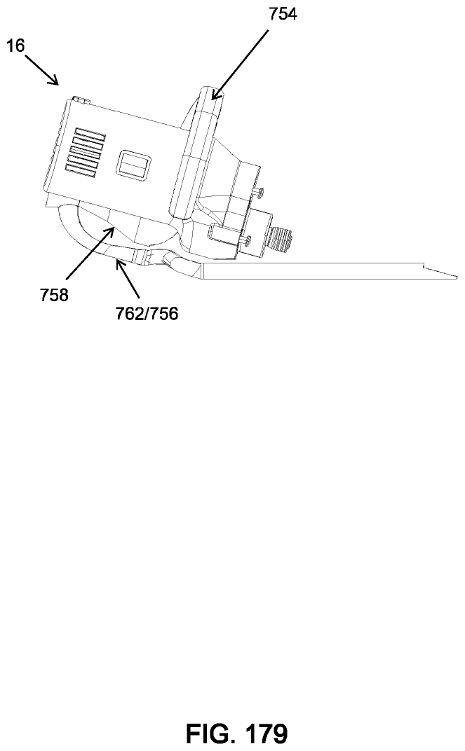

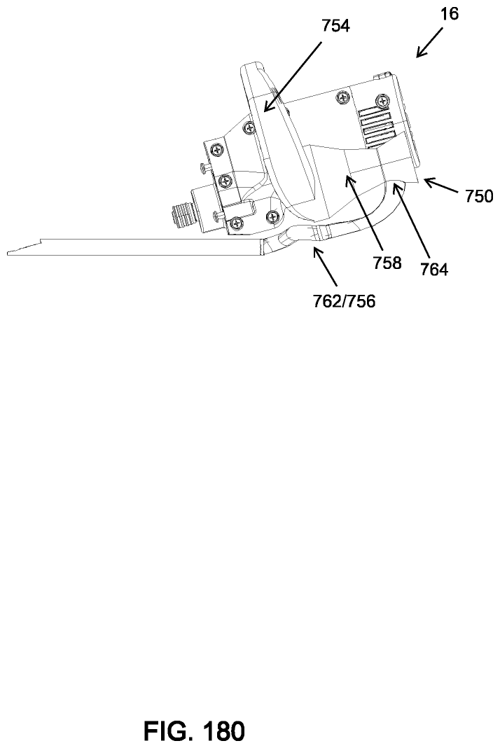

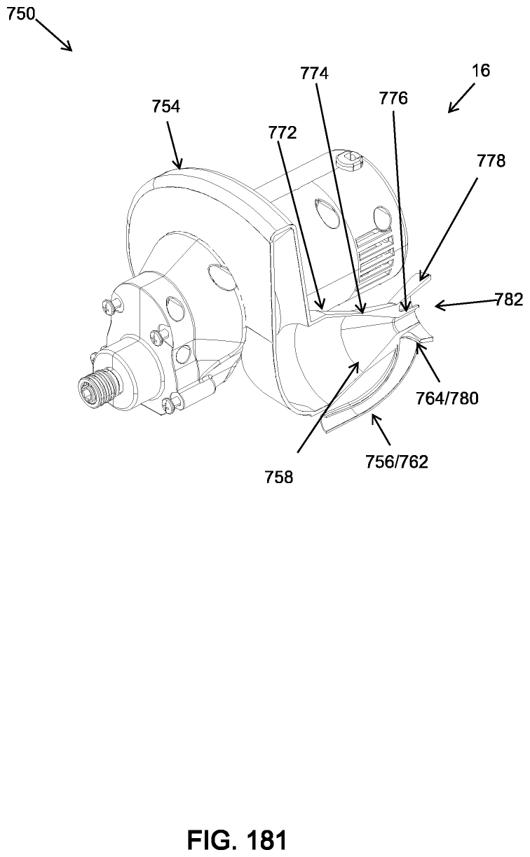

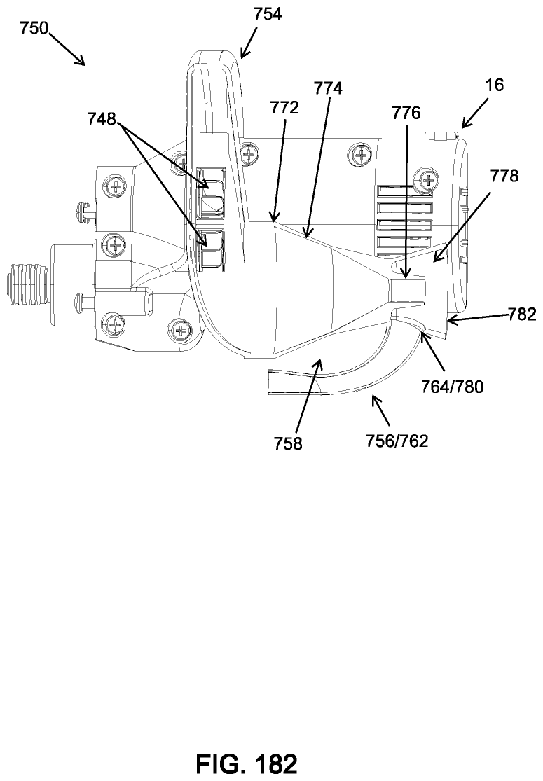

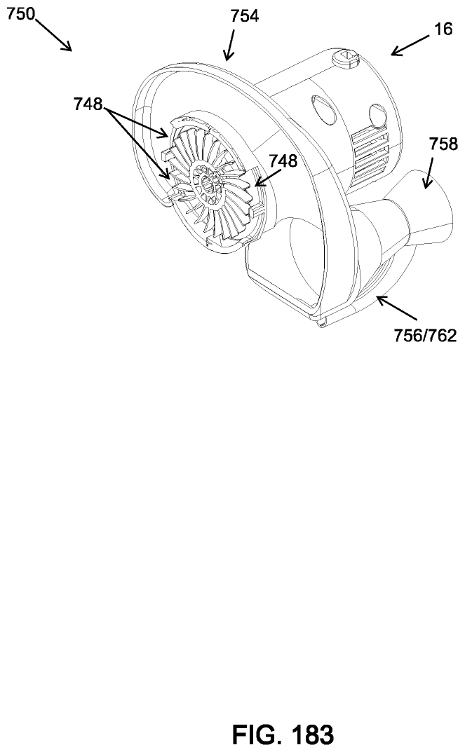

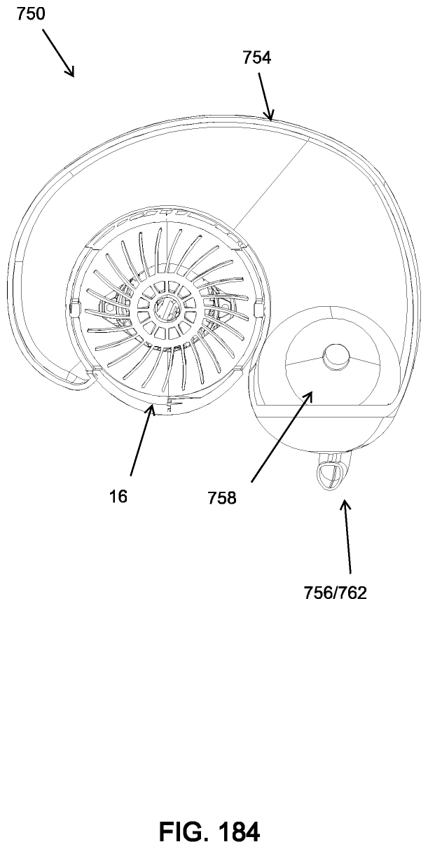

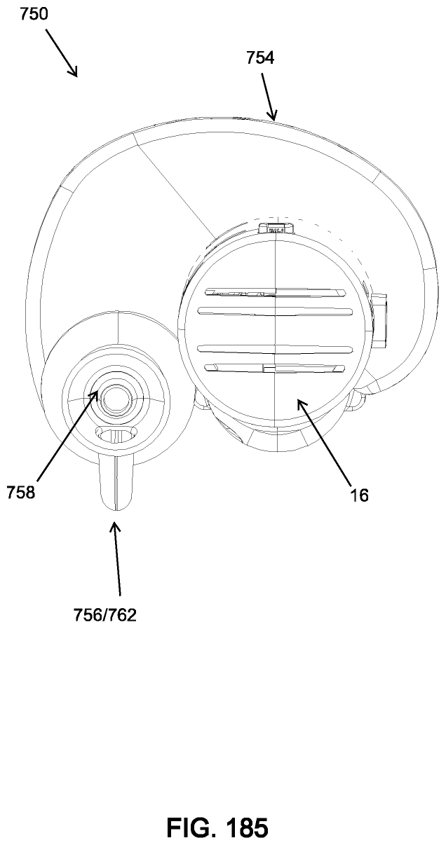

In the arrangements shown with reference to FIGS. 174-185, some example arrangements of system 10 are presented having a dust collection system 750. The arrangement shown in FIGS. 174-185 are similar to the system 10 shown in FIGS. 1-173 and as such the disclosure related to the arrangements shown in FIGS. 1-173 applies to the arrangements shown in FIGS. 174-185 unless stated specifically herein.

### Dust Collection System 750:

Dust collection system 750 is formed of any suitable size, shape, and design and is configured to collect dust and/or wood shavings generated from drilling of pocket holes using system 10. In the arrangement shown, as one example, dust collection system is configured to transport dust and/or wood shavings for collection using an airflow generated by a cooling fan of drill motor 70.

In this example arrangement, dust collection system 750 includes a dust collector 752 (not shown), a first airflow path 754 from fan outlets 748 of drill motor 70 to dust collector 752, a second airflow path 756 from drill bit opening 50 to dust collector 752, and a venturi tube 758 among other components.

In the arrangement shown, the first airflow path 754 and second airflow path 756 intersect and are combined together by a venturi tube 758. In this example arrangement, as airflow generated by the cooling fan in the first airflow path 754 passes through the Venturi tube 758, a pressure drop is created in the second airflow path 756. The pressure drop in the second airflow path 756 causes air and dust and/or shavings to be sucked from drill bit opening 50 through the second airflow path 756, to the dust collector 752. This arrangement allows dust to be collected without requiring additional fans and/or motors to induce airflow.

### First Airflow Path 754:

Frist airflow path 754 is formed of any suitable size, shape, and design and is configured to transport air output from fan outlets 748 of drill motor 70 through venturi tube 758 and to dust collector 752. In the arrangement shown, as one example, first airflow path 754 includes a squirrel cage shaped housing configured to direct air output from fan outlets 748 of drill motor 70 to a high-pressure inlet 772 of venturi tube 758.

### Second Airflow Path 756:

Second airflow path 756 is formed of any suitable size, shape, and design and is configured to transport air output from drill bit opening 50 through venturi tube 758 and to dust collector 752. In the arrangement shown, as one example, second airflow path 756 is a meandering cylindrical tube 762 extending from a first end 764 connected to low pressure inlet 780 of Venturi tube 758 to a second end located near drill bit opening 50. In this example arrangement, tube 762 extends downward from a high-pressure inlet of Venturi tube 758 and rearward along plate 30 to the area proximate to drill bit opening 50. However, the embodiments are not so limited. Rather, it is contemplated that in some various arrangements, second airflow path 756 may be configured to transport air along any number of alternate routes.

### Venturi Tube 758:

Venturi tube 758 is formed of any suitable size, shape, and design and is configured to induce airflow from drill bit opening 50 through Venturi tube 758 and to dust collector 752 when air of the first airflow path 754 passes through Venturi tube 758. In this example, Venturi tube 758 includes a high-pressure inlet 772, a convergent section 774, a throat section 776, a divergent section 778, a lower pressure inlet 780, and an outlet 782.

In this example arrangement, air from the first airflow path 754 flows into high pressure inlet 772, through convergent section 774, where the pathway narrows and velocity of the airflow is increased, through throat section 776, and through divergent section 778, where the pathway widens and higher velocity creates a pressure drop, to outlet 782. In the arrangement shown, Venturi tube 758 has a lower pressure inlet 780 positioned in the divergent section 778. Due to the pressure drop in divergent section 778, air is sucked from second airflow path 756 into lower pressure inlet 780 along with any dust and shavings.

Although the arrangement shown has low pressure inlet 780 positioned in divergent section 778 of Venturi tube 758, the arrangements are not so limited. Rather, it is contemplated that in one or more arrangements, Venturi tube 758 may have a low pressure inlet 780 positioned in throat section 776 or at another position of Venturi tube 758.

### Dust Collector 752:

Dust collector 752 is formed of any suitable size, shape, and design and is configured to receive and hold dust and shavings transported by second airflow path 756. In some various example arrangements, dust collector 752 may be implemented using various means and methods for removing and/or collecting dust from an airflow but not limited to, for example, filters (e.g., a dust bag or vacuum bag), centrifugal separators, and/or any other method of means for separating and/or collecting dust and debris.

From the above discussion it will be appreciated that the disclosed system 10 and method improves upon the state of the art. That is, in one or more arrangements, a handheld powered pocket hole drilling system 10 and method of use is presented: that is easy to use; that is fast and efficient to use; that is portable; that is light weight; that is handheld; that is cost effective; that forms accurate pocket holes; that is safe to use; that has a durable design; that has a long useful life; that provides additional functionality for pocket hole jigs and pocket hole joinery; that has a wide variety of uses; that has a wide variety of applications; that prevents or reduces relative movement between the pocket hole jig and the workpiece 12; that avoids the need to clamp to the system 10 to a workpiece 12; that facilitates the formation of aesthetically pleasing finished products; that forms a pocket hole with a single movement of a handle; that facilitates stable placement when used horizontally; that facilitates stable placement when used vertically; that facilitates easy removal of chips and debris during use; that is comfortable to use; that is more stable than other pocket hole jigs; that improves the ergonomics of use; and/or that easily adjusts to workpieces of various thicknesses among countless other advantages, improvements and features.

It will be appreciated by those skilled in the art that other various modifications could be made to the device without parting from the spirit and scope of this invention. All such modifications and changes fall within the scope of the claims and are intended to be covered thereby.

What is claimed is:

1. A handheld powered pocket hole drilling system, comprising:
a base assembly;
the base assembly extending between a front end and a rear end;
the base assembly having a plate;
the plate having a drill bit opening extending through the plate;
a lip operably connected to the plate;
a drilling assembly;
a drill bit connected to the drilling assembly;
a drill guide assembly;
the drill guide assembly operably connected to the base assembly and the drilling assembly;
wherein the drilling assembly is movable along the drill guide assembly between an extended position and a retracted position to extend and retract the drill bit through the drill bit opening at an angle;
an actuating assembly operably connected to the drilling assembly;
wherein the actuating assembly includes a first handle;
wherein when the first handle is moved away from the lip, the actuating assembly moves the drilling assembly toward the lip to the extended position;
wherein when the first handle is moved toward the lip, the actuating assembly moves the drilling assembly away from the lip to the retraced position;
wherein when a lower surface of the plate is placed on a first surface of a workpiece with the lip placed against an edge of the workpiece, the drill bit is positioned to drill a pocket hole in the workpiece when the drilling assembly is moved to the extended position;
wherein when the first handle is moved away from the lip, the actuating assembly is configured and arranged to transfer a downward force to the base assembly, thereby increasing frictional forces between the plate and the workpiece.

2. The system of claim 1, wherein when the first handle is moved away from the lip, the actuating assembly is configured and arranged to transfer a lateral force to the lip, thereby increasing frictional forces between the lip and the workpiece.

3. The system of claim 1, wherein the frictional force between the plate and the workpiece holds the plate in place on the workpiece while drilling the pocket hole without clamping the plate to the workpiece.

4. The system of claim 1, wherein when the first handle is moved away from the lip, the actuating assembly is configured and arranged to transfer a lateral force to the lip, thereby increasing frictional forces between the lip and the workpiece;
wherein the frictional forces between the lip and the workpiece and the frictional forces between the plate and the workpiece hold the plate in place on the workpiece while drilling the pocket hole without clamping the plate to the workpiece.

5. The system of claim 1, wherein drill guide assembly includes:
a guide block operably connected to the base assembly;
one or more guide rods operably connected to the guide block;
wherein the one or more guide rods are oriented at the angle with respect to the plate.

6. The system of claim 1, wherein the drill guide assembly includes a pair of guide rods operably connected to the base assembly at the angle;
wherein the drilling assembly includes a pair of alignment guides; and
wherein the alignment guides are operably connected to the pair of guide rods and are configured to guide the drilling assembly along the alignment guides between the extended position and the retracted position.

7. The system of claim 1, further comprising a second handle operably connected to the base assembly.

8. The system of claim 1, further comprising one or more grip pads positioned on a lower surface of the plate;
wherein the plate is formed of a material having a lower coefficient of friction; and
wherein the one or more grip pads are formed of a material having a higher coefficient of friction.

9. The system of claim 1, wherein the drilling assembly includes a drill motor and a chuck operably connected to the drill bit.

10. The system of claim 1, wherein the actuating assembly includes a lever;
wherein the lever operably connects the first handle to the drilling assembly;
wherein the first handle is movable between a first position and a second position;
wherein, when the first handle is moved to the first position the lever moves the drill guide assembly to the retracted position;
wherein, when the first handle is moved to the second position the lever moves the drill guide assembly to the extended position.

11. The system of claim 1, wherein the system includes a bias member configured to move the drilling assembly from the extended position to the retracted position in absence of an opposing force on the first handle.

12. The system of claim 1, wherein the base assembly, the drilling assembly, the drill guide assembly, and the actuating assembly are positioned on the same side of the workpiece when the lower surface of the plate is placed on the first surface of the workpiece with the lip placed against the edge of the workpiece.

13. The system of claim 1, further comprising:
a drill stop operatively connected to the base assembly;
an adjustment member;
wherein the adjustment member simultaneously adjusts the positions of the lip and the drill stop to facilitate drilling of pocket holes for workpieces of different thicknesses.

14. The system of claim 1, further comprising a window in the base assembly;
wherein when the base assembly is placed on a workpiece, the window allows a user to see an area around where the drill bit enters the workpiece.

15. The system of claim 1, further comprising a window in the base assembly;
wherein the base assembly includes one or more indicators proximate to the window;
wherein when the base assembly is placed on a workpiece, the window allows a user to see an area around where the drill bit enters the workpiece and the one or more indicators facilitate positioning of the base assembly for drilling of a pocket hole in an intended location.

16. The system of claim 1, a front support assembly configured to support the front end of the base assembly in an elevated position above a worktable.

17. The system of claim 1, a front support assembly configured to support the front end of the base assembly in an elevated position above a worktable;
wherein the front support assembly includes a pair of retractable support legs configured to be moved between a retracted position and an extended position.

18. The system of claim 1, further comprising one or more retractable guides are configured to extend downward from a lower surface of base assembly to an extended position to facilitate positioning of a narrow workpiece under the lower surface of the base assembly.

19. The system of claim 1, further comprising a switch;
the switch operatively connected to the base assembly and the drilling assembly;
wherein the switch disables operation of the drilling assembly when the switch is disengaged from a workpiece so as to prevent errant operation of the drilling assembly.

20. A handheld powered pocket hole drilling system, comprising:
a base assembly;
the base assembly having a plate;
the plate having a drill bit opening extending through the plate;
a lip operably connected to the plate;
a drilling assembly;
a drill bit connected to the drilling assembly;
a drill guide assembly;
the drill guide assembly operably connected to the base assembly and the drilling assembly;
wherein the drilling assembly is movable along the drill guide assembly to extend and retract the drill bit through the drill bit opening at an angle;
an actuating assembly operably connected to the drilling assembly;
wherein the actuating assembly includes a lever and a first handle;
wherein the powered pocket hole jig system is configured to drill a pocket hole in a workpiece when a lower surface of the plate is placed on an upper surface of a workpiece while a forward surface of the lip is placed on a rearward edge of the workpiece without clamping the powered pocket hole jig system engaging a lower surface of the workpiece which is opposite the upper surface of the workpiece.

21. The system of claim 20, wherein when the first handle is moved away from the lip, the actuating assembly is configured and arranged to transfer a downward force to the base assembly, thereby increasing frictional forces between the plate and the workpiece;
wherein when the first handle is moved away from the lip, the actuating assembly is configured and arranged to transfer a lateral force to the lip, thereby increasing frictional forces between the lip and the workpiece;
wherein the frictional forces between the lip and the workpiece and the frictional forces between the plate and the workpiece hold the plate in place on the workpiece while drilling the pocket hole without clamping the plate to the workpiece.

22. The system of claim 20, wherein the drilling assembly and the first handle are positioned on an upper side of the plate.

23. A handheld powered pocket hole drilling system, comprising:
a base assembly;
the base assembly having a plate;
the plate having a drill bit opening extending through the plate;
a lip operably connected to the plate;
a drilling assembly;
a drill bit connected to the drilling assembly;
a drill guide assembly;
the drill guide assembly operably connected to the base assembly and the drilling assembly;
wherein the drilling assembly is movable along the drill guide assembly to extend and retract the drill bit through the drill bit opening at an angle;
an actuating assembly operably connected to the drilling assembly;
wherein the actuating assembly includes a first handle;
wherein the first handle is movable between a first position and a second position;
wherein, when the first handle is moved to the first position the actuating assembly moves the drill guide assembly to a retracted position;
wherein, when the first handle is moved to the second position the actuating assembly moves the drill guide assembly to an extended position
wherein the powered pocket hole jig system is configured to drill a pocket hole in a workpiece;
wherein the drilling assembly and the first handle are positioned on an upper side of the plate.

24. A handheld powered pocket hole drilling system, comprising:
a base assembly;
the base assembly having a plate;
a lip operably connected to the plate;
a drilling assembly;
a drill bit connected to the drilling assembly;
an actuating assembly operably connected to the drilling assembly;
the actuating assembly configured to move the drilling assembly between an extended position and a retracted position;
a drill stop operatively connected to the base assembly;
wherein when a lower surface of the plate is placed on a first surface of a workpiece with the lip placed against an edge of the workpiece, the drill bit is positioned to drill a pocket hole in the workpiece when the drilling assembly is moved to the extended position;
wherein the drill stop is configured to limit a depth of the pocket hole drilled by the drill bit when the drilling assembly is moved to the extended position;
an adjustment member
the adjustment member configured to simultaneously adjust positions of the lip and the drill stop to facilitate drilling of pocket holes for workpieces of different thicknesses.

25. The system of claim 24, wherein the plurality of different thicknesses includes three or more thicknesses.

26. The system of claim 24, wherein the plurality of different thicknesses includes a first thickness of approximately 0.5 inch, a second thickness of approximately 0.75 inch, and a third thickness of approximately 1.0 inch.

27. The system of claim 24, wherein the adjustment member includes a lock feature configured to hold the lip and the drill stop in positions for a selected one of the plurality of different thicknesses.

28. A handheld powered pocket hole drilling system, comprising:
a base assembly;
a drilling assembly connected to the base assembly;
a drill bit operatively connected to the drilling assembly;
an window in the base assembly;
an actuating assembly operably connected to the drilling assembly;
wherein when the base assembly is placed on a workpiece, the window allows a user to see an area of the workpiece proximate to where a pocket hole will be drilled to facilitate positioning of the base assembly on the workpiece.
wherein when the base assembly is placed on the workpiece, the actuating assembly is configured to move the drilling assembly from a retracted position to an extended position to facilitate drilling of the pocket hole in a workpiece.

29. The system of claim 28, wherein the window allows the user to see the location where the drill bit enters the workpiece.

30. The system of claim 28, wherein the base assembly includes one or more indicators indicative of the position where the pocket hole will be drilled in the workpiece.

31. The system of claim 28, wherein the base assembly includes at least one indicator configured to facilitate alignment of the at least one indicator with an edge of the workpiece and thereby place the base assembly in position for drilling the pocket at a predetermined distance from the edge of the workpiece.

32. A handheld powered pocket hole drilling system, comprising:
a base assembly;
the base assembly extending between a front end and a rear end;
a motor operatively connected to the base assembly;
a lip operatively connected to the rear end of the base assembly;
a drill stop operatively connected to the base assembly;
a front support assembly configured to support the front end of the base assembly in an elevated position above a worktable.

33. The system of claim 32, wherein the front support assembly includes a pair of retractable support legs that can be moved downward to hold the front end of system in a raised position.

34. The system of claim 32, wherein the front support assembly includes a pair of retractable support legs;
wherein the front support assembly includes an adjustment assembly configured to move the pair of retractable support legs to a plurality of positions between a retracted position and an extended position.

35. The system of claim 32, wherein the front support assembly includes a pair of retractable support legs;
wherein the front support assembly includes an adjustment assembly configured to move the pair of retractable support legs to a plurality of positions between a retracted position and an extended position;
wherein the adjustment assembly includes a lock assembly configured to hold the pair of retractable support legs in position at a user selected one of plurality of positions.
